(19) United States
(12) Patent Application Publication
(10) Pub. No.: US 2022/0352584 A1
(43) Pub. Date: Nov. 3, 2022

(54) ELECTROCHEMICAL CELL, ELECTROCHEMICAL SYSTEM, AND METHOD FOR PRODUCING AN ELECTROCHEMICAL CELL

(71) Applicant: ElringKlinger AG, Dettingen (DE)

(72) Inventors: Mathias WIDMAIER, Magstadt (DE); Matthias SCHWINDOWSKY, Lichtenstein (DE); Elisabeth REITZ, Tübingen (DE); Mathias SCHERER, Sigmaringen (DE); Christian BECK, Jettingen-Scheppach (DE)

(73) Assignee: ElringKlinger AG, Dettingen (DE)

(21) Appl. No.: 17/856,137

(22) Filed: Jul. 1, 2022

Related U.S. Application Data
(63) Continuation of application No. PCT/EP2021/050050, filed on Jan. 5, 2021.

(30) Foreign Application Priority Data
Jan. 7, 2020 (DE) 10 2020 200 063.8

(51) Int. Cl. H01M 50/186; H01M 50/103; H01M 50/15; H01M 50/176; H01M 50/19

(52) U.S. Cl. CPC H01M 50/186; H01M 50/103; H01M 50/15; H01M 50/176; H01M 50/19

(57) ABSTRACT

The aim of the invention is to provide an electrochemical cell that can be produced as simply as possible and has a long service life. This is achieved in that the electrochemical cell comprises a first contact element that connects a first cell terminal to a first connection conductor and that is fixed to a cover element of the electrochemical cell by means of a first potting element in a first connection region, said first potting element being made of a first polymer material that comprises or is made of a first resin material, and/or the electrochemical cell comprises a second contact element that connects a second cell terminal to a second connection conductor and that is fixed to the cover element by means of a second potting element in a second connection region, said second potting element being made of a second polymer material that comprises or is made of a second resin material.

### RELATED APPLICATION

This application is a continuation of international application No. PCT/EP2021/050050 filed on Jan. 5, 2021, and claims the benefit of German application No. 10 2020 200 063.8 filed on Jan. 7, 2022, which are incorporated herein by reference in their entirety and for all purposes.

### FIELD OF DISCLOSURE

The present invention relates to an electrochemical cell for an electrochemical system.

Furthermore, the present invention relates to an electrochemical system comprising one or more electrochemical cells.

The present invention further relates to a method for producing an electrochemical cell.

### BACKGROUND

Electrochemical cells are known from DE 10 2018 209 270 A1, DE 10 2017 200 390 A1, EP 2 541 650 A1, US 2015/0214516 A1, DE 10 2012 213 871 A1, EP 1459 882 A1, US 2018/0097208 A1 and WO 2017/159760 A1.

### SUMMARY OF THE INVENTION

The object of the present invention is to provide an electrochemical cell that is as easy to produce as possible and has a long service life.

This object is achieved by an electrochemical cell according to claim 1.

The electrochemical cell for an electrochemical system comprises an electrochemical element for receiving, storing and/or providing electrical energy.

The electrochemical cell further comprises a housing for accommodating the electrochemical element, the housing surrounding an interior space of the electrochemical cell and comprising a cover element.

The cover element is preferably connected in a form-fitting manner and/or in a force-locking manner and/or integrally to a further, in particular cup-shaped, housing component.

The electrochemical cell comprises a first cell terminal and a second cell terminal for connecting the electrochemical cell to a cell contacting system.

The first cell terminal is an anode, for example.

The second cell terminal is a cathode, for example.

Alternatively, it can be provided that the first cell terminal forms the cathode and/or that the second cell terminal forms the anode.

It can be favorable if the electrochemical cell comprises a first contact element that connects the first cell terminal to a first connection conductor of the electrochemical cell and if the electrochemical cell comprises a second contact element that connects the second cell terminal to a second connection conductor of the electrochemical cell.

The first connection conductor preferably serves to electrically connect the electrochemical element to the first contact element.

The second connection conductor serves in particular to electrically connect the electrochemical element to the second contact element.

The first contact element is fixed to the cover element in a first connection region by means of a first potting element.

The first potting element is formed from a first polymer material, which in particular comprises or is formed from a first resin material.

Additionally or alternatively, the second contact element is fixed to the cover element in a second connection region by means of a second potting element.

The second potting element is formed from a second polymer material, which in particular comprises or is formed from a second resin material.

By fixing the first contact element by means of the first potting element and/or the second contact element by means of the second potting element, simplified production of the electrochemical cell is preferably made possible.

Additional tools for producing the first potting element and/or the second potting element are preferably unnecessary. In particular, a tool-free terminal bushing is formed.

The use of the first resin material and/or the second resin material makes it possible in particular to avoid or reduce the formation of gaps, which can occur, for example, when a thermoplastic material is injected. This preferably optimizes a sealing effect of the first potting element and/or the second potting element.

It can be advantageous if the first potting element and/or the second potting element are filling potting elements.

As an alternative to fixing the second contact element by means of the second potting element, the second cell terminal can also be directly integrally connected to the cover element, for example by means of laser welding and/or friction welding and/or ultrasonic welding.

It can be provided that the first contact element has an at least approximately T-shaped cross section or an at least approximately L-shaped cross section. The cross section is preferably taken parallel to a primary side of the electrochemical cell.

The second contact element preferably has an at least approximately T-shaped cross section or an at least approximately L-shaped cross section. The cross section is preferably taken parallel to a primary side of the electrochemical cell.

It can be favorable if the first potting element has an anchor shape and/or at least approximately two C shapes in a cross section taken parallel to a primary side of the electrochemical cell. A form fit and/or force fit is thus preferably formed between the cover element and the first potting element, in particular along a direction arranged parallel to a central axis of the first contact element.

The central axis of the first contact element is preferably a main direction of extent of the first contact element. In particular, the central axis of the first contact element is arranged at least approximately perpendicular to a main extension plane of the cover element.

It can be favorable if the second potting element has an anchor shape and/or at least approximately two C shapes in a cross section taken parallel to a primary side of the electrochemical cell. A form fit and/or force fit is thus preferably formed between the cover element and the second potting element, in particular along a direction arranged parallel to a central axis of the second contact element.

The central axis of the second contact element is preferably a main direction of extent of the second contact element. In particular, the central axis of the second contact element is arranged at least approximately perpendicular to a main extension plane of the cover element.

It can be advantageous if the electrochemical cell has at least one predetermined breaking point that is arranged, for example, in a central portion of the cover element between the first cell terminal and the second cell terminal. The at least one predetermined breaking point is in particular at least one material weak point, for example at least one bursting element.

If a critical temperature and/or a critical pressure in the interior space of the electrochemical cell is exceeded, the at least one predetermined breaking point preferably breaks and/or tears.

It can be favorable if the cover element comprises a metallic material or is formed from a metallic material. This can facilitate processing.

For example, the cover element is made of sheet metal, for example aluminum.

It can be advantageous if the first polymer material has a hardness of approx. 40 Shore D or more, in particular approx. 50 Shore D or more, for example approx. 60 Shore D or more.

The first polymer material preferably has a hardness of approx. 100 Shore D or less, in particular approx. 97 Shore D or less, for example approx. 95 Shore D or less.

In particular, the second polymer material has a hardness of approx. 40 Shore D or more, in particular approx. 50 Shore D or more, for example approx. 60 Shore D or more.

It can be favorable if the second polymer material has a hardness of approx. 100 Shore D or less, in particular approx. 97 Shore D or less, for example approx. 95 Shore D or less.

The hardness is determined in accordance with DIN EN ISO 868 in particular.

The hardnesses mentioned preferably also apply to the first resin material and/or the second resin material in a hardened state.

It can be advantageous if the first polymer material has a glass transition temperature of approx. 90° C. or more, in particular approx. 95° C. or more, for example approx. 100° C. or more.

It can be favorable if the second polymer material has a glass transition temperature of approx. 90° C. or more, in particular approx. 95° C. or more, for example approx. 100° C. or more.

The values mentioned for the glass transition temperature preferably also apply to the first resin material and/or the second resin material in a hardened state.

Preferably, the first resin material and/or the second resin material comprises or is formed from one or more of the following materials: epoxy resin material, phenolic resin material, aminoplast material, polyurethane material, silicone material, polyester resin material, ABS (acrylonitrile butadiene styrene) resin material.

An epoxy resin material, for example an epoxy resin, has proven to be particularly advantageous for use as the first resin material and/or as the second resin material. Said epoxy resin material has optimized resistance to corrosion. This can be advantageous in particular with regard to contact with an electrolyte used in the interior space of the electrochemical cell.

In particular, epoxy resin materials have optimized gas tightness, which is why sealing with epoxy resin materials is advantageous for optimized tightness.

If an epoxy resin material is used as the first resin material and/or second resin material, slight volume shrinkages preferably occur during curing and/or drying. In this way, gap formation can be reduced or avoided in the first potting element and/or the second potting element.

One-component resin materials are preferably used as the first resin material and/or the second resin material.

It can be advantageous if the first polymer material and/or the second polymer material are highly crosslinked materials, for example highly crosslinked epoxy resin materials.

It can be advantageous if the first resin material and/or the second resin material has a viscosity of approx. 10² mPa s or more, in particular of approx. 10³ mPa s or more, during production of the first potting element and/or the second potting element.

The viscosity of the first resin material and/or the second resin material during production of the electrochemical cell is preferably approx. 10⁶ mPa s or less, in particular 10⁵ mPa s or less.

Filling the first connection region with the first resin material and/or the second connection region with the second resin material preferably takes place at ambient pressure.

In particular, in order to avoid oxygen and/or water diffusion into the interior space of the electrochemical cell, it can be advantageous if the first resin material and/or the second resin material comprise one or more fillers.

The one or more fillers may also minimize diffusion of the electrolyte out of the interior space of the electrochemical cell.

The one or more fillers are in particular selected from one or more of the following: inorganic fillers, in particular silicon oxide; carbonate; carbide, in particular silicon carbide; nitride, in particular metal nitride; metal oxide.

It can be advantageous if the cover element is connected to an insulating element, in particular a plate-shaped insulating element, on an inner side facing the interior space. In particular, the insulating element has one or more positioning projections on a side facing the cover element.

The one or more positioning projections preferably engage in one or more positioning recesses of the cover element, which are designed to be complementary thereto.

Additionally or alternatively, it can be provided that the insulating element has one or more positioning recesses. The one or more positioning recesses of the insulating element engage in particular in one or more positioning projections of the cover element.

In particular, the one or more positioning projections and/or the one or more positioning recesses preferably form a form fit and/or force fit between the cover element and the insulating element.

The one or more positioning projections and/or positioning recesses preferably block a displacement of the cover element relative to the insulating element in a direction that is arranged parallel to a main extension plane of the cover element.

In particular, the one or more positioning projections of the insulating element engage behind the cover element in a direction that is arranged parallel to a main extension plane of the cover element.

In particular, the one or more positioning projections of the cover element engage behind the insulating element in a direction that is arranged parallel to a main extension plane of the insulating element.

It can be provided that the one or more positioning projections are designed in the form of pins, for example as positioning pins.

In addition or as an alternative to pin-shaped positioning projections, it can be provided that one or more positioning projections have an oval or rectangular or linear cross section. The cross section is preferably taken parallel to the main extension plane of the cover element.

It can be favorable if an average thickness of the insulating element of the electrochemical cell is approx. 1/10 or less, for example approx. 1/15 or less, of an average width of the insulating element taken perpendicular to the thickness. For example, the average thickness of the insulating element is preferably approx. 1.7 mm or less.

The thickness of the insulating element is preferably defined perpendicular to a main extension plane of the insulating element.

For the purposes of the present description and the appended claims, a “thickness” is preferably a material thickness, in particular an average material thickness, of the corresponding element (recesses and/or passage openings excluded).

The insulating element is preferably an injection-molded element and/or a potting element.

It can be provided that the insulating element is and/or will be produced in multiple parts, for example in two parts.

It can be advantageous if the insulating element has a plurality of passage openings, which are in particular arranged regularly. For example, a plurality of passage openings are arranged in all insulating element parts. The passage openings are preferably at least approximately oval or at least approximately rectangular.

The passage openings can be designed in the form of recesses.

In particular, the insulating element comprises a compensation element for absorbing mechanical stresses.

It can be favorable if the insulating element comprises a fifth polymer material or is formed from a fifth polymer material.

The fifth polymer material is preferably a thermoplastic polymer material, in particular an electrolyte-resistant thermoplastic polymer material.

Additionally or alternatively, the fifth polymer material is in particular a polymer material that can be processed in an injection molding process.

For example, the fifth polymer material comprises or is formed from one or more of the following materials: polyethylene terephthalate, polyethylene, polypropylene, polybutylene terephthalate.

It can be provided that the cover element has a first recessed region for accommodating the first potting element on a side facing away from the interior space.

Additionally or alternatively, it can be provided that the cover element has a second recessed region for accommodating the second potting element on a side facing away from the interior space.

The first recessed region and/or the second recessed region are potting basins, for example.

Preferably, the first recessed region and/or the second recessed region are formed by means of embossing. For example, the first recessed region and/or the second recessed region are impressed regions.

It can be favorable if the first recessed region has a bulge, which preferably forms a degassing opening during a filling operation of the first resin material.

In particular, the second recessed region has a bulge. The bulge preferably forms a degassing opening during a filling operation of the second resin material.

The design of a first recessed region and/or a second recessed region means that (additional and/or separate) sealing elements in the respective connection region are preferably unnecessary.

It can be advantageous if the electrochemical cell comprises a first sealing element that radially surrounds the first potting element on an outside of the cover element facing away from the interior space of the electrochemical cell with respect to a central axis of the first contact element.

The first sealing element is, for example, closed in a ring shape.

“Closed in a ring shape” is preferably not limited to elements that have a circular cross section, but also designates elements having an oval cross section or a rectangular cross section, the main bodies of which have no free ends.

Alternatively it can be provided that the first sealing element has at least one interruption.

It can be favorable if the first sealing element has at least one interruption in the radial direction with respect to the central axis of the first contact element.

The at least one interruption in the first sealing element preferably forms at least one ventilation opening through which air can escape when the first resin material is filled into the first connection region.

Irrespective of the shape of the first sealing element, approx. 350° to approx. 355° of a circle whose central point forms the central axis of the first contact element is surrounded by the first sealing element, preferably in a cross section.

In an installation situation of the first sealing element, the cross section is preferably taken parallel to a main extension plane of the cover element.

Additionally or alternatively, it can be provided that the first sealing element protrudes beyond the first cell terminal in the radial direction with respect to the central axis of the first contact element.

For example, a ventilation opening is formed by a projection of the first sealing element beyond the first cell terminal, in particular in the radial direction with respect to the central axis of the first contact element.

The central axis of the first contact element is preferably a central axis of the first cell terminal.

Additionally or alternatively, the electrochemical cell comprises in particular a second sealing element that radially surrounds the second potting element on an outside of the cover element facing away from the interior space of the electrochemical cell with respect to a central axis of the second contact element.

The second sealing element is, for example, closed in a ring shape.

Alternatively it can be provided that the second sealing element has at least one interruption.

It can be favorable if the second sealing element has at least one interruption in the radial direction with respect to the central axis of the second contact element.

The at least one interruption in the second sealing element preferably forms at least one ventilation opening through which air can escape when the second resin material is filled into the second connection region.

Irrespective of the shape of the second sealing element, approx. 350° to approx. 355° of a circle whose central point forms the central axis of the second contact element is surrounded by the second sealing element, preferably in a cross section.

In an installation situation of the second sealing element, the cross section is preferably taken parallel to a main extension plane of the cover element.

Additionally or alternatively, it can be provided that the second sealing element protrudes beyond the second cell terminal in the radial direction with respect to the central axis of the second contact element.

For example, a ventilation opening is formed by a projection of the second sealing element beyond the second cell terminal, in particular in the radial direction with respect to the central axis of the second contact element.

The central axis of the second contact element is preferably a central axis of the second cell terminal.

It can be advantageous if the first sealing element extends away from the main body of the cover element on an outside of the cover element facing away from the interior space of the electrochemical cell.

The second sealing element preferably extends away from the main body of the cover element on an outside of the cover element that faces away from the interior space of the electrochemical cell.

It can be provided that the first sealing element and/or the second sealing element has an at least rectangular cross section or an at least approximately oval cross section. The cross section is preferably taken parallel to the main extension plane of the cover element.

Alternatively, it can be provided that the first sealing element and/or the second sealing element has one or more curved portions.

Additionally or alternatively, it can be provided that the first sealing element and/or the second sealing element has one or more projections that extend into an interior space surrounded by the respective sealing element.

The one or more projections form, in particular, indentations in the respective connection region and/or are surrounded by the potting element.

Additionally or alternatively, it can be provided that the first sealing element and/or the second sealing element has one or more projections that are arranged at a distance from a main body that radially surrounds the respective connection region. The one or more projections are in particular in the form of a base and/or cuboid.

For example, the first sealing element and/or the second sealing element have a wavy and/or jagged cross section at least in some regions.

Bulge(s), a wave shape and/or jagged shape of the cross section of the first sealing element and/or the second sealing element and one or more projections can increase the stability of a contact surface between the first sealing element and the first potting element and/or a contact surface between the second sealing element and the second potting element.

In particular during production of the first potting element and/or the second potting element, adhesion of the first resin material to the first sealing element and/or adhesion of the second resin material to the second sealing element can be optimized.

It can be provided that the first cell terminal and the first sealing element terminate flush with one another with respect to a radial direction of the central axis of the first contact element.

Additionally or alternatively, it can be provided that the second cell terminal and the second sealing element terminate flush with one another with respect to a radial direction of the central axis of the second contact element.

As an alternative to a flush termination, provision can be made for the first cell terminal to protrude laterally beyond the first sealing element on one or more sides and/or for the second cell terminal to protrude laterally beyond the second sealing element on one or more sides.

As an alternative to the alternatives mentioned, it can be provided—as already described—that the first sealing element projects laterally beyond the first cell terminal and/or that the second sealing element projects laterally beyond the second cell terminal.

The first sealing element and/or the second sealing element can protrude laterally beyond the respective cell terminal by using a first cell terminal and/or a second cell terminal that is smaller than the areas surrounded by the first sealing element and/or the second sealing element.

Ventilation openings are preferably formed by the lateral protrusion of the sealing elements beyond the cell terminals, through which ventilation openings air can escape when the first resin material and/or the second resin material are filled into a connection region.

“Lateral” preferably refers to an orientation of the electrochemical cell in which the first and second cell terminals are at the top and a bottom side of the housing that faces away from the cover element is arranged at the bottom.

It can be advantageous if a cavity for accommodating the first resin material is formed between the first sealing element and the first cell terminal on a side of the cover element facing away from the interior space.

In particular, a cavity for accommodating the second resin material is formed by the second sealing element and the second cell terminal on a side of the cover element facing away from the interior space.

It can be favorable if the first sealing element forms an electrical and/or thermal and/or spatial separation and/or insulation between the first cell terminal and the cover element.

Additionally or alternatively, it can be provided that the second sealing element forms an electrical and/or thermal and/or spatial separation and/or insulation between the second cell terminal and the cover element.

For example, the first sealing element forms a support for the first cell terminal and/or the second sealing element forms a support for the second cell terminal.

The first sealing element is preferably applied to the main body of the cover element in a printing process, in particular in the form of a sealing bead.

The second sealing element is applied to the main body of the cover element, for example in a printing process, in particular in the form of a sealing bead.

For example, the first sealing element and/or the second sealing element are applied to the main body of the cover element in a pattern printing process, for example in a screen printing process and/or stencil printing process and/or pad printing process.

Alternatively, it can be provided that the first sealing element is produced separately and/or is a component that can be handled separately.

In particular, the first sealing element is an insert, for example a plastic frame.

In embodiments having a separately produced first sealing element, said sealing element is preferably inserted into a receiving space in the cover element complementary thereto and/or a receiving space complementary to the first sealing element in the first cell terminal. Positioning can take place in this manner.

In addition to or as an alternative to a separately produced first sealing element, it can be provided that the second sealing element is produced separately and/or is a component that can be handled separately.

In particular, the second sealing element is an insert, for example a metal frame.

In embodiments having a separately produced second sealing element, said sealing element is preferably inserted into a receiving space in the cover element complementary thereto and/or a receiving space complementary to the second sealing element in the second cell terminal. Positioning can take place in this manner.

It can be provided that the first sealing element comprises or is formed from a third polymer material.

The second sealing element preferably comprises or is formed from a fourth polymer material.

The third polymer material and the fourth polymer material are in particular different from one another.

Alternatively, the third polymer material and the fourth polymer material are identical.

The third polymer material and/or the fourth polymer material preferably comprises or is formed from one or more of the following materials: a thermosetting polymer material, a thermoplastic polymer material, an elastomeric polymer material, or mixtures thereof.

For example, the third polymer material and/or the fourth polymer material comprises or is formed from one or more of the following polymer materials: polyolefin, in particular polypropylene and/or polyethylene; polyester, in particular polyethylene terephthalate and/or polybutylene terephthalate; polyamide; polyimide; copolyamide; polyamide elastomer; polyether, in particular epoxy resins; polyurethane; polyurethane acrylate; polyvinyl chloride; polystyrene; polymethylmethacrylate; acryl butadiene styrene; synthetic rubber, in particular ethylene-propylene-diene rubber; polycarbonate; polyethersulfone; polyoxymethylene; polyetheretherketone; polytetrafluoroethylene; silicone, in particular silicone rubber and/or silicone-based elastomer.

Thermoplastic polymer materials are preferred for the third polymer material and/or the fourth polymer material. For example, hotmelt materials are used for the third polymer material and/or the fourth polymer material.

The third polymer material and/or the fourth polymer material preferably hardens to form the first sealing element or the second sealing element.

It can be provided that the third polymer material and/or the fourth polymer material comprises one or more fillers.

The one or more fillers are in particular selected from one or more of the following: inorganic fillers, in particular silicon oxide; carbonate; carbide, in particular silicon carbide; nitride, in particular metal nitride; metal oxide.

The use of one or more fillers preferably optimizes a settlement behavior of the third polymer material and/or the fourth polymer material.

It can be provided that the fourth polymer material comprises one or more conductive additives. The one or more conductive additives are selected in particular from one or more of the following: carbon materials, in particular conductive carbon black, graphite, graphene, carbon nanotubes, carbon fibers and/or carbon nano-onions; particulate metallic materials, in particular metal powder; electrically conductive ceramic materials, in particular nitrides and/or carbides; electrically conductive polymers, in particular trans-polyacetylene, polypyrrole, polyaniline, poly(-phenylene), polythiophene and/or polystyrene doped poly(3,4-ethylenedioxythiophene) (PEDOT:PSS).

Preferred particulate metallic materials preferably comprise or are formed from aluminum, copper, titanium, iron or silver.

In particular, the particulate metallic materials comprise alloys of the materials mentioned or are formed therefrom.

“Electrically conductive” means in particular an electrical conductivity of 10⁻¹ S/m or more, in particular 10⁶ S/m or more.

Preferably, in embodiments in which a snap-over element is formed, the fourth polymer material comprises one or more conductive additives.

It can be provided that the first sealing element forms part of the cover element and is formed in particular by an elevation of the cover element, which elevation is in particular closed in a ring shape or has at least one interruption.

The elevation of the cover element, which forms the first sealing element, preferably extends away from the main body of the cover element in a direction pointing away from the interior space of the electrochemical cell.

Additionally or alternatively, it can be provided that the second sealing element of the electrochemical cell forms part of the cover element and is formed in particular by an elevation of the cover element, which elevation is, for example, closed in a ring shape or has at least one interruption.

The elevation of the cover element, which forms the second sealing element, in particular extends away from the main body of the cover element in a direction pointing away from the interior space of the electrochemical cell.

For example, the first sealing element and/or the second sealing element are formed by means of embossing and/or beads in the cover element. In this case, the cover element is machined, for example, from an inner side facing the interior space in a mounted state.

As an alternative to a complete formation of the first sealing element by means of embossing and/or beads, it can be provided that the first sealing element comprises or is formed from both at least one sealing bead and at least one bead.

For example, the first sealing element is formed in some regions from one or more sealing beads and in some regions from one or more beads.

As an alternative to a complete formation of the second sealing element by means of embossing and/or beads, it can be provided that the second sealing element comprises or is formed from both at least one sealing bead and at least one bead.

For example, the second sealing element is formed in some regions from one or more sealing beads and in some regions from one or more beads.

The second sealing element preferably consists in part of at least one bead made of a metallic material and in part of at least one sealing bead made of a fourth polymer material. According to this embodiment, the fourth polymer material is preferably electrically insulating. The bead preferably sets the cover element to potential and/or a current is more strongly limited in the event of a fault, in particular because a contact surface between the housing and the second cell terminal is minimized by the partial formation of the second sealing element from an electrically insulating polymer material.

In embodiments in which the first sealing element and/or the second sealing element are formed by elevations of the cover element, indentations of the cover element designed to complement them form, for example, positioning recesses on an inner side of the cover element facing the interior space.

Positioning projections that are preferably complementary thereto are then formed in the insulating element, which positioning projections in particular allow the insulating element to be positioned relative to the cover element.

It can be provided that the first contact element and/or the second contact element is in the form of an insert in the insulating element.

Thus, in particular, a form fit is formed between the first contact element and the insulating element and/or a form fit is formed between the second contact element and the insulating element. This forms, for example, leakage protection and/or seals against the first resin material and/or the second resin material.

The insulating element is preferably injection molded onto the first contact element and/or the second contact element.

It can be favorable if a contact region is formed between the first cell terminal and the first sealing element and/or a contact region is formed between the second cell terminal and the second sealing element.

It can be provided that the first sealing element and/or the second sealing element, in particular in embodiments in which these form part of the cover element, have a treated surface and/or are subjected to a surface treatment.

For example, the second sealing element is and/or will be anodized in a contact region with the second cell terminal and/or has a surface having increased roughness.

A surface having an increased roughness can be produced, for example, by means of sandblasting.

It can be provided that the second contact element bears against the cover element in a region of a second opening of the cover element and/or is in direct material and/or electrical contact therewith. In this way, the cover element can be brought to a potential of the second cell terminal.

It can be advantageous for the first contact element to comprise at least two contact element components that, in particular, comprise or are formed from metallic materials that are different from one another.

For example, a first contact element component of the first contact element comprises or is formed from a first metallic material, for example aluminum, and a second contact element component of the first contact element comprises or is formed from a second metallic material, for example copper.

The at least two contact element components of the first contact element are preferably integrally connected to one another in the first connection region, for example by means of laser welding and/or roll cladding.

Alternatively, it can be provided that the at least two contact element components of the first contact element are integrally connected to one another, in particular by means of laser welding and/or roll cladding, outside the first connection region, for example on a side facing the electrochemical element.

It can be provided that the first contact element comprises a third contact element component that is connected, for example, to the first contact element component and/or to the second contact element component.

Additionally or alternatively, it can be provided that the second contact element comprises at least two contact element components.

The at least two contact element components of the second contact element are integrally connected to one another, in particular in the second connection region, in particular by means of laser welding and/or roll cladding.

Alternatively, it can be provided that the different contact element components of the second contact element are integrally connected to each other outside of the second connection region, for example on a side facing the electrochemical element, in particular by means of laser welding and/or roll cladding.

In embodiments in which the second contact element has a first contact element portion and a second contact element portion, these are preferably formed from the same metallic material or comprise the same metallic material. Aluminum is preferred as the metallic material for the second contact element.

In addition to a first contact element component and a second contact element component of the second contact element, it can be provided that the second contact element comprises a third contact element component that is in particular integrally connected to the first contact element component and/or to the second contact element component of the second contact element. The integral connection is made, for example, by means of laser welding and/or roll cladding.

The first contact element and/or the second contact element are preferably made from a flat material.

The first contact element and/or the second contact element are preferably formed in a cross section at least approximately in the form of an inverted T or in an L-shape. The cross section is preferably taken parallel to a primary side of the electrochemical cell.

The second contact element preferably has at least one fuse element. The at least one fuse element is formed in particular by a region of a locally reduced cross-sectional area of the second contact element.

The cross-sectional area is preferably defined perpendicular to a main direction of extent and/or perpendicular to a central axis of the second contact element.

The at least one fuse element is preferably at least one safety fuse.

It can be favorable if the at least one fuse element is arranged in the second connection region.

The at least one fuse element forms in particular an overcurrent protection that melts when a critical current and/or a critical voltage is exceeded.

As an alternative to arranging the at least one fuse element in the second connection region, provision can be made for the at least one fuse element to be arranged outside of the second connection region.

For example, the at least one fuse element is part of the second connection conductor.

It can be provided that the at least one fuse element is encased in a polymer material, an electrolyte-resistant thermoplastic polymer material preferably being used here.

It can be favorable if the first contact element has a first resin material filling opening for filling the first resin material into the first connection region.

Preferably, the second contact element has a second resin material filling opening for filling the second resin material into the second connection region.

It can be advantageous if the first connection conductor has an average thickness that is approx. 1/10 or less of an average width of the first connection conductor taken perpendicular to the thickness.

Preferably, the average thickness of the first connection conductor is approx. 0.8 mm or less, for example approx. 0.7 mm or less.

It can be favorable if the second connection conductor has an average thickness that is approx. 1/10 or less of an average width of the second connection conductor taken perpendicular to the thickness.

Preferably, the average thickness of the second connection conductor is approx. 0.8 mm or less, for example approx. 0.7 mm or less.

Due to the mentioned average thicknesses of the first connection conductor and/or the second connection conductor, material embossing in the production of the connection conductor is preferably unnecessary.

The first connection conductor and/or the second connection conductor preferably each have a homogeneous thickness over their entire extent.

Due to the comparatively small average thickness of the first connection conductor and/or the second connection conductor, material can preferably be saved. As a result, costs for the corresponding elements can be reduced.

According to a preferred embodiment, the first contact element has an average thickness in a first joint region that is approx. 2/10 or less, in particular approx. 1/10 or less, of an average width of the first contact element taken perpendicular to the thickness.

The average thickness of the first contact element in the first joint region is preferably approx. 0.8 mm or less, for example approx. 0.7 mm or less.

The first joint region is preferably a region in which the first contact element and the first cell terminal are connected to one another. In particular, the first contact element is passed through a passage opening of the first cell terminal in the first joint region.

It can be advantageous if the second contact element has an average thickness in a second joint region that is approx. 2/10 or less, in particular approx. 1/10 or less, of an average width of the second contact element taken perpendicular to the thickness.

The average thickness of the second contact element in the second joint region is preferably approx. 0.8 mm or less, for example approx. 0.7 mm or less.

The second joint region is preferably a region in which the second contact element and the second cell terminal are connected to one another. For example, the second contact element is passed through a passage opening in the second cell terminal in the second joint region.

It can be favorable if an average width of the first contact element in a first joint region having the first cell terminal is approx. ½ or less, in particular ⅖ or less, than an average width of the first cell terminal in a direction parallel to the width of the first contact element.

It can be advantageous if the average width of the first contact element in the first joint region is approx. 10.0 mm or less, for example approx. 9.5 mm or less.

Preferably, an average width of the second contact element in a second joint region having the second cell terminal is approx. ½ or less, in particular ⅖ or less, than an average width of the second cell terminal in a direction parallel to the width of the second contact element.

In particular, the average width of the second contact element in the second joint region is approx. 10.0 mm or less, for example approx. 9.5 mm or less.

The average thickness of the first contact element in the first joint region is preferably substantially identical to an average length of the passage opening of the first cell terminal in the first joint region.

In particular, the average thickness of the second contact element in the second joint region is substantially identical to an average length of the passage opening of the second cell terminal in the second joint region.

The average width of the first contact element in the first joint region preferably corresponds substantially to an average width of the passage opening of the first cell terminal.

In particular, the average width of the second contact element in the second joint region substantially corresponds to an average width of the passage opening of the second cell terminal.

It can be advantageous if the first connection conductor and the first contact element are formed in one part and/or if the second connection conductor and the second contact element are formed in one part.

The first contact element is preferably at least approximately rectangular in cross section taken parallel to a main extension plane of the cover element. In particular, the second contact element is at least approximately rectangular in a cross section taken parallel to the main extension plane of the cover element.

It can be provided that an average thickness of the cover element in a cross section taken perpendicular to the main extension plane thereof is approx. 1/10 or less, for example approx. 1/20 or less, of an average width of the cover element perpendicular to its thickness. For example, the average thickness of the cover element is approx. 1.9 mm or less, for example approx. 1.8 mm or less.

Due to the aforementioned dimensions, the electrochemical cell can be produced comparatively inexpensively.

It can be provided that the electrochemical cell comprises at least one snap-over element that can be and/or is deflected outward from a rest state into a working state when a critical pressure and/or a critical temperature in the interior space of the electrochemical cell is exceeded, and thus making electrical contact between the cover element and the first cell terminal.

By deflecting the at least one snap-over element from the rest state into the working state, an electrically conductive connection is in particular produced between the cover element and the first cell terminal, which initially has a polarity opposite to the polarity of the cover element.

The snap-over element can, in particular, be welded into a housing cover of the housing of the electrochemical cell.

At a predetermined internal cell pressure, the snap-over element is deflected outward and thereby produces an electrically conductive connection between the cover element and the first cell terminal.

The increased internal cell pressure is caused in particular by electrochemical processes and by the heat generated when the electrochemical cell is overcharged. Because the cover element is at the opposite electrical potential, for example at the potential of the second cell terminal, the electrochemical cell is short-circuited by the contact of the snap-over element with the first cell terminal.

For example, the at least one fuse element, for example at least one safety fuse, can be triggered by the short circuit.

After the at least one fuse element has been triggered, there is no longer any electrical connection between the cell terminal and the electrochemical element in the interior space of the electrochemical cell, such that the electrochemical cell can no longer be charged. This prevents further overcharging of the cell.

The first contact element is preferably connected to the insulating element of the electrochemical cell integrally and/or in a form-fitting and/or force-locking manner.

Additionally or alternatively, it can be provided that the second contact element is connected to the insulating element of the electrochemical cell integrally and/or in form-fitting and/or force-locking manner.

For example, the first contact element and/or the second contact element reach behind the insulating element in a direction perpendicular to a main extension plane of the cover element.

It can be favorable if the insulating element is connected to the cover element on an inner side of the cover element facing the interior space.

The insulating element preferably has at least one filling opening adjacent to the first connection region and/or adjacent to the second connection region for filling the first resin material into the first connection region and/or for filling the second resin material into the second connection region.

This can facilitate and/or allow filling of the first resin material and/or the second resin material.

It can be provided that at least one filling channel is connected to the at least one filling opening, which filling channel in particular connects the at least one filling opening to a depression of the insulating element, which depression delimits the first connection region or the second connection region.

It can be advantageous if two filling channels are formed that have an at least approximately Y-shaped cross section and each open into a depression in the insulating element.

It can be favorable if the insulating element of the electrochemical cell has a plurality of depressions for accommodating the first potting element and/or the second potting element, one or more flow guide elements for distribution of the first resin material and/or the second resin material being arranged in each of the depressions, in particular, during production of the electrochemical cell.

The depressions are, for example, pocket-shaped.

In a state in which the insulating element is connected to the cover element, the depressions preferably form a cavity for accommodating the first resin material and/or the second resin material.

The one or more flow guide elements preferably have an at least approximately rectangular cross section, an at least approximately oval cross section or an at least approximately spiral cross section.

Alternatively, a cross section of the one or more flow guide elements is V-shaped.

The cross section is preferably taken parallel to a main extension plane of the insulating element.

Optimized properties are preferably achieved if in the first connection region and/or the second connection region:
a distance between the cover element and the first cell terminal in a direction parallel to the central axis of the first contact element and/or a distance between the cover element and the second cell terminal in a direction parallel to the central axis of the second contact element is 0.05 mm or more; and/or
a distance between the first contact element and the cover element in the region of the first opening of the cover element and/or a distance between the second contact element and the cover element in the region of the second opening of the cover element is 0.05 mm or more; and/or
a ratio between the distance mentioned first and a thickness of the cover element is in a range of approx. 0.005 to 1.

The present invention also relates to an electrochemical system comprising one or more electrochemical cells according to the invention.

The electrochemical system according to the invention preferably has one or more of the features described in connection with the electrochemical cell according to the invention and/or one or more of the advantages described in connection with the electrochemical cell according to the invention.

The present invention also relates to a method for producing an electrochemical cell, in particular an electrochemical cell according to the invention.

The method preferably comprises providing a cover element that comprises a first opening and/or a second opening.

The first opening is, for example, at least one anode opening.

The second opening is, for example, at least a cathode opening.

Alternatively it can be provided that the first opening is at least a cathode opening and/or that the second opening is at least an anode opening.

A first contact element, which is connected or can be connected in particular to a first cell terminal, is preferably positioned in the first opening.

Additionally or alternatively, a second contact element, which is or can be connected in particular to a second cell terminal, is positioned in the second opening.

A first resin material is preferably filled in a casting process into a first connection region surrounded by the cover element, the first contact element and in particular the first cell terminal.

Additionally or alternatively, a second resin material is filled in a casting process into a second connection region surrounded by the cover element, the second contact element and in particular the second cell terminal.

The method preferably further comprises drying and/or curing the first resin material to form a first potting element and/or drying and/or curing the second resin material to form the second potting element.

The cover element is then preferably connected to a further housing component of the housing, in particular integrally, for example by means of welding.

The method according to the invention preferably has one or more of the features described in connection with the electrochemical cell according to the invention and/or one or more of the advantages described in connection with the electrochemical cell according to the invention.

At least one first sealing element is preferably applied to the cover element and/or introduced into the cover element on an outer side of the cover element facing away from an interior space of the electrochemical cell, which sealing element radially surrounds the first connection region with respect to a central axis of the first contact element.

Additionally or alternatively, at least one second sealing element is preferably applied to the cover element and/or introduced into the cover element on an outer side of the cover element facing away from the interior space of the electrochemical cell, which sealing element radially surrounds the second connection region with respect to a central axis of the second contact element.

It can be favorable if the cover element is connected in a force-locking and/or form-fitting manner to an insulating element before, during or after the filling of the first resin material and/or the second resin material.

The first cell terminal is preferably integrally connected to the first contact element, for example by means of laser welding, before or after the first contact element is cast and/or the first potting element is produced.

The second cell terminal is preferably integrally connected to the second contact element, for example by means of laser welding, before or after the casting of the second contact element and/or the production of the second potting element.

It can be provided that a relative position of the cover element and the insulating element is fixed during the drying and/or curing of the first resin material and/or second resin material by means of a holding element, for example by means of a hold-down device.

After the cell terminals have been fixed, the corresponding assembly is preferably hardened, for example in a hardening line.

In addition or as an alternative to the use and/or production of sealing elements, it can be provided that a first recessed region is introduced into a main body of the cover element, for example by means of embossing. The first recessed region preferably serves as a receptacle for the first potting element.

In particular, the first resin material is filled into the first recessed region in a flowable state.

According to a preferred embodiment, a second recessed region is introduced into the cover element, for example by means of embossing. The second recessed region preferably serves as a receptacle for the second potting element.

In particular, the second resin material is filled into the second recessed region in a flowable state.

It can be advantageous if the first resin material is filled through a first resin material filling opening in the first contact element into a cavity that forms the first potting element in the cured state.

The second resin material is preferably filled through a second resin material filling opening in the second contact element into a cavity that forms the second potting element in the cured state.

Alternatively (as described above), filling can take place via filling openings in the insulating element.

Further features and/or advantages of the invention are the subject matter of the following description and the drawings illustrating embodiments.

### BRIEF DESCRIPTION OF THE DRAWINGS

FIG. 1 is a schematic sectional view of a first embodiment of an electrochemical cell, in which a first contact element is fixed to a cover element of a housing by means of a first potting element and in which a second contact element is fixed to the cover element by means of a second potting element;

FIG. 2 is a schematic sectional view of the first contact element from FIG. 1, a first contact element component and an L-shaped second contact element component of the first contact element being integrally connected to one another;

FIG. 3 is a schematic plan view of the first contact element along a direction indicated by III in FIG. 2;

FIG. 4 is a schematic sectional view of the second contact element from FIG. 1, the second contact element having an L-shape;

FIG. 5 is a schematic plan view of the second contact element along a direction denoted by V in FIG. 4;

FIG. 6 is a section of the schematic sectional view of FIG. 1;

FIG. 7 is an enlarged representation of the region labeled VII in FIG. 6;

FIG. 8 is a schematic plan view of the cover element of the electrochemical cell from FIGS. 1 to 7;

FIG. 9 is a schematic plan view of the cover element of the electrochemical cell from FIG. 1 during production of the electrochemical cell, a first sealing element being applied around a first opening of the cover element and at a distance therefrom, and a second sealing element being applied around a second opening of the cover element and at a distance therefrom;

FIG. 10 is a schematic plan view of the insulating element of the electrochemical cell of FIG. 1;

FIG. 11 is a schematic plan view of an insulating element of a further embodiment of an electrochemical cell, the insulating element being formed in two parts;

FIG. 12 is a schematic plan view of an insulating element of a further embodiment of an electrochemical cell, the insulating element having a compensation element centrally between a first opening for leading through the first contact element and a second opening for leading through the second contact element;

FIG. 13 is a schematic plan view of a section of a further embodiment of an electrochemical cell in which a first recess of the first cell terminal is at least approximately oval and in which a second recess of the second cell terminal is at least approximately oval;

FIG. 14 is a schematic plan view of the cover element from FIG. 13 during production of the electrochemical cell;

FIG. 15 is a schematic plan view of the insulating element of the further embodiment of an electrochemical cell from FIGS. 13 and 14, the insulating element having an at least approximately oval first opening and an at least approximately oval second opening and the insulating element optionally being formed in two parts;

FIG. 16 is a schematic plan view of a section of a further embodiment of an electrochemical cell in which a passage opening of the first cell terminal and a passage opening of the second cell terminal each have a main direction of extent and are arranged at least approximately parallel to a primary side of the electrochemical cell;

FIG. 17 is a schematic plan view of a section of the electrochemical cell from FIG. 16 during production;

FIG. 18 is a schematic sectional view of a section of a further embodiment of an electrochemical cell in which a fuse element of the second contact element is arranged in the form of a safety fuse outside a second connection region;

FIG. 19 is a schematic sectional view of a section of a further embodiment of an electrochemical cell;

FIG. 20 is a schematic sectional view of a section of a further embodiment of an electrochemical cell, the first potting element and the second potting element not engaging behind the cover element in a direction perpendicular to a main extension plane of the cover element;

FIG. 21 is a schematic sectional view of a section of a further embodiment of an electrochemical cell, the electrochemical cell comprising a snap-over element in the form of a spring element, by means of which the first cell terminal can contact the cover element in an electrically conductive manner if a critical pressure and/or a critical temperature is exceeded in an interior space of the electrochemical cell;

FIG. 22 is a schematic plan view of the cover element of the electrochemical cell from FIG. 21 during production of the electrochemical cell;

FIG. 23 is a schematic plan view of the insulating element of the electrochemical cell of FIGS. 21 and 22;

FIG. 24 is a schematic sectional view of a section of a further embodiment of an electrochemical cell in which the first contact element and the second contact element each have an at least approximately T-shaped cross section;

FIG. 25 is a schematic sectional view of the first contact element from FIG. 24 that comprises three contact element components;

FIG. 26 is a schematic plan view of the first contact element along a direction denoted by XXVI in FIG. 25;

FIG. 27 is a schematic sectional view of the second contact element from FIG. 24 that comprises at least two contact element components;

FIG. 28 is a plan view of the second contact element from FIG. 27 along a direction denoted by XXVIII in FIG. 27;

FIG. 29 is a schematic sectional view of a first contact element of a further embodiment of an electrochemical cell that is at least approximately oval in a cross section taken parallel to a main extension plane of the cover element;

FIG. 30 is a schematic plan view of the first contact element from FIG. 29 along a direction denoted by XXX in FIG. 29;

FIG. 31 is a schematic sectional view of a second contact element of the electrochemical cell from FIGS. 29 and 30, the second contact element being at least approximately oval in a cross section taken parallel to the main extension plane of the cover element;

FIG. 32 is a schematic plan view of the second contact element from FIG. 31 along a direction denoted by XXXII in FIG. 31;

FIG. 33 is a schematic sectional view of a section of a further embodiment of an electrochemical cell in which elevations of the cover element form lateral boundaries of the first potting element and the second potting element;

FIG. 34 is a schematic plan view of the cover element of the electrochemical cell from FIG. 33 during production of the electrochemical cell;

FIG. 35 is a schematic plan view of an insulating element of the electrochemical cell from FIGS. 34 and 35, the insulating element having a plurality of positioning projections that each have an at least approximately rectangular cross section;

FIG. 36 is a schematic sectional view of a section of a further embodiment of an electrochemical cell in which the first contact element and the second contact element are each connected to the insulating element in a force-locking and/or form-fitting manner relative to the latter;

FIG. 37 is a schematic sectional view of a section of a further embodiment of an electrochemical cell in which the insulating element has a first filling opening for filling a first resin material into the first connection region and a second filling opening for filling a second resin material into the second connection region;

FIG. 38 is a schematic sectional view of a section of a further embodiment of an electrochemical cell in which the second cell terminal bears against an elevation of the cover element designed as a second sealing element;

FIG. 39 is a schematic sectional view of a section of a further embodiment of an electrochemical cell in which the second contact element integrally contacts an edge region of a second opening of the cover element;

FIG. 40 is a schematic sectional view of a further embodiment of an electrochemical cell in which the first contact element is connected laterally to the electrochemical element by means of a first connection conductor and the second contact element by means of a second connection conductor;

FIG. 41 is a schematic sectional view of the first contact element and the first cell terminal of the electrochemical cell from FIG. 40;

FIG. 42 is a schematic plan view of the first contact element from FIG. 41 along a direction denoted by XLII in FIG. 41;

FIG. 43 is a schematic sectional view of the second contact element and the first cell terminal of the electrochemical cell from FIG. 40;

FIG. 44 is a schematic plan view of the second contact element from FIG. 43 along a direction denoted by XLIV in FIG. 43;

FIG. 45 is a schematic sectional view of a section of a further embodiment of an electrochemical cell in which the first resin material is filled into the first connection region and/or the second resin material is filled into the second connection region from a side facing the interior space;

FIG. 46 is a schematic sectional view of a section of a further embodiment of an electrochemical cell in which the first contact element and the second contact element are each thinner on a side facing the interior space;

FIG. 47 is a schematic sectional view of a section of a further embodiment of an electrochemical cell in which the cover element and the insulating element can be held together by means of the first contact element and/or the second contact element when the first potting element and/or the second potting element is formed;

FIG. 48 is a schematic sectional view of the first contact element and the first cell terminal of the electrochemical cell from FIG. 47;

FIG. 49 is a schematic plan view of the first contact element from FIG. 48 along a direction denoted by XLIX in FIG. 48;

FIG. 50 is a schematic sectional view of the second contact element and the second cell terminal of the electrochemical cell from FIG. 47;

FIG. 51 is a schematic plan view of the second contact element from FIG. 50 along a direction denoted by LI in FIG. 50;

FIG. 52 is a schematic plan view of an insulating element of a further embodiment of an electrochemical cell in which the insulating element has pocket-like depressions in the region of the first connection region and in the region of the second connection region, in which depressions V-shaped flow guide elements are arranged;

FIG. 53 is a schematic sectional view of the insulating element from FIG. 52 along a plane denoted by LIII in FIG. 52;

FIG. 54 is a schematic plan view of an insulating element of a further embodiment of an electrochemical cell in which two flow guide elements are arranged at a distance from one another in a first depression and in a second depression of the insulating element;

FIG. 55 is a schematic plan view of an insulating element of a further embodiment of an electrochemical cell in which a first pocket-like depression and a second pocket-like depression are formed, positioning projections arranged in the pocket-like depressions serving as flow guide elements;

FIG. 56 is a schematic plan view of an insulating element of a further embodiment of an electrochemical cell in which the insulating element has a first filling channel for filling the first depression and a second filling channel for filling the second depression;

FIG. 57 is a schematic plan view of an insulating element of a further embodiment of an electrochemical cell in which the insulating element has a plurality of filling openings arranged in edge regions of the first depression and a plurality of filling openings arranged in edge regions of the second depression;

FIG. 58 is a schematic plan view of an insulating element of a further embodiment of an electrochemical cell in which the insulating element has a first flow guide element arranged spirally around a first opening of the insulating element and a second flow guide element arranged spirally around a second opening of the insulating element;

FIG. 59 is a schematic plan view of an insulating element of a further embodiment of an electrochemical cell in which a first flow guide element equidistantly surrounds the first opening of the insulating element and in which a second flow guide element equidistantly surrounds the second opening of the insulating element, it being possible for a height of the flow guide elements to be different;

FIG. 60 is a schematic plan view of a variant of a sealing element, according to which the sealing element has an at least approximately rectangular cross section;

FIG. 61 is a schematic plan view of a further variant of a sealing element, according to which the sealing element has at least one interruption on a side facing away from the opening of the cover element;

FIG. 62 is a schematic plan view of a further variant of a sealing element, according to which the sealing element has a cross section of a truncated ellipse;

FIG. 63 is a schematic plan view of a further variant of a sealing element, according to which the sealing element has a bulge on a side facing away from the opening of the cover element;

FIG. 64 is a schematic plan view of a further variant of a sealing element, according to which the sealing element has two adjoining bulges on a side facing away from the opening of the cover element;

FIG. 65 is a schematic plan view of a further variant of a sealing element, according to which the sealing element has inwardly protruding projections whose main direction of extent is at least approximately parallel to a main direction of extent of the opening of the cover element;

FIG. 66 is a schematic plan view of a further variant of a sealing element, according to which the inwardly protruding projections of the sealing element are formed so as to be inclined with respect to the opening of the cover element;

FIG. 67 is a schematic plan view of a further variant of a sealing element, according to which three inwardly projecting projections of the sealing element are arranged alternately on opposite sides of the sealing element;

FIG. 68 is a schematic plan view of a further variant of a sealing element, according to which the inwardly projecting projections are designed to be inclined away from the opening of the cover element;

FIG. 69 is a schematic plan view of a further variant of a sealing element, according to which a plurality of projections of the sealing element are at a distance from a main body of the sealing element and are surrounded by the main body;

FIG. 70 is a schematic plan view of a further variant of a sealing element, according to which the sealing element has a projection that has an at least approximately circular cross section and that is arranged at a distance from the main body of the sealing element;

FIG. 71 is a schematic plan view of a further variant of a sealing element, according to which the projection has an at least approximately oval cross section;

FIG. 72 is a schematic plan view of a further variant of a sealing element, according to which the sealing element comprises a main body made of a polymer material and at least one projection made of a metallic material;

FIG. 73 is a schematic plan view of a cell terminal in which an opening is at least approximately rectangular and has a main direction of extent that is arranged at least approximately parallel to a narrow side of the cell terminal;

FIG. 74 is a schematic plan view of a cell terminal in which a main direction of extent of the opening is arranged at least approximately parallel to a broad side of the cell terminal;

FIG. 75 is a schematic plan view of a cell terminal in which an opening is at least approximately oval and has a main direction of extent that is arranged at least approximately parallel to a narrow side of the cell terminal;

FIG. 76 is a schematic plan view of a cell terminal in which a main direction of extent of the opening is arranged at least approximately parallel to a broad side of the cell terminal;

FIG. 77 is a schematic perspective view of a section of a further embodiment of an electrochemical cell in which the second cell terminal is arranged on a second recessed region of the cover element;

FIG. 78 is a schematic perspective view of the cover element from FIG. 77 in which the second recessed region forms a potting basin for the second potting element;

FIG. 79 is a schematic perspective view of a section of the embodiment of an electrochemical cell from FIGS. 77 and 78 in which the first contact element has a first filling opening for the first resin material and in which the second contact element has a second filling opening for the second resin material;

FIG. 80 is a schematic perspective sectional view of a section of the electrochemical cell from FIGS. 77 to 79 in which the second cell terminal, the second contact element and part of the second connection conductor are shown;

FIG. 81 is a schematic perspective sectional view of a section of the electrochemical cell from FIGS. 77 to 80 in which the first cell terminal, the first contact element and part of the first connection conductor are shown;

FIG. 82 is a schematic perspective view of the second contact element of the embodiment of an electrochemical cell from FIGS. 77 to 81, the second contact element being connected to the second connection conductor, the second contact element and the second connection conductor at least approximately forming an L shape in a cross section taken perpendicular to the main extension plane of the cover element;

FIG. 83 is a schematic perspective view of the first contact element of the embodiment of an electrochemical cell from FIGS. 77 to 82, the first contact element being connected to the first connection conductor, the first contact element and the first connection conductor at least approximately forming an L shape in a cross section taken perpendicular to the main extension plane of the cover element;

FIG. 84 is a schematic perspective view of a section of a further embodiment of an electrochemical cell in which the connection conductors, the cell terminals and/or the insulating element have reduced thicknesses and/or in which the first cell terminal and/or the second cell terminal have passage openings that have a reduced average width;

FIG. 85 is a schematic perspective view of a section of the electrochemical cell from FIG. 84, the first contact element and the first connection conductor being formed in one part and/or the second contact element and the second connection conductor being formed in one part;

FIG. 86 is a schematic perspective view of the first contact element and part of the first connection conductor of the electrochemical cell from FIGS. 84 and 85, the first contact element and the first connection conductor being at least approximately step-shaped in a cross section taken perpendicular to the main extension plane of the cover element; and

FIG. 87 is a schematic perspective view of the second contact element and part of the second connection conductor of the electrochemical cell from FIGS. 84 to 86, the second contact element and the second connection conductor being at least approximately step-shaped in a cross section taken perpendicular to the main extension plane of the cover element.

The same or functionally equivalent elements are provided with the same reference signs in all figures.

### DETAILED DESCRIPTION OF THE DRAWINGS

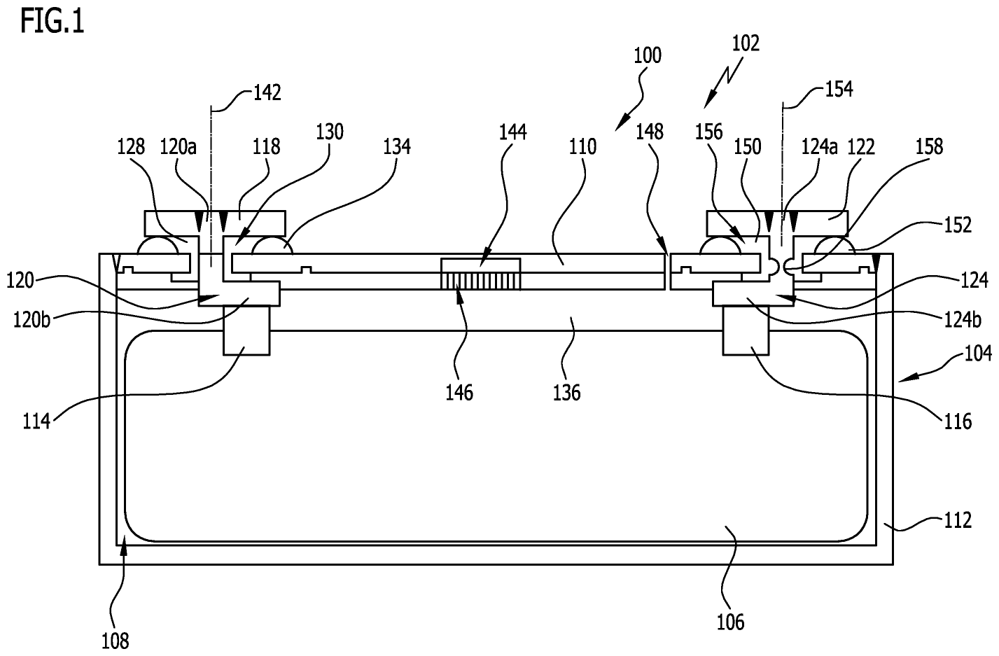

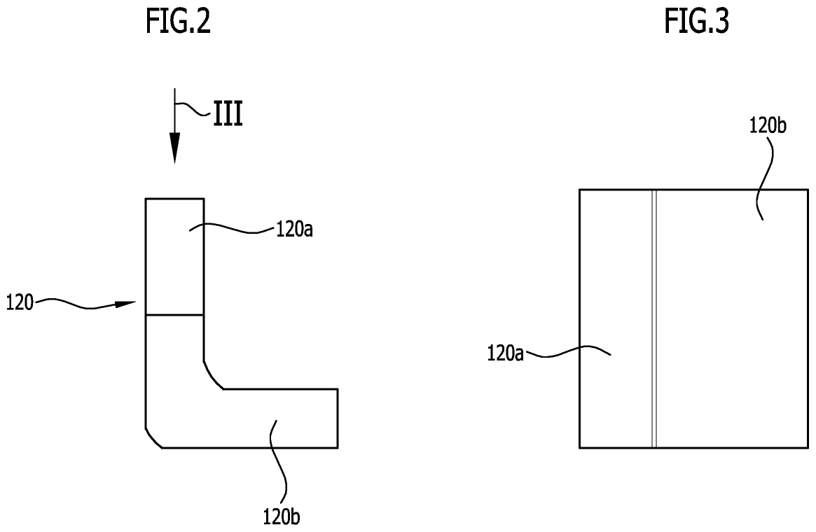

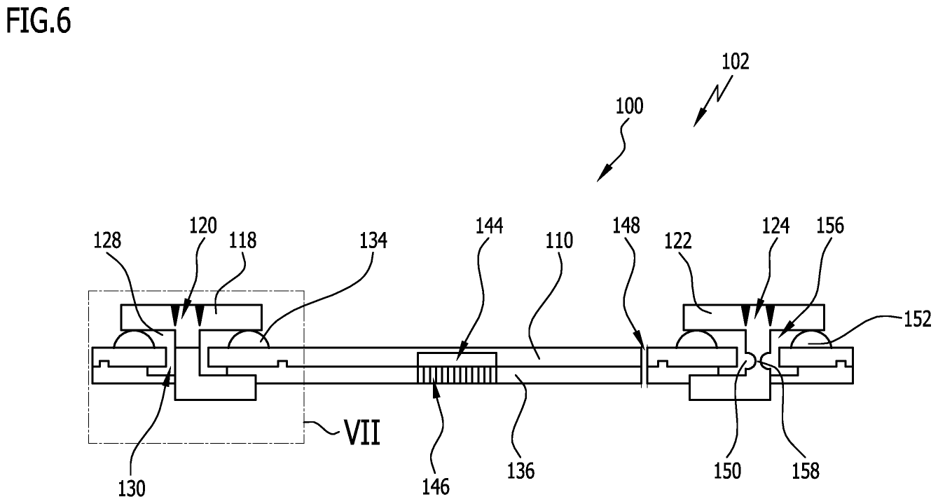

FIGS. 1 to 10 show a first embodiment of an electrochemical cell denoted as a whole by 100, as well as individual components thereof.

The electrochemical cell 100 is, for example, a battery cell and/or an accumulator cell.

Preferably, the electrochemical cell 100 is a lithium-ion cell.

The electrochemical cell 100 preferably forms part of an electrochemical system 102 that, in particular, comprises a plurality of electrochemical cells 100.

The electrochemical system 102 is, for example, an accumulator module and/or a battery module.

For example, the electrochemical cell 100 is used in a vehicle.

The electrochemical cell 100 preferably comprises a housing 104 for accommodating an electrochemical element 106. The housing 104 surrounds an interior space 108 of the electrochemical cell 100 and comprises a cover element 110 as a first housing component.

The cover element 110 preferably covers a further housing component 112 of the housing 104 and/or is connected to the further housing component 112 in a fluid-tight manner.

The further housing component 112 is in particular in the form of a trough or cup. Said further housing component preferably surrounds the interior space 108 of the electrochemical cell 100 on five sides.

The housing 104 of the electrochemical cell 100 is preferably at least approximately cuboid.

It can be advantageous if the cover element 110 is plate-shaped, for example made of sheet metal. In particular, the cover element 110 comprises a metallic material, for example aluminum, or is formed from the metallic material. For example, the cover element 110 is formed from a metal sheet, for example from an aluminum sheet.

The cover element 110 is preferably integrally connected to the further housing component 112 of the housing 104, preferably by means of welding, for example by means of laser welding.

The electrochemical element 106 is in particular what is known as a “cell winding.”

It can be advantageous if the electrochemical element 106 is connected to a first connection conductor 114 and a second connection conductor 116 or comprises them.

The first connection conductor 114 serves in particular to electrically connect the electrochemical element 106 to a first cell terminal 118 of the electrochemical cell 100, in particular via a first contact element 120 of the electrochemical cell 100.

The second connection conductor 116 is preferably used to electrically connect the electrochemical element 106 to a second cell terminal 122 of the electrochemical cell 100, in particular via a second contact element 124 of the electrochemical cell 100.

The second cell terminal 122 preferably comprises or is formed from a first metallic material, for example aluminum.

For example, the second cell terminal 122 is designed as a cathode.

Alternatively, it can be provided that the second cell terminal 122 is in the form of an anode (not shown).

The electrical connection of the electrochemical element 106 to the first cell terminal 118 and/or the second cell terminal 122 is provided in particular by the fact that the respective connection conductor 114, 116 is fixed on the one hand to the electrochemical element 106 and on the other hand to the respective contact element 120, 124.

In the present case, the first connection conductor 114 and/or the second connection conductor 116 are fixed to the electrochemical element 106 on a side of the electrochemical element 100 that faces the cover element 110, in particular from above.

The first cell terminal 118 preferably comprises or is formed from a first metallic material, such as aluminum.

For example, the first cell terminal 118 is designed as an anode.

Alternatively it can be provided that the first cell terminal 118 is a cathode (not shown).

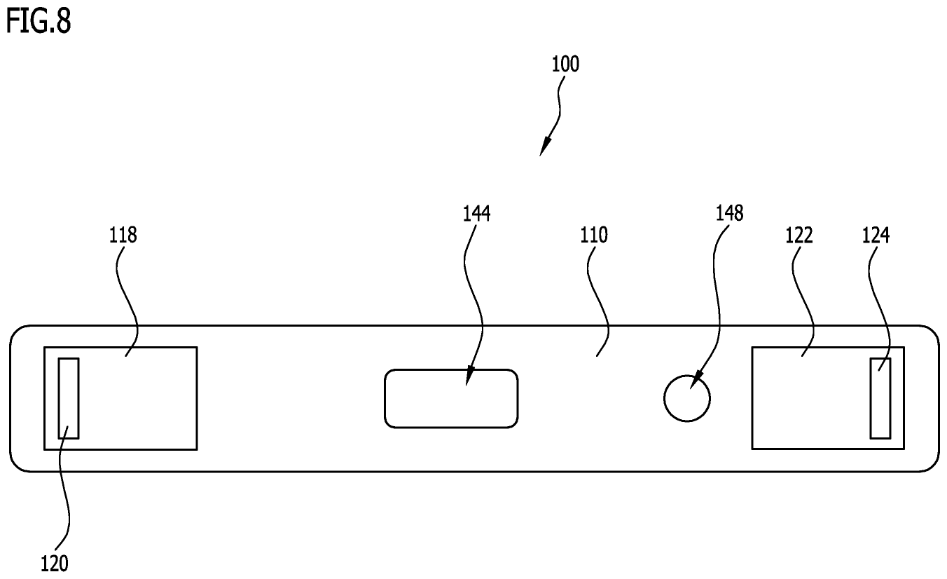

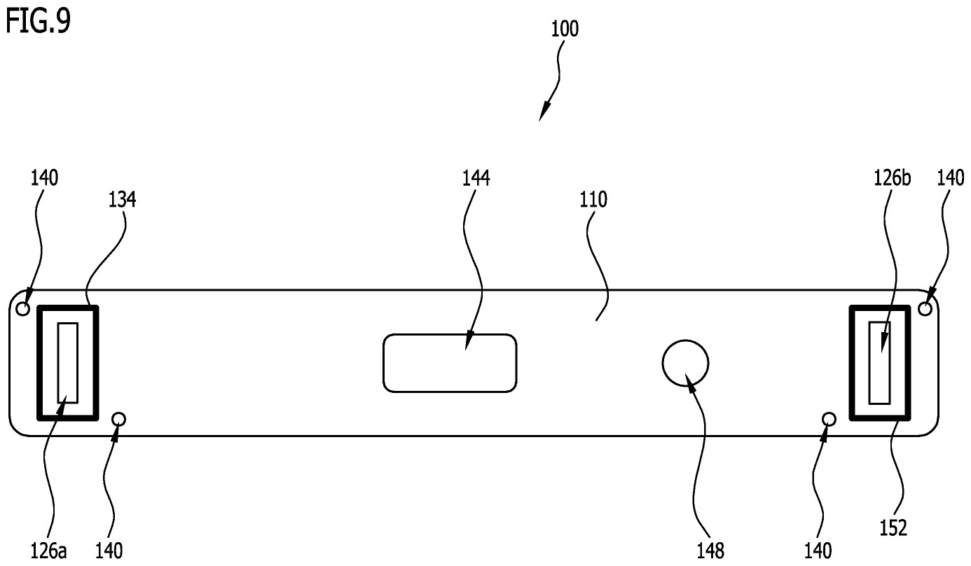

It can be advantageous if the first cell terminal 118 has a passage opening 119 through which a first contact element component 120a of the first contact element 120 is passed (cf. FIG. 8).

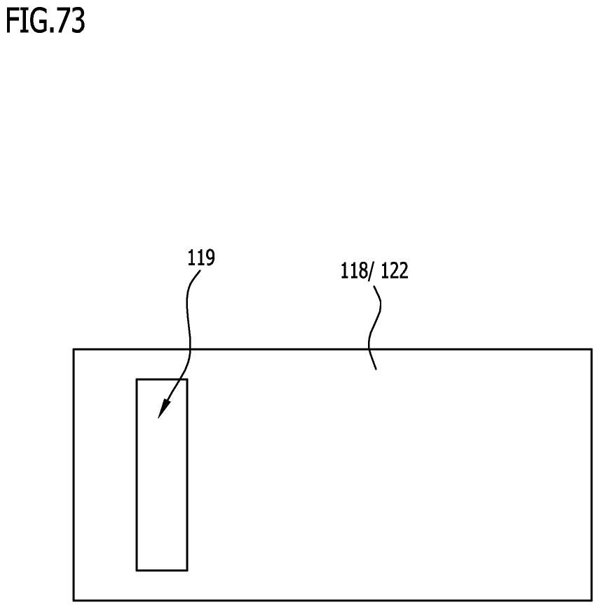

The first cell terminal 118 and the second cell terminal 122 are configured identically in the present case. The cell terminal 118 or 122 is shown separately in FIG. 73.

The passage opening 119 of the first cell terminal 118 has in particular a shape that is at least approximately complementary to a cross section of the first contact element 120.

For example, the first cell terminal 118 and/or the second cell terminal 122 each has a cuboid recess.

The first cell terminal 118 is preferably integrally connected to a first contact element component 120a of the first contact element 120, for example by means of welding.

The first contact element component 120a preferably comprises or is formed from the same material as the first cell terminal 118.

It can be advantageous if the first contact element component 120a of the first contact element 120 comprises or is formed from aluminum.

The first contact element 120 preferably comprises a second contact element component 120b, which in particular comprises or is formed from a second metallic material. The second metallic material differs in particular from the first metallic material.

For example, the second contact element component 120b of the first contact element 120 comprises or is formed from copper.

It can be favorable if the first contact element component 120a and the second contact element component 120b of the first contact element 120 are integrally connected to one another, for example by means of laser welding and/or roll cladding.

It can be provided that the second contact element component 120b at least approximately has an L-shape in a cross section taken perpendicular to a primary side of the electrochemical cell 100. During production, the second contact element component is preferably bent into the L-shape.

Due to the fact that one leg of the L-shape has a main extension plane that is arranged at least approximately parallel to a main extension plane of the cover element 110, a surface connection of the first connection conductor 114 to the second contact element component 120b can take place.

It can be favorable if the first connection conductor 114 is integrally connected, in particular by means of welding, to a leg of the first contact element 120 facing away from the first cell terminal 118, for example on an underside of the said first contact element facing away from the cover element 110.

The cover element 110 preferably comprises a first opening 126a, through which the first contact element 120 is guided.

The first opening 126a of the cover element 110 is, for example, at least an anode opening.

Alternatively it can be provided that the first opening 126a of the cover element 110 is at least a cathode opening (not shown).

It can be advantageous if the first contact element 120 and the first cell terminal 118 fixed thereto are fixed in a first connection region 130 by means of a first potting element 128.

The first potting element 128 preferably fills the first connection region 130 completely.

For example, a region formed in the region of the first opening 126a between the cover element 110 and the first contact element 120 is completely filled.

The first potting element 128 is preferably formed from a first polymer material that comprises or is formed from a first resin material.

It can be favorable if the first resin material comprises or is formed from one or more of the following materials: epoxy resin material, phenolic resin material, aminoplast material, polyurethane material, silicone material, polyester resin material, ABS resin material.

It can be advantageous if the first resin material has a hardness of approx. 40 Shore D or more, in particular approx. 50 Shore D, for example approx. 60 Shore D or more, in a hardened state relative to the first polymer material.

The hardness of the first resin material in a hardened state relative to the first polymer material is approx. 100 Shore D or less, in particular approx. 97 Shore D or less, for example approx. 95 Shore D or less.

The hardness is determined according to DIN EN ISO 868 in particular.

It can be favorable if the first resin material has a glass transition temperature of approx. 90° C. or more, in particular approx. 95° C. or more, for example approx. 100° C. or more. The glass transition temperature is preferably related to a hardened state of the first resin material relative to the first polymer material.

Preferably, the first resin material is a one-part resin material, for example a one-part epoxy resin material.

One-component epoxy resin materials preferably have increased stability with respect to an electrolyte accommodated in the interior space 108.

It can be favorable if the first resin material comprises one or more fillers. The one or more fillers are preferably selected from: inorganic fillers, in particular silicon oxide; carbonate; carbide, in particular silicon carbide; nitride, in particular metal nitride; metal oxide.

Preferred silicon oxides include silicates.

By using fillers, oxygen diffusion and/or water diffusion from an environment of the electrochemical cell 100 into the interior space 108 via the first potting element 128 can be avoided or reduced.

It can be favorable if the connection region 130 and/or the first potting element 128 is delimited by an underside of the first cell terminal 118 facing the interior space 108 of the electrochemical cell 100 on an outer side of the cover element 110 facing away from the interior space 108 of the electrochemical cell and laterally by a first sealing element 134.

The first sealing element 134 is preferably applied to an upper side of the cover element 110 facing away from the interior space 108 in a printing process, for example in a pattern printing process, in particular in a screen printing process, a stencil printing process and/or a pad printing process.

For example, a third polymer material is applied to the upper side of the cover element 110 by means of an application element and, in particular, is subsequently hardened and/or dried.

For example, the first sealing element 134 is and/or is formed by a sealing bead.

It can be favorable if the third polymer material comprises or is formed from a thermoplastic polymer material, a thermosetting polymer material and/or an elastomeric polymer material.

Preferably, the third polymer material comprises or is formed from one or more of the following materials: polyolefin, in particular polypropylene and/or polyethylene; polyester, in particular polyethylene terephthalate and/or polybutylene terephthalate; polyamide; polyimide; copolyamide; polyamide elastomer; polyether, in particular epoxy resins; polyurethane; polyurethane acrylate; polyvinyl chloride; polystyrene; polymethylmethacrylate; acryl butadiene styrene; synthetic rubber, in particular ethylene-propylene-diene rubber; polycarbonate; polyethersulfone; polyoxymethylene; polyetheretherketone; polytetrafluoroethylene; silicone, in particular silicone rubber and/or silicone-based elastomer.

Thermoplastic polymer materials are preferably used for the third polymer material. For example, hot melt materials are used for the third polymer material.

It can be advantageous if the third polymer material comprises one or more fillers, the one or more fillers being selected, for example, from: inorganic fillers, for example silicon oxide, carbonate, silicon carbide, metal oxide, nitride, in particular metal nitride.

As can be seen in particular in FIG. 9, provision can be made for the first sealing element 134 to be at least approximately rectangular in cross section taken parallel to the main extension plane of the cover element 110.

It can be favorable if the first sealing element 134 is arranged at a distance from the first opening 126a of the cover element 110, the first sealing element 134 preferably having the same distance circumferentially from an edge of the cover element 110 surrounding the opening.

The electrochemical cell 100 preferably comprises an insulating element 136 that serves in particular to insulate the interior space 108 and/or to fix the first contact element 120 and the second contact element 124 in a more stable manner.

The insulating element 136 is preferably at least approximately plate-shaped and/or is fixed to the cover element 110 on an inner side 132 of the cover element 110 facing the interior space 108, in particular integrally and/or in a force-locking and/or form-fitting manner.

The insulating element 136 preferably comprises or is formed from a fifth polymer material.

The fifth polymer material is preferably a thermoplastic polymer material, for example an injection moldable and/or electrolyte-resistant thermoplastic polymer material.

Preferably, the insulating element 136 is an injection-molded element.

It can be provided that the insulating element 136 is produced separately, for example in an injection molding process, and is then connected to the cover element 110.

Alternatively, it can be provided that the insulating element 136 is injection molded onto the cover element 110.

It can be advantageous if the insulating element 136 comprises one or more positioning projections 138, in this case four (cf., for example, FIG. 9). The one or more positioning projections 138 preferably extend away from a main body of the insulating element 136 along a direction pointing from the interior space 108 in the direction of the cell terminals 118, 122.

The positioning projections 138 preferably engage in positioning recesses 140 of the cover element 110 that are designed to be complementary thereto.

For example, the positioning projections 138 engage behind the cover element 110 in a direction arranged parallel to a main extension plane of the cover element 110.

In the present case, the positioning projections 138 are designed in the form of pins, for example as positioning pins.

The ability of the cover element 110 and the insulating element 136 to move relative to one another parallel to a main extension plane of the cover element 110 by means of the positioning projections 138 engaging in the positioning recesses 140 is preferably blocked.

It can be provided that the insulating element 136 has a bulge and/or depression 165 facing the first connection region 130, in particular such that a part of the first potting element 128 is accommodated between the cover element 110 and the insulating element 136.

For example, the first potting element 128 engages behind the cover element 110 in a direction parallel to a central axis 142 of the first contact element 120.

It can be favorable if the electrochemical cell 100 has at least one predetermined breaking point 144 that tears and/or breaks when a critical interior temperature and/or a critical interior space pressure is exceeded.

It can be provided that the at least one predetermined breaking point 144 is designed as a material weak point of the cover element 110.

It can be favorable if a predetermined breaking point 144 is arranged centrally between the first cell terminal 118 and the second cell terminal 122.

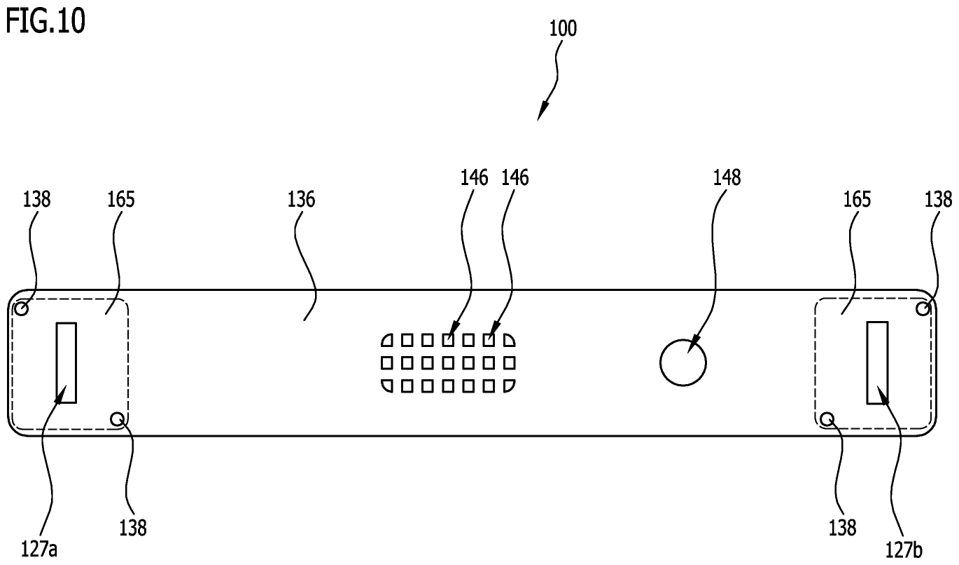

As can be seen in particular in FIG. 10, the insulating element 136 preferably has recesses 146 (designated by way of example) in the region of the at least one predetermined breaking point 144, which recesses are in particular arranged regularly.

The recesses 146 are preferably delimited by webs, which are in particular cross-shaped. A splash guard can be formed by the web structure.

It can be advantageous if the insulating element 136 has a plurality of depressions 165, in the present case two, (indicated by dashed lines in FIG. 10), in the region in which the insulating element 136 has a reduced thickness. The depressions 165 preferably serve to accommodate resin material and/or delimit a volume formed by the respective connection region 130, 156 toward the interior space 108 of the electrochemical cell 100.

The electrochemical cell 100 preferably has an electrolyte filling opening 148 that extends through the cover element 110 and the insulating element 136 and/or is used to fill the interior space 108 with electrolyte.

The second contact element 124 is fixed to the cover element 110 by means of a second potting element 150. The second potting element 150 preferably completely fills a second connection region 156.

With regard to the arrangement and/or configuration of the second potting element 150 and the second connection region 156, reference is made to the explanations in connection with the first potting element 128 and the first connection region 130.

The second potting element 150 is preferably formed from a second polymer material. Preferably, the second polymer material comprises or is formed from a second resin material.

In a hardened state relative to the second polymer material, the second resin material preferably has a glass transition temperature of approx. 90° C. or more, in particular approx. 95° C. or more, for example approx. 100° C. or more.

It can be advantageous if the second polymer material comprises or is formed from one or more of the following materials: epoxy resin material, phenolic resin material, aminoplast material, polyurethane material, silicone material, polyester resin material, ABS resin material.

Preferably, the second resin material has a hardness of approx. 40 Shore D or more, in particular approx. 50 Shore D or more, for example approx. 60 Shore D or more, in a hardened state relative to the second polymer material.

The hardness of the second resin material hardened relative to the second polymer material is preferably approx. 100 Shore D or less, in particular approx. 97 Shore D or less, for example 95 Shore D or less.

The hardness is preferably determined according to DIN ISO 868.

It can be advantageous if the second resin material comprises one or more fillers. The fillers are selected, for example, from one or more of the following: inorganic fillers, in particular silicon oxide; carbonate; carbide, in particular silicon carbide; nitride, in particular metal nitride; metal oxide.

It can be favorable if the second resin material comprises an epoxy resin material or is formed therefrom.

Preferably, the second resin material comprises or is formed from a one-part resin material, for example a one-part epoxy resin material.

According to the first embodiment of an electrochemical cell 100, it is provided that the first resin material and the second resin material are identical.

According to alternative embodiments, the first resin material and the second resin material are chemically and/or physically different resin materials.

It can be favorable if the first resin material during production of the first potting element 128 and/or the second resin material during production of the second potting element 150 has a viscosity of approx. 10² mPa s or more, in particular of approx. 10³ mPa s or more.

The viscosity of the first resin material and/or the second resin material during production of the electrochemical cell 100 is preferably approx. 10⁶ mPa s or less, in particular 10⁵ mPa s or less.

Filling the first connection region 130 with the first resin material and/or of the second connection region 156 with the second resin material preferably takes place at ambient pressure.

The electrochemical cell 100 preferably has a second sealing element 152, which in particular radially surrounds and/or delimits the second potting element 150 with respect to a central axis 154 of the second contact element 124 on an outer side of the cover element 110 facing away from the interior space 108.

The second connection region 156, in which the second potting element 150 is preferably arranged, is preferably delimited and/or defined by an underside of the second cell terminal 122 facing the interior space 108 and by a side of the second sealing element 152 facing the second contact element 124 on a side of the cover element 110 facing away from the interior space 108.

On a side of the cover element 110 facing the interior space 108, the second connection region 156 is preferably delimited and/or defined by a depression 165 formed on a side of insulating element 136 facing away from interior space 108, by an inner side 132 of the cover element 110 facing the interior space 108, and by an outer surface of the second contact element 124.

The second sealing element 152 preferably comprises or is formed from a fourth polymer material.

For example, the fourth polymer material is applied to the outside of the cover element 110 by means of an application element and, in particular, is subsequently hardened and/or dried.

For example, the second sealing element 152 is formed by a sealing bead.

It can be favorable if the fourth polymer material comprises or is formed from a thermoplastic polymer material, a thermosetting polymer material and/or an elastomeric polymer material.

It can be advantageous if the fourth polymer material of the second sealing element 152 and the third polymer material of the first sealing element 134 are chemically and/or physically identical.

A material selection and/or design and/or arrangement of the second sealing element 152 corresponds in the present case to the material selection and/or design and/or arrangement of the first sealing element 134, such that reference is made to the relevant statements.

The sealing elements 134, 152 preferably form contact surfaces for the cell terminals 118, 122.

As an alternative to forming the first sealing element 134 during production thereof, it can be provided that the first sealing element 134 is a separate component, in particular a component that can be handled separately.

For example, the first sealing element 134 is an insert, for example a plastic frame.

Additionally or alternatively, it can be provided that the second sealing element 152 is a separate component, in particular a component that can be handled separately.

For example, the second sealing element 152 is an insert, for example a metal frame.

In the case of a separately produced first sealing element 134 and/or a separately produced second sealing element 152, it can be provided that these are inserted into a receiving space provided for this purpose in the cover element 110 and/or into a receiving space in the respective cell terminal 118, 122 (not shown).

It can be provided that the first sealing element 134 and the first cell terminal 118 terminate flush radially with respect to the central axis 142 of the first contact element 120.

In particular, the second sealing element 152 and the second cell terminal 122 terminate flush with one another radially with respect to the central axis 154 of the second contact element (cf., for example, FIG. 1).

Alternatively, it can be provided that the first cell terminal 118 protrudes beyond the first sealing element 134, for example on a side facing a central region of the cover element 110 arranged between the cell terminals 118, 122.

In particular, the second cell terminal 122 protrudes beyond the second sealing element 152, for example on a side facing the central region of the cover element 110 arranged between the cell terminals 118, 122 (cf., for example, FIG. 8).

It can be favorable if the second contact element 124 is at least approximately rectangular in a cross section taken parallel to a main extension plane of the cover element 110.

It can be advantageous if the second cell terminal 122 has a passage opening 119 that, in particular, is designed to be at least approximately complementary to the cross section of the second contact element 124 (cf. FIG. 73).

It can be advantageous if the second contact element 124 is guided through the passage opening 119 of the second cell terminal 122.

Preferably, an end region of the second contact element component 124b facing away from the interior space 108 of the electrochemical cell 100 is integrally connected, in particular by means of welding, to an edge region of the second cell terminal 122 surrounding the passage opening 119.

The second contact element 124 is preferably made of a flat material, for example in the form of sheet metal.

It can be provided that the second contact element 124 is bent into an L-shape, a main extension plane of a leg of the L-shape facing away from the second cell terminal 122 having a main extension plane that is preferably at least approximately parallel to a main extension plane of the cover element 110.

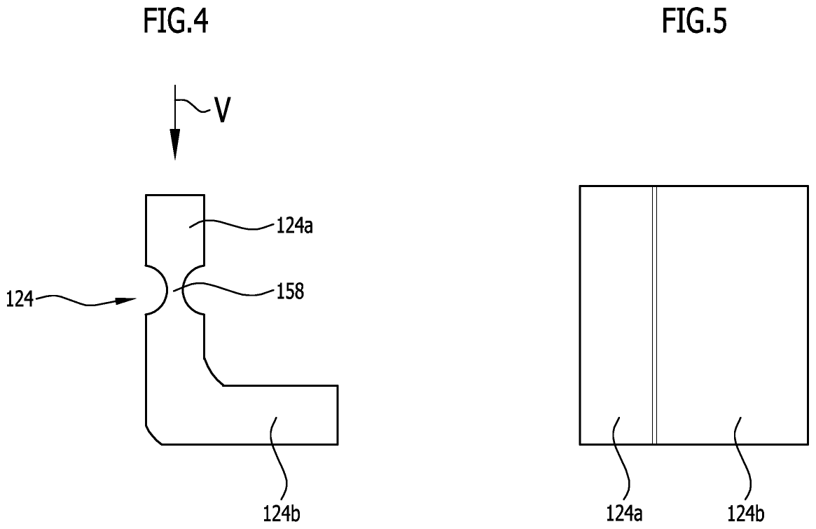

As shown in particular in FIGS. 4 and 5, the second contact element 124 is preferably in one piece.

Alternatively, it can be provided that the second contact element 124 has a first contact element component 124a and a second contact element component 124b that are connected to one another in accordance with the first contact element component 120a and the second contact element component 120b.

Reference is made here to the corresponding description. In contrast to the first contact element 120, the contact conductor components 124a, 124b of the second contact element 124 are preferably made of the same metallic material or comprise the same metallic material, for example aluminum.

For example, the second connection conductor 116 is integrally connected, in particular by means of welding, to a leg of the second contact element 124 facing the interior space 108 on an underside facing the interior space 108.

It can be advantageous if the second contact element 124 has at least one fuse element 158, for example in the second connection region 156. The at least one fuse element 158 is preferably a region of the second contact element 124 in which the said contact element has a locally reduced cross-sectional area. The cross-sectional area is preferably defined at least approximately parallel to a main extension plane of the cover element 110.

Preferably, the cross-sectional area of the second contact element 124 in the region of the at least one fuse element 158 is smaller than an average cross-sectional area of the second contact element 124 in adjacent regions by approx. 20% or more, in particular approx. 30% or more, in particular approx. 50% or more.

The at least one fuse element 158 is preferably arranged in a leg of the second contact element 124 that faces away from the interior space 108. For example, the at least one fuse element 158 is a safety fuse.

The at least one fuse element 158 preferably serves as an overcurrent protection that melts in particular when a critical current is exceeded. The melting of the at least one fuse element 158 preferably electrically disconnects the second cell terminal 122 from the electrochemical element 106.

The second contact element 124 preferably comprises or is formed from the first metallic material, for example aluminum.

To produce the electrochemical cell 100, the cover element 110 is preferably positioned on the insulating element 136, in particular in such a way that the positioning projections 138 and the positioning recesses 140 engage in one another.

The first contact element 120 is then preferably guided through the first opening 126a in the cover element 110 and a first opening 127a in the insulating element 136.

The first opening 127a of the insulating element 136 is, for example, at least an anode opening.

Alternatively it can be provided that the first opening 127a of the insulating element 136 is at least a cathode opening (not shown).

The second contact element 124 is preferably guided through a second opening 126b in the cover element 110 and a second opening 127b in the insulating element 136.

The second opening 126b of the cover element 110 is, for example, at least a cathode opening.

Alternatively it can be provided that the second opening 126b of the cover element 110 is at least an anode opening (not shown).

The second opening 127b of the insulating element 136 is, for example, at least a cathode opening.

Alternatively it can be provided that the second opening 127b of the insulating element 136 is at least an anode opening (not shown).

It can be advantageous if the first contact element 120 and/or the second contact element 124 is fixed relative to the cover element 110 and/or the insulating element 136 by means of a holding element, for example by means of a hold-down device.

The first resin material is then preferably filled from above into the first connection region 130 and/or the first connection region 130 is filled, in particular completely, with the first resin material.

In particular, the second resin material is filled into the second connection region 156 from above and/or the second connection region 156 is filled, in particular completely, with the second resin material.

After filling, the first cell terminal 118 is preferably integrally connected, in particular by means of laser welding, to an edge region of the first contact element 120 facing away from the interior space 108.

After filling, the second cell terminal 122 is preferably integrally connected, in particular by means of laser welding, to an edge region of the second contact element 124 facing away from the interior space 108.

To fix the cell terminals 118, 122, holding elements in the form of hold-down devices are preferably used.

The assembly, in particular without holding elements, is then hardened. Hardening takes place, for example, in a hardening line.

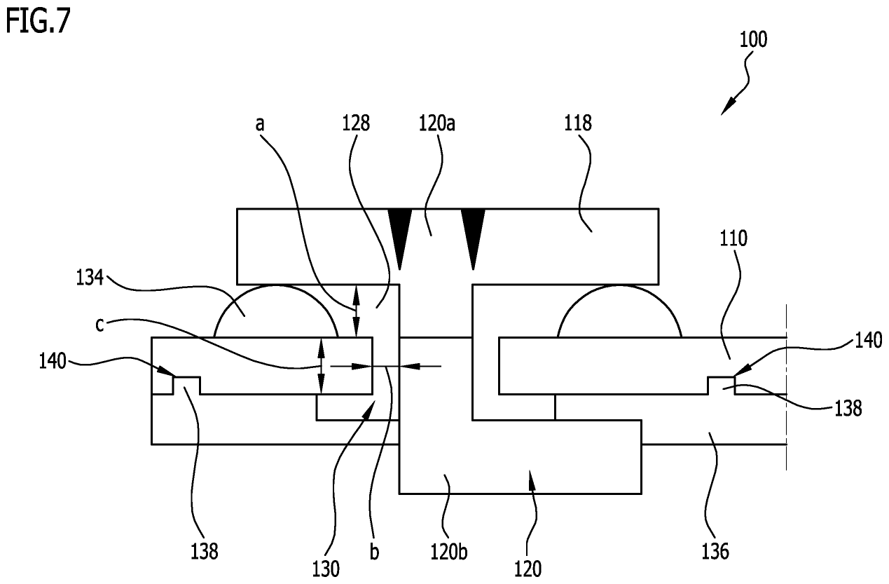

Optimized properties are preferably formed if the first connection region 130 and/or the second connection region 156 has the following features (cf. FIG. 7):
a distance a between the cover element 110 and the first cell terminal 118 in a direction parallel to the central axis 142 and/or a distance a between the cover element 110 and the second cell terminal 122 in a direction parallel to the central axis 154 is 0.05 mm or more; and/or
a distance b between the first contact element 120 and the cover element 110 in the region of the first opening 126a of the cover element 110 and/or a distance b between the second contact element 124 and the cover element 110 in the region of the second opening 126b of the cover element 110 is 0.05 mm or more; and/or
a ratio between the distance a and a thickness of the cover element 110 is in a range of approx. 0.005 to 1.

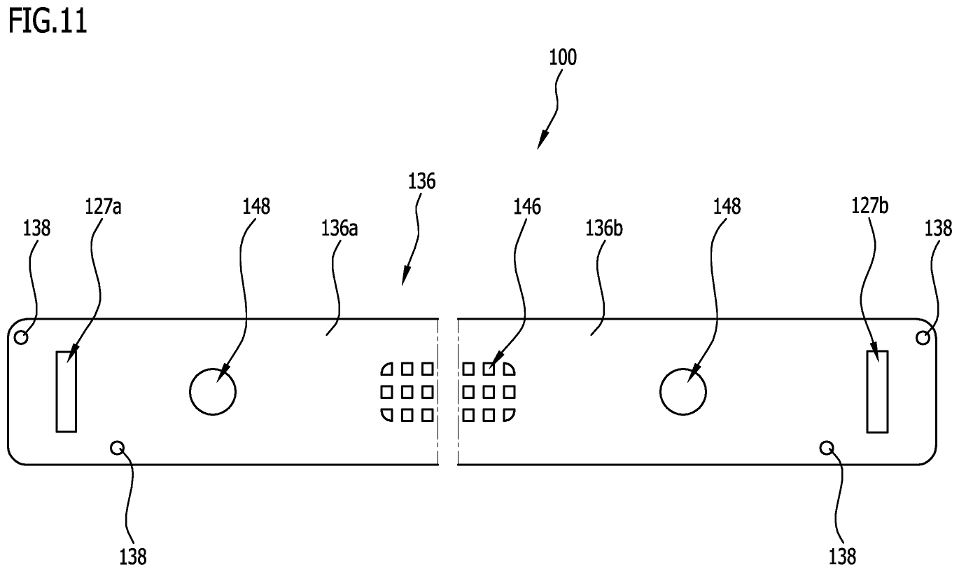

FIG. 11 shows an insulating element 136 of a further embodiment of an electrochemical cell 100, which is not shown as a whole in the drawings. In the present case, the insulating element 136 is formed in two parts and has a first insulating element component 136a and a second insulating element component 136b.

It can be advantageous if the first insulating element component 136a and the second insulating element component 136b are mirror-symmetrical with respect to a plane of symmetry that is arranged at least approximately perpendicular to a main extension plane of the insulating element 136.

It can be favorable if the insulating element 136 has a plurality of electrolyte filling openings 148. For example, two electrolyte filling openings 148 are arranged in a respective central region of the respective insulating element component 136a, 136b.

The two insulating element components 136a, 136b are preferably connected to one another integrally and/or in a form-fitting and/or force-locking manner.

It can be provided that the first insulating element component 136a and the second insulating element component 136b are each connected to the cover element 110 integrally and/or in a force-locking manner.

Otherwise, the further embodiment of an electrochemical cell 100 corresponds in terms of structure and function to the first embodiment shown in FIGS. 1 to 10, such that reference is made to the description thereof.

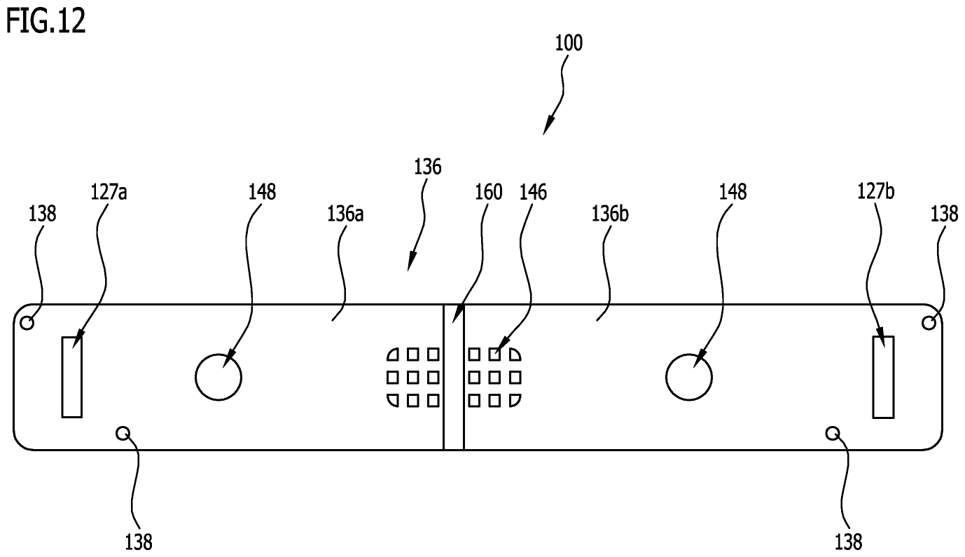

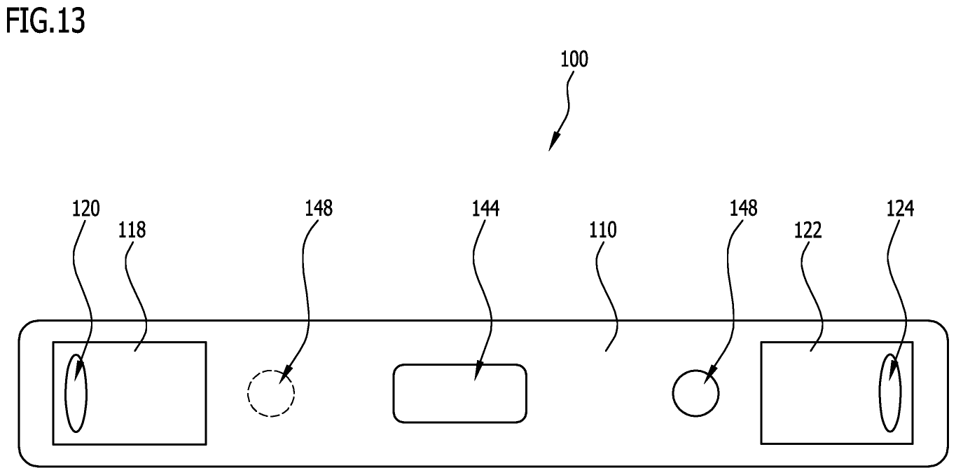

FIG. 12 shows an insulating element 136 of a further embodiment of an electrochemical cell 100, which is not shown as a whole in the drawings.

The insulating element 136 shown in FIG. 12 has a compensation element 160 in the center between the first opening 127a and the second opening 127b.

The compensation element 160 is preferably used to compensate for mechanical stresses that arise in particular due to a critical pressure being exceeded in the interior space 108 of the electrochemical cell 100 and/or a critical temperature being exceeded in the interior space 108 of the electrochemical cell 100.

The compensation element 160 is preferably integrally connected to the first insulating element component 136a arranged laterally thereto and/or to the second insulating element component 136b arranged laterally thereto.

It can be advantageous if the insulating element 136 has a plurality of, for example two, electrolyte filling openings 148, which are preferably arranged in accordance with the electrolyte filling openings 148 in the insulating element 136 shown in FIG. 11.

Otherwise, the further embodiment of an electrochemical cell 100, which is not shown as a whole in the drawings, substantially corresponds in terms of structure and function to the first embodiment shown in FIGS. 1 to 10, such that reference is made to the description thereof.

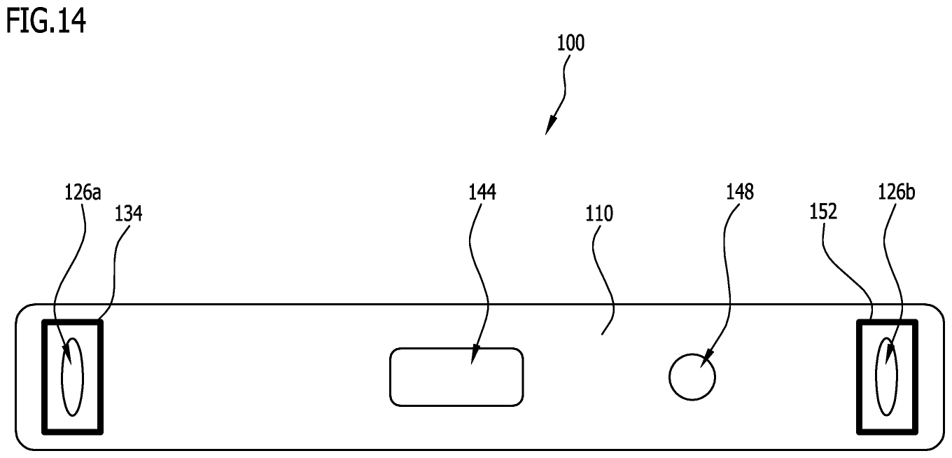

FIGS. 13 to 15 show a section of a further embodiment of an electrochemical cell 100, which is not shown as a whole in the drawings.

According to this embodiment, the first contact element 120 and/or the second contact element 124 preferably has an at least approximately elliptical and/or oval cross section.

The cross section is preferably taken parallel to a main extension plane of the cover element 110.

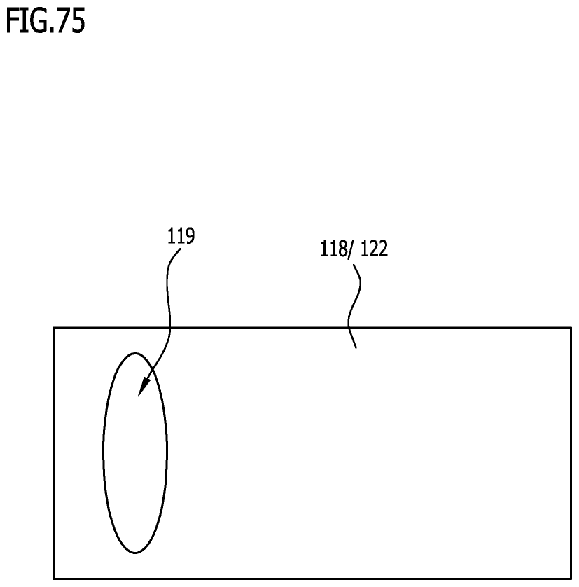

As shown in particular in FIG. 75, the first cell terminal 118 and/or the second cell terminal 122 according to this further embodiment preferably has an at least approximately elliptical and/or oval passage opening 119.

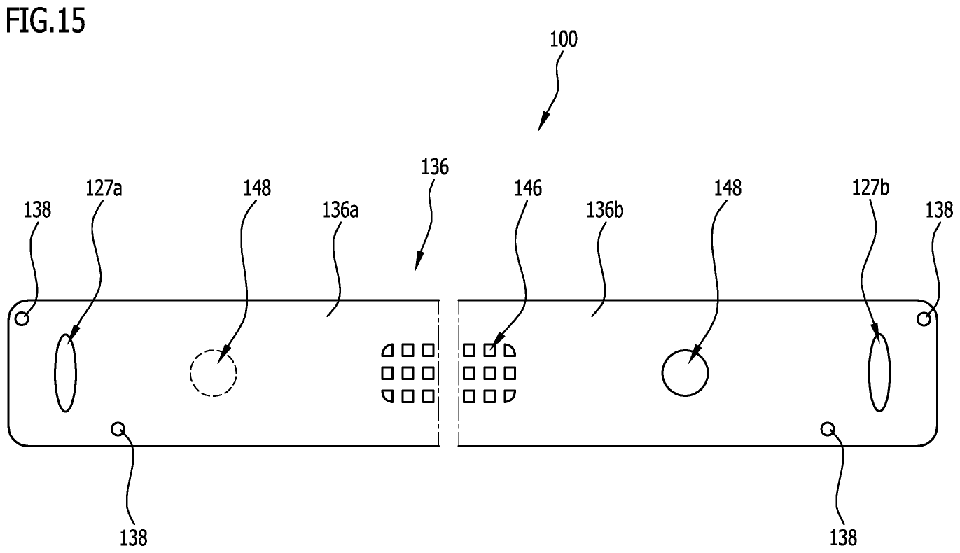

As can be seen in particular in FIG. 15, the insulating element 136 is preferably formed in two parts. Alternatively, it can be provided that the insulating element 136 is formed in one part and/or has a compensation element 160.

The second electrolyte filling opening 148 is optional.

Otherwise, the further embodiment of an electrochemical cell 100, which is not shown as a whole in the drawings, substantially corresponds in terms of structure and function to the first embodiment shown in FIGS. 1 to 10, such that reference is made to the description thereof.

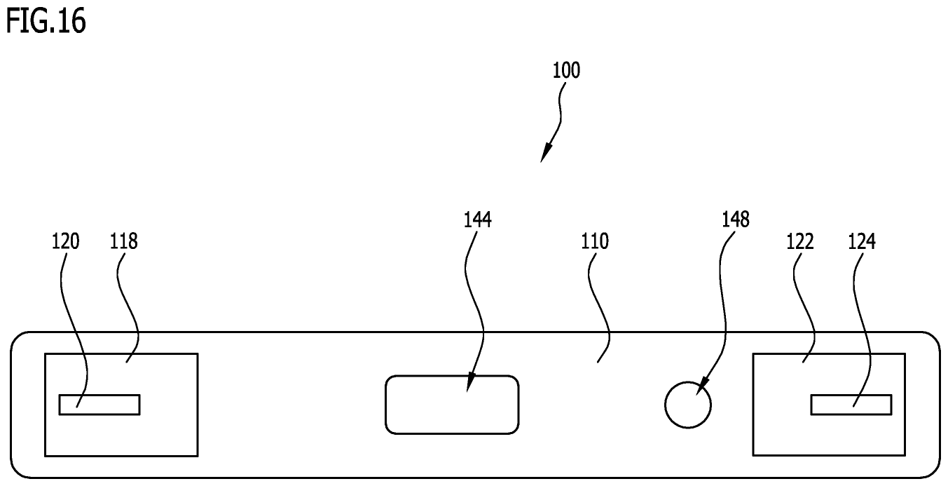

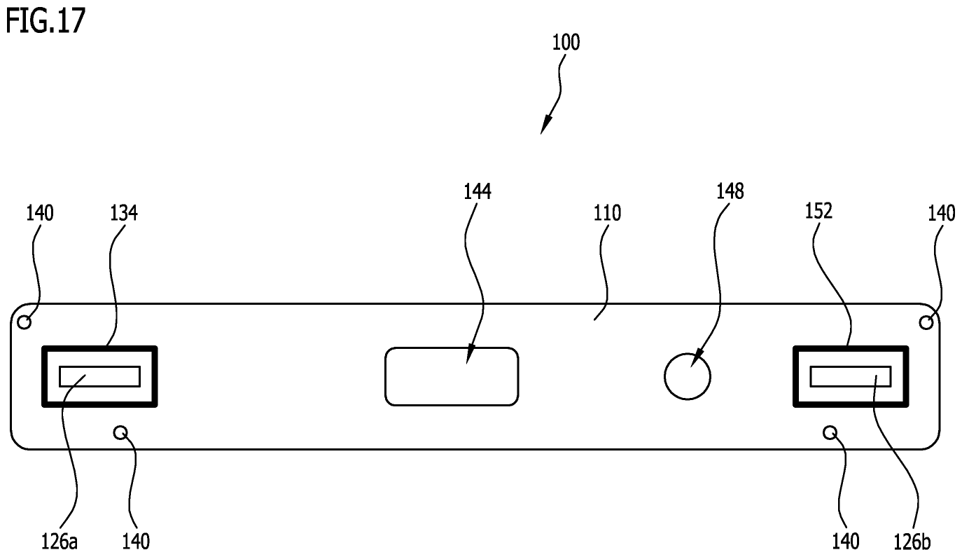

FIGS. 16 and 17 show a section of a further embodiment of a further embodiment of an electrochemical cell 100, which is not shown as a whole in the drawings.

In terms of structure and function, this further embodiment differs from the first embodiment shown in FIGS. 1 to 10 substantially in that the first contact element 120 and/or the second contact element 124 has a main direction of extent in a cross section taken perpendicularly to a main extension plane of the cover element 110, which main direction of extent is arranged at least approximately parallel to a primary side of the electrochemical cell 100.

Accordingly, main extension directions of the first opening 126a and/or the second opening 126b of the cover element 110 are arranged in particular at least approximately parallel to the primary side of the electrochemical cell 100.

FIG. 16 shows a state after the first cell terminal 120 and the second cell terminal 122 have been fixed.

In the state shown in FIG. 17, the first contact element 120 and the second contact element 124 have not yet passed through the first opening 126a or the second opening 126b of the cover element 110. The first cell terminal 118 and the second cell terminal 122 are also not yet mounted in the state shown in FIG. 17.

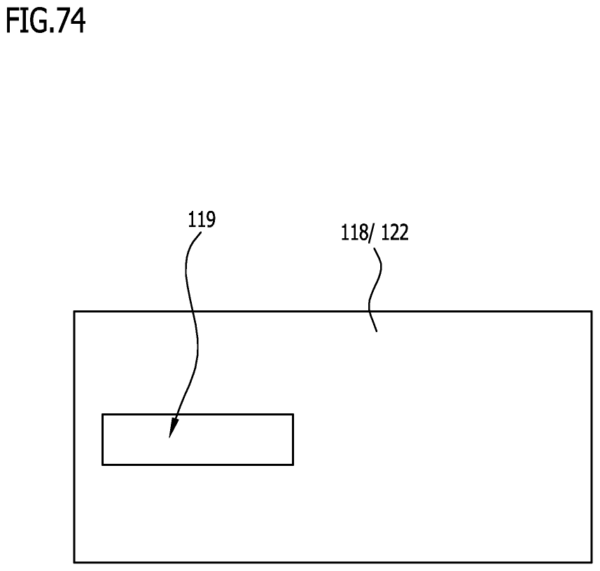

As shown in particular in FIG. 74, a passage opening 119 formed in the first cell terminal 118 and/or in the second cell terminal 122 preferably has a main direction of extent that is arranged at least approximately parallel to a primary side of the electrochemical cell 100.

Otherwise, the further embodiment of an electrochemical cell 100, which is not shown as a whole in FIGS. 16 and 17, substantially corresponds in terms of structure and function to the first embodiment shown in FIGS. 1 to 10, such that reference is made to the description thereof.

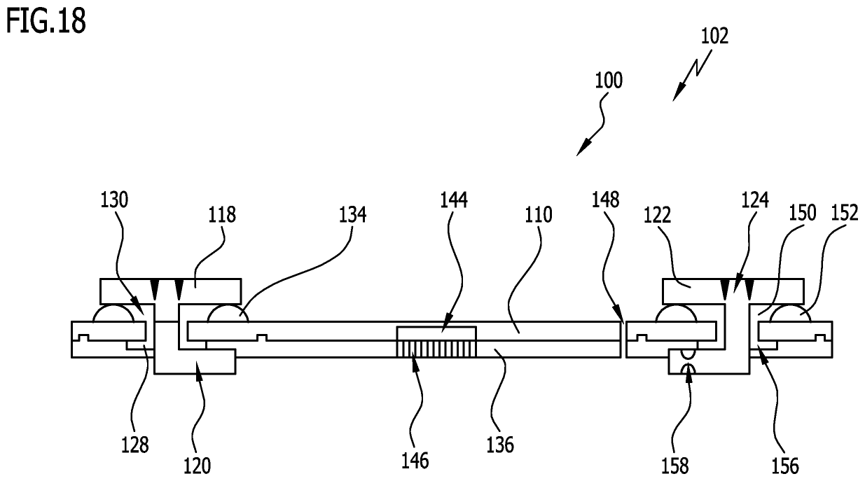

A further embodiment of an electrochemical cell 100, which is not shown as a whole in FIG. 18, differs in terms of structure and function from the first embodiment shown in FIGS. 1 to 10 substantially in that the fuse element 158 is arranged outside the second connection region 156.

This preferably serves to avoid leakage when the fuse element 158 is triggered.

In particular, the fuse element 158 is encapsulated with an electrolyte-resistant thermoplastic polymer material. Polyethylene, polyethylene terephthalate, polypropylene and/or polybutylene terephthalate are preferably suitable as electrolyte-resistant thermoplastic polymer materials.

It can be advantageous if the fuse element 158, for example in the form of a safety fuse, is arranged adjacent to an end of the second contact element 124 that is remote from the second cell terminal 122.

Otherwise, the further embodiment of an electrochemical cell 100, which is not shown as a whole in FIG. 18, substantially corresponds in terms of structure and function to the first embodiment shown in FIGS. 1 to 10, such that reference is made to the description thereof.

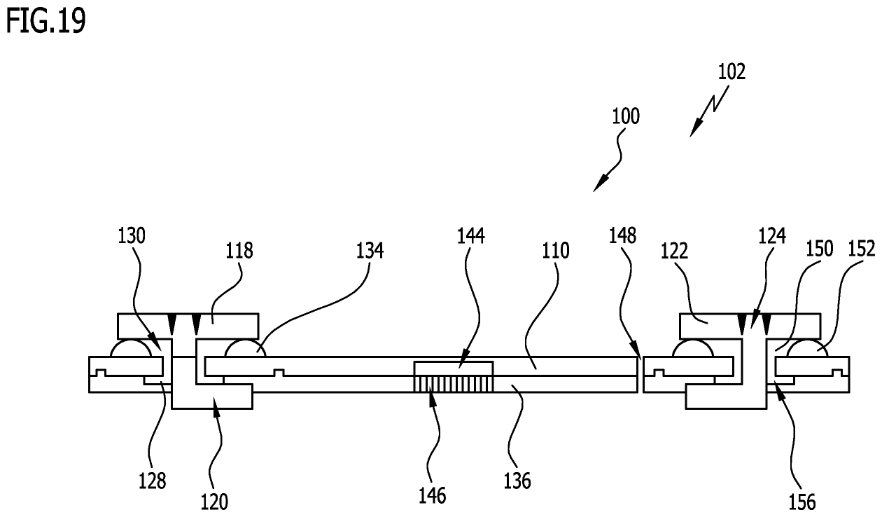

A further embodiment of an electrochemical cell 100, which is not shown as a whole in FIG. 19, differs in terms of structure and function from the first embodiment shown in FIGS. 1 to 10 substantially in that the second contact element 124 has no fuse element 158.

It can be advantageous if the fuse element 158 forms part of the second connection conductor 116 (not shown).

Otherwise, the further embodiment of an electrochemical cell 100, which is not shown as a whole in FIG. 19, substantially corresponds in terms of structure and function to the first embodiment shown in FIGS. 1 to 10, such that reference is made to the description thereof.

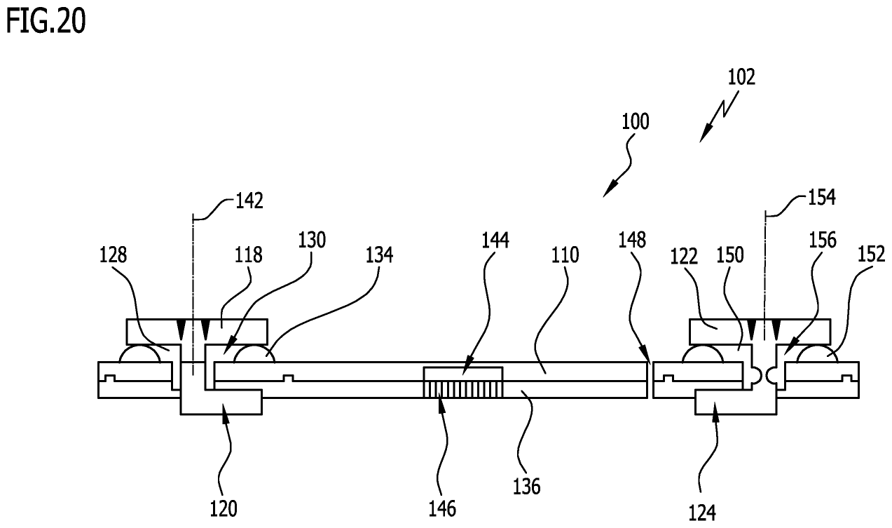

A further embodiment of an electrochemical cell 100, which is not shown as a whole in FIG. 20, differs in terms of structure and function from the first embodiment of an electrochemical cell 100 shown in FIGS. 1 to 10 substantially in that
the first potting element 128 does not radially engage behind the cover element 110 with respect to the central axis 142 of the first contact element 120 on an inner side 132 of the cover element 110 facing the interior space 108; and/or
the second potting element 150 does not radially engage behind the cover element 110 with respect to the central axis 154 of the second contact element 124 on an inner side 132 of the cover element 110 facing the interior space 108.

It can be favorable if the first potting element 128 and the second potting element 150 have at least approximately the same shape.

It can be advantageous if the dimensions of a first depression 165 in the insulating element 136 correspond at least approximately to the dimensions of the first opening 126a in the cover element 110.

The dimensions of a second depression 165 in the insulating element 136 preferably correspond at least approximately to the dimensions of the second opening 126b in the cover element 110.

With the exception of the first opening 126a and/or the second opening 126b, a continuous direct integral contact is preferably formed between the insulating element 136 and the cover element 110.

Otherwise, the further embodiment of an electrochemical cell 100, which is not shown as a whole in FIG. 20, substantially corresponds in terms of structure and function to the first embodiment shown in FIGS. 1 to 10, such that reference is made to the description thereof.

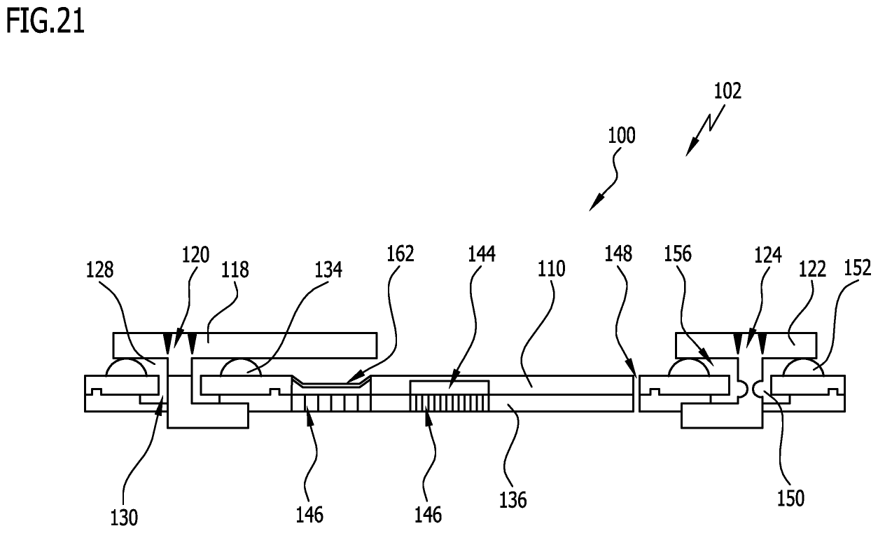

A further embodiment of an electrochemical cell 100, which is not shown as a whole in FIGS. 21 to 23, differs in terms of structure and function from the first embodiment shown in FIGS. 1 to 10 substantially in that the electrochemical cell 100 comprises a snap-over element 162 that is in a rest state during a normal operating state of the electrochemical cell 100 shown in FIG. 21.

In FIG. 21, the first cell terminal 118 is shown as being larger than the second cell terminal 122 for clarity. Preferably, the first cell terminal 118 and the second cell terminal 122 have substantially the same dimensions.

In the rest state, the snap-over element 162 preferably extends in the direction of insulating element 136.

It can be advantageous if the snap-over element 162 transitions to a working state in which the snap-over element 162 protrudes into an exterior space of the housing 104 when the pressure in the interior space 108 of the electrochemical cell 100 exceeds a threshold pressure value (critical pressure) and/or when the temperature in the interior space 108 of the housing 104 exceeds a threshold temperature value (critical temperature).

The snap-over element 162 is preferably arranged in a region of the cover element 110 that is arranged below the first cell terminal 118 in a direction arranged perpendicular to the main extension plane of the cover element 110.

In the normal operating state of the electrochemical cell 100 shown in FIG. 21, the snap-over element 162 is preferably arranged at a distance from the first cell terminal 118.

When the electrochemical cell 100 is in an overcharged state, which is not shown in the drawings, the short circuit between the first cell terminal 118 on the one hand and the housing 104 and the second contact element 124 on the other hand is generated by the fact that the pressure in the interior space 108 of the electrochemical cell 100 increases when the electrochemical cell 100 causes a transition of the snap-over element 162 from the rest state shown in FIG. 21 to the working state not shown in the drawings.

In the operating state of the snap-over element 162, the snap-over element 162 presses against the first cell terminal 118 such that the first cell terminal 118 comes into electrically conductive contact with the cover element 110, which triggers a short circuit between the first cell terminal 118 and the housing 104.

In embodiments in which a snap-over element 162 is provided, it can be favorable if the fourth polymer material of the second sealing element 152 comprises one or more conductive additives.

Suitable conductive additives are preferably one or more of the following: carbon materials, in particular conductive carbon black, graphite, graphene, carbon nanotubes, carbon fibers and/or carbon nano-onions; particulate metallic materials, in particular metal powder; electrically conductive ceramic materials, in particular nitrides and/or carbides; electrically conductive polymers, in particular trans-polyacetylene, polypyrrole, polyaniline, poly(-phenylene), polythiophene and/or polystyrene doped poly(3,4-ethylenedioxythiophene) (PEDOT:PSS).

Preferred particulate metallic materials preferably comprise or are formed from aluminum, copper, titanium, iron or silver and/or alloys of the materials mentioned.

Due to the one or more conductive additives, the second sealing element 152 preferably has sufficient electrical conductivity to connect the second contact element 124 to the cover element 110 in an electrically conductive manner.

When the snap-over element 162 transitions from the rest state to the working state and the first cell terminal 118 contacts the cover element 110 in an electrically conductive manner, the fuse element 158 in particular is activated.

The fuse element 158 preferably melts, as a result of which the second cell terminal 122 in particular is electrically isolated from the electrochemical element 106. In this way, further overcharging of the electrochemical cell 100 can be avoided.

As can be seen in FIG. 22, the cover element 110 preferably has an opening, which is, for example, at least approximately round, into which opening the snap-over element 162 is introduced, for example by means of welding or gluing.

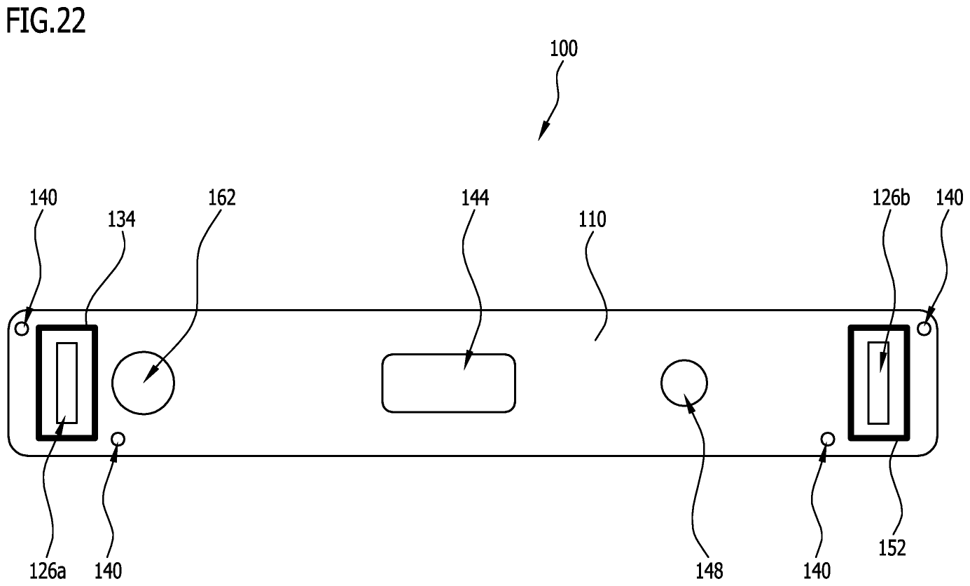

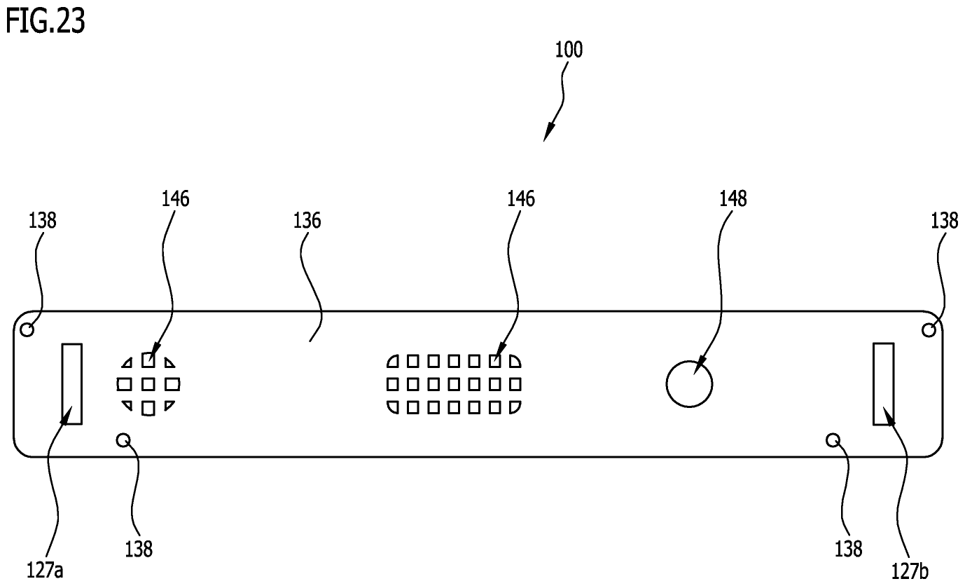

In the region of the snap-over element 162, the insulating element 136 preferably has a plurality of recesses that are in particular arranged regularly. For example, the plurality of recesses are separated from one another and/or delimited by webs arranged in the form of a grid (cf. FIG. 23).

A splash guard is preferably formed by the webs and/or the recesses, which splash guard can reduce or prevent excessive leakage of electrolyte from the interior space 108 of the electrochemical cell 100.

Otherwise, the further embodiment of an electrochemical cell 100 shown in FIGS. 21 to 23 substantially corresponds in terms of structure and function to the first embodiment shown in FIGS. 1 to 10, such that reference is made to the description thereof.

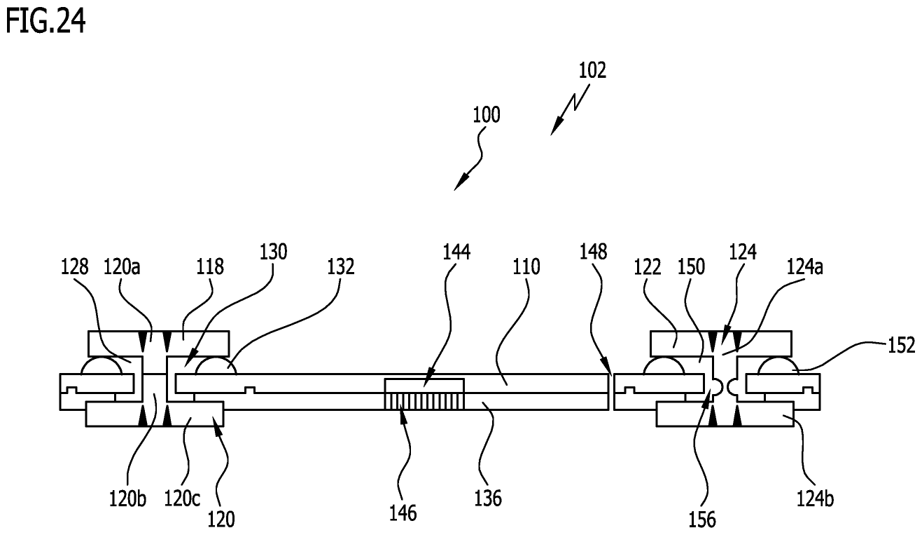

A further embodiment of an electrochemical cell 100, which is not shown as a whole in FIGS. 24 to 28, differs in terms of structure and function from the first embodiment shown in FIGS. 1 to 10 substantially in that the first contact element 120 has an at least approximately T-shaped cross section and/or in that the second contact element 124 has an at least approximately T-shaped cross section. The cross section is preferably taken parallel to a primary side of the electrochemical cell 100.

It can be advantageous if the first contact element 120 has a first contact element component 120a that comprises or is formed from a first metallic material, for example aluminum.

As described in connection with the first embodiment of an electrochemical cell 100, the first contact element component 120a is integrally connected to the first cell terminal 118 on the one hand and to a second contact element component 120b on the other.

In the present case, both the first contact element component 120a and the second contact element component 120b are at least approximately cuboid.

It can be favorable if the first contact element 120 has a third contact element component 120c that is fixed in particular to the second contact element component 120b on a side of the second contact element component 120b facing away from the first contact element component 120a.

For example, the second contact element component 120b is accommodated centrally in an opening in the third contact element component 120c. Preferably, the second contact element component 120b and the third contact element component 120c of the first contact element 120 are integrally connected to one another, for example by means of laser welding and/or roll cladding.

As an alternative to the variant shown, pins that are oval in cross section can be punched out of a contact element component and then welded into a metal sheet.

The second contact element component 120b and/or the third contact element component 120c of the first contact element 120 preferably comprise or are formed from a second metallic material, for example copper.

The second metallic material is preferably a different metallic material than the first metallic material.

It can be provided that the third contact element component 120c is at least approximately cuboid and/or in the form of sheet metal.

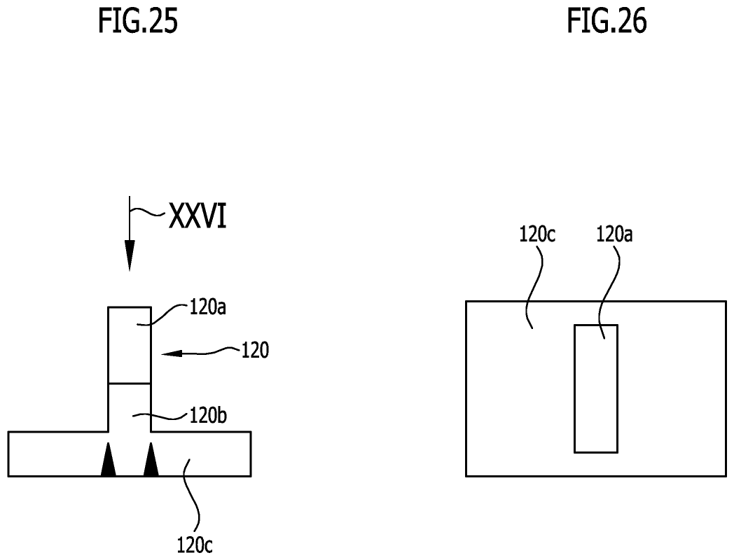

The third contact element component 120c preferably has an at least approximately rectangular recess through which the second contact element component 120b is passed (cf. FIGS. 25 and 26).

In particular, edges of the recesses of the third contact element component 120c and an edge region of the second contact element component 120b facing away from the first contact element component 120a are integrally connected to one another, for example by means of welding.

It can be advantageous if the second contact element 124 is made of a plurality of parts.

The second contact element 124 preferably comprises a first contact element component 124a that is fixed on the one hand to the second cell terminal 122 and on the other hand to a second contact element component 124b of the second contact element 124, for example by means of welding.

It can be advantageous if a main extension plane of the first contact element component 124a is arranged perpendicular to a main extension plane of the second contact element component 124b.

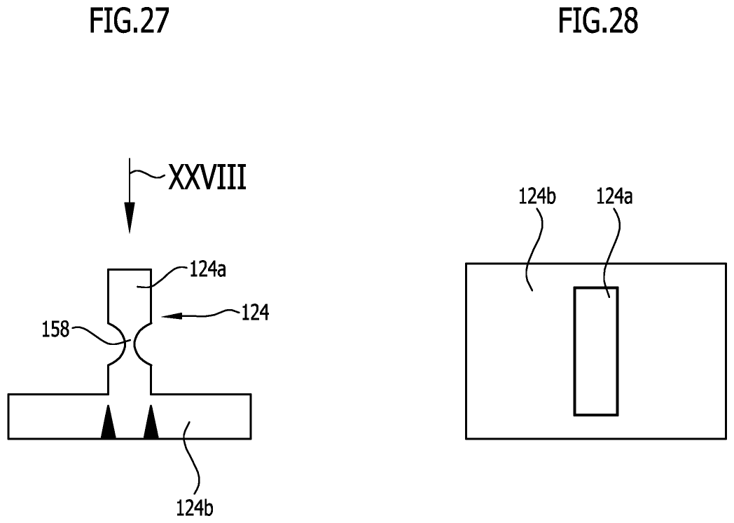

The second contact element component 124b preferably has an at least approximately rectangular recess through which the first contact element component 124a is fixed on a side of the first contact element component 124a that faces away from the first cell terminal 122 (cf. FIGS. 27 and 28).

In addition, it can be provided that the second contact element 124 has a third contact element component (not shown in the drawings) that is fixed, for example, to the second contact element component 124b (as described in connection with the first contact element 120).

The first contact element component 124a, the second contact element component 124b and the third contact element component preferably comprise the same metallic material, for example aluminum, or are formed therefrom.

A cross section of the second contact element 124 is preferably rectangular. The cross section is preferably taken at least approximately parallel to a main extension plane of the cover element 110.

Otherwise, the further embodiment of an electrochemical cell 100 shown in FIGS. 24 to 28 corresponds in terms of structure and function to the embodiment shown in FIGS. 1 to 10, such that reference is made to the description thereof.

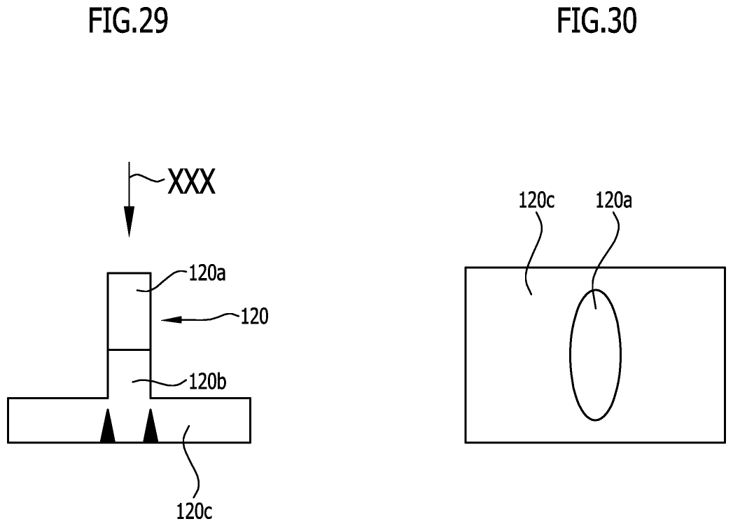

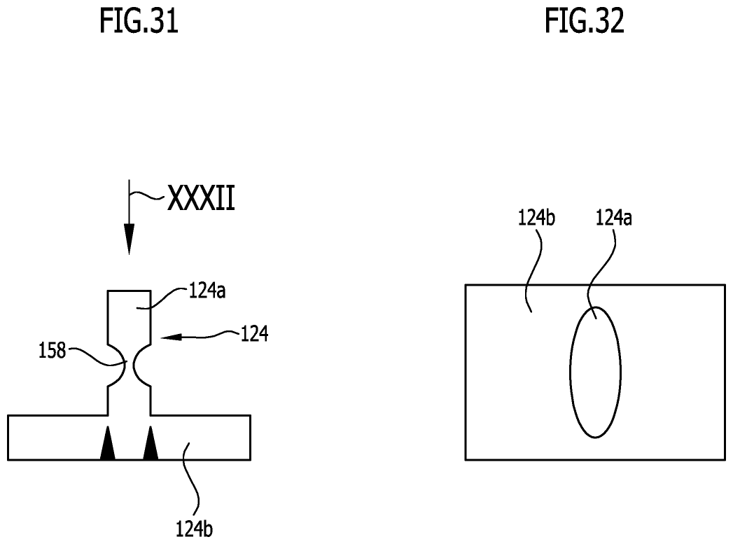

A further embodiment of an electrochemical cell 100, which is not shown as a whole in FIGS. 29 to 32, differs in terms of structure and function from the embodiment shown in FIGS. 24 to 28 substantially in that a cross section of the first contact element component 120a of the first contact element 120 and/or a cross section of the first contact element component 124a of the second contact element 124 is at least approximately elliptical and/or oval.

The cross section is preferably taken parallel to a main extension plane of the cover element 110.

Otherwise, the further embodiment of an electrochemical cell 100 shown in FIGS. 29 to 32 substantially corresponds in terms of structure and function to the embodiment shown in FIGS. 29 to 32, such that reference is made to the description thereof.

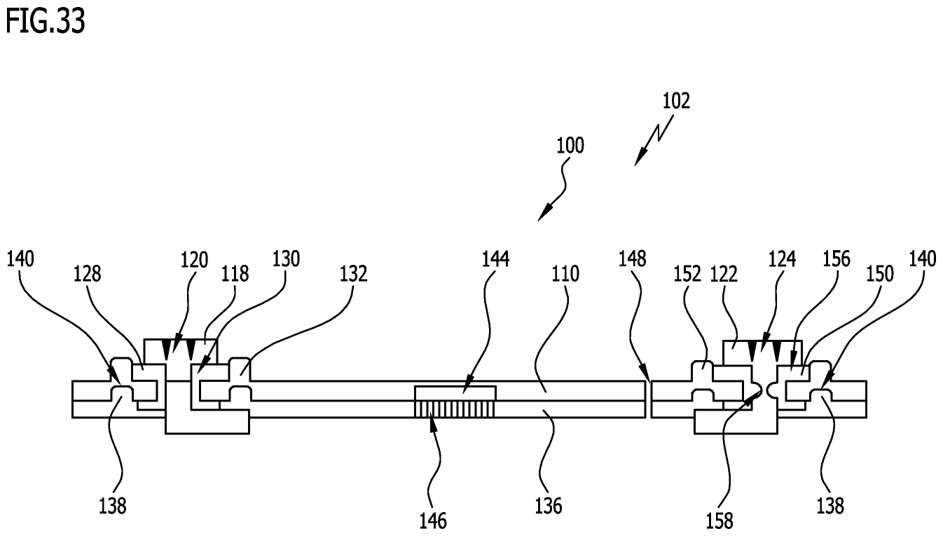

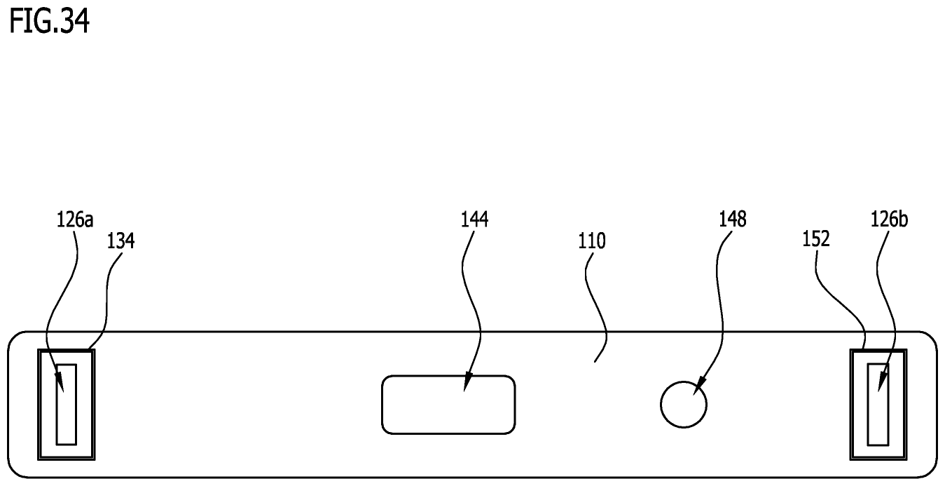

A further embodiment of an electrochemical cell 100, which is not shown as a whole in FIGS. 33 to 35, differs in terms of structure and function from the first embodiment shown in FIGS. 1 to 10 substantially in that the first sealing element 134 and/or the second sealing element 152 forms part of the cover element 110.

A first elevation, which is in particular closed to form a ring shape, preferably extends away from a main body of the cover element 110 in a direction pointing from the interior space 108 toward the first cell terminal 118. The elevation preferably forms the first sealing element 134 and radially surrounds the first potting element 128 with respect to a central axis 142 of the first contact element 120.

In particular, a second elevation, which is in particular closed to form a ring shape, extends away from a main body of the cover element 110 in a direction pointing from the interior space 108 toward the second cell terminal 122.

As an alternative to a closed ring shape, provision can be made for the first sealing element 134 and/or the second sealing element 152 to have at least one interruption (not shown).

The elevation forms the second sealing element 152 and radially surrounds the second potting element 150 with respect to a central axis 154 of the second contact element 124.

It can be provided that the first sealing element 134 and/or the second sealing element 152 is embossed into the cover element 110.

For example, the first sealing element 134 and/or the second sealing element 152 is in the form of embossments.

It can be provided that the second sealing element 152 is in part in the form of a sealing bead made of the fourth polymer material and in part in the form of an embossment and/or bead (not shown).

A bead-sealing bead hybrid sealing element can be formed in this way. According to this embodiment, the fourth polymer material is preferably electrically insulating. An electrically conductive contact surface only exists in regions of the bead and the electrically conductive contact surface between the housing 104 and the second cell terminal 122 is minimized overall. In the event of a fault, a current can be limited to a greater extent.

Additionally or alternatively, the first sealing element 134 can also comprise or be formed from one or more beads and one or more sealing beads in some regions.

FIG. 34 shows the cover element 110 prior to mounting in the electrochemical cell 100.

It can be provided that the first sealing element 134 is formed from the same material as the cover element 110. In particular, the first sealing element 134 is formed in one piece with the main body of the cover element 110.

It can be favorable if the second sealing element 152 is formed from the same material as the cover element 110. In particular, the second sealing element 152 is formed in one piece with the main body of the cover element 110.

It can be favorable if the introduction, for example embossing, of the first sealing element 134 and/or the second sealing element 152 creates a recess and/or indentation on an inner side 132 of the cover element 110 facing the interior space 108 of the housing 104, which recess and/or indentation is in particular designed to be complementary to the elevation forming the respective sealing element 134, 152.

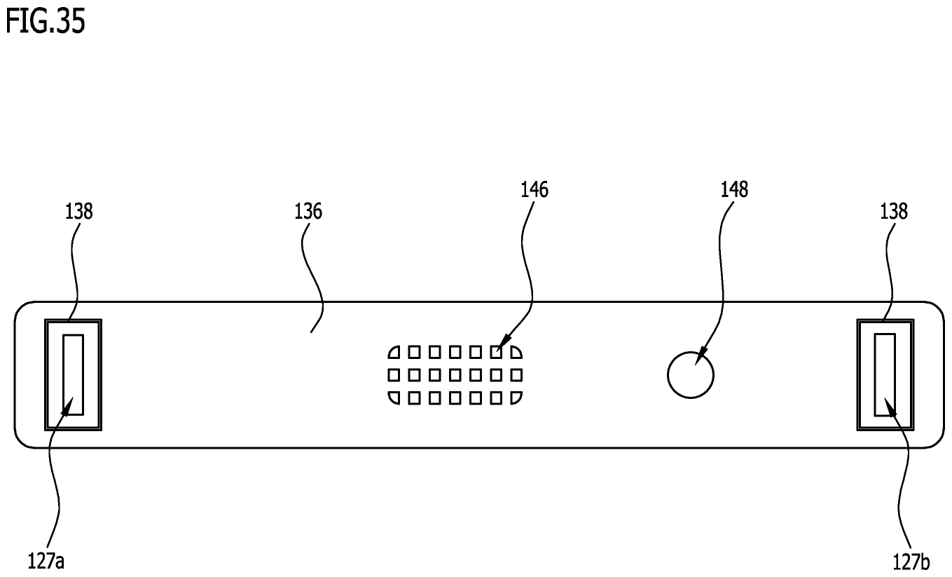

Said recesses and/or indentations preferably form positioning recesses 140. As shown in particular in FIG. 35, the insulating element 136 preferably has positioning projections 138 that are designed in a complementary manner thereto.

In particular, a first positioning projection 138 is closed to form a ring shape around the first opening 127a, for example, by means of a bead.

Preferably, a second positioning projection 138 is closed to form a ring shape around the second opening 127b of the insulating element, for example by means of a bead.

The first positioning projection 138 and/or the second positioning projection 138 has, for example, an at least approximately rectangular cross section. The cross section is preferably taken parallel to a main extension plane of the insulating element 136.

Further positioning projections 138 and positioning recesses 140 designed in a complementary manner thereto are preferably unnecessary.

The cover element 110 can be positioned relative to the insulating element 136 via the positioning projections 138 closed in a ring shape of the insulating element 136 and the positioning recesses 140 of the covering element 110 that are designed to complement said positioning projections closed in a ring shape.

In order to fill in and/or harden the first resin material and the second resin material, the cover element 110 and the insulating element 136 are fixed relative to one another, for example by means of a holding element. In this way, the first resin material and/or the second resin material can be prevented from running before complete hardening.

A hold-down device is preferably used as the holding element.

Otherwise, the further embodiment of an electrochemical cell 100 shown in FIGS. 33 to 35 corresponds in terms of structure and function to the first embodiment shown in FIGS. 1 to 10, such that reference is made to the description thereof.

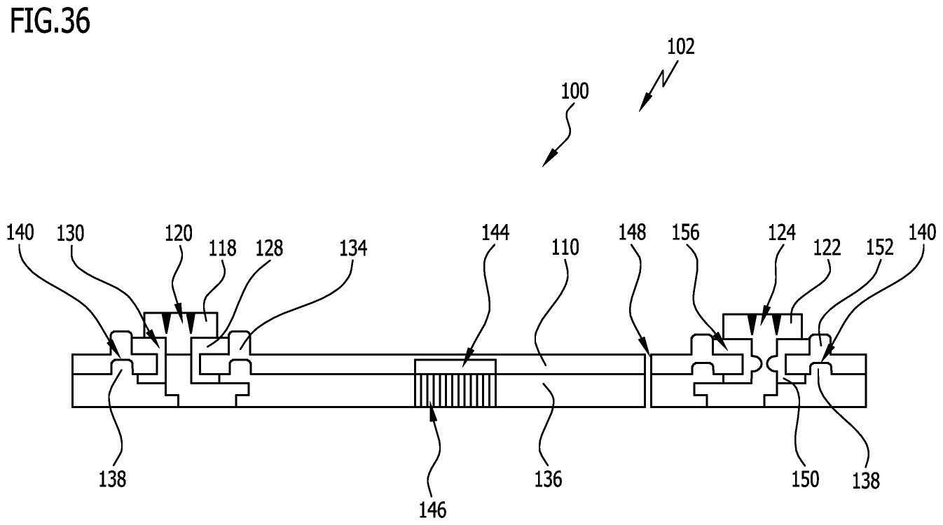

A further embodiment of an electrochemical cell 100, which is not shown as a whole in FIG. 36, differs in terms of structure and function from the first embodiment shown in FIGS. 33 to 35 substantially in that the first contact element 120 and/or the second contact element 124 is inserted into the insulating element 136.

For example, the first contact element 120 forms an insert.

In particular, the second contact element 124 forms an insert.

For example, a form fit is formed between the insulating element 136 and the first contact element 120, in particular in a direction arranged parallel to the central axis 142 of the first contact element 120.

A form fit is preferably formed between the insulating element 136 and the second contact element 124, in particular in a direction arranged parallel to the central axis 154 of the second contact element 124.

A seal between the first contact element 124 and the insulating element 136 and/or the second contact element 124 and the insulating element 136 is formed in particular by the weight of the respective components.

The insulating element 136 is in particular injection molded onto the first contact element 120 and/or the second contact element 124.

Otherwise, the further embodiment of an electrochemical cell shown in FIG. 36 substantially corresponds in terms of structure and function to the embodiment shown in FIGS. 33 to 35, such that reference is made to the description thereof.

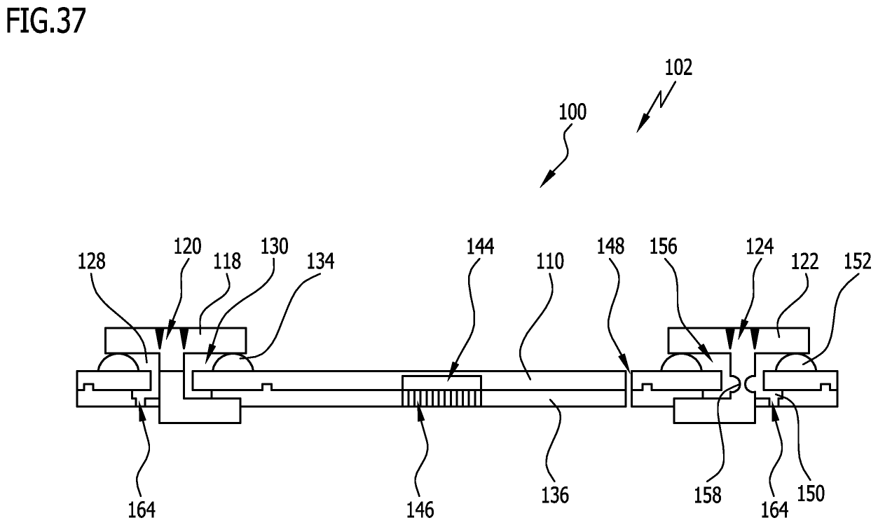

A further embodiment of an electrochemical cell 100, which is not shown as a whole in FIG. 37, differs in terms of structure and function from the first embodiment shown in FIGS. 1 to 10 substantially in that the first resin material and/or the second resin material is filled in after the first cell terminal 118 is connected to the first connection element 120 and/or after the second terminal 122 is connected to the second contact element 124.

In particular, the insulating element 136 has a first filling opening 164 in the region of the first connection region 130, through which first filling opening the first resin material is filled into the first connection region 130 in a flowable state.

It can be advantageous if the insulating element 136 has a second filling opening 164 in the region of the second connection region 156, through which second filling opening the second resin material is filled into the second connection region 156 in a flowable state.

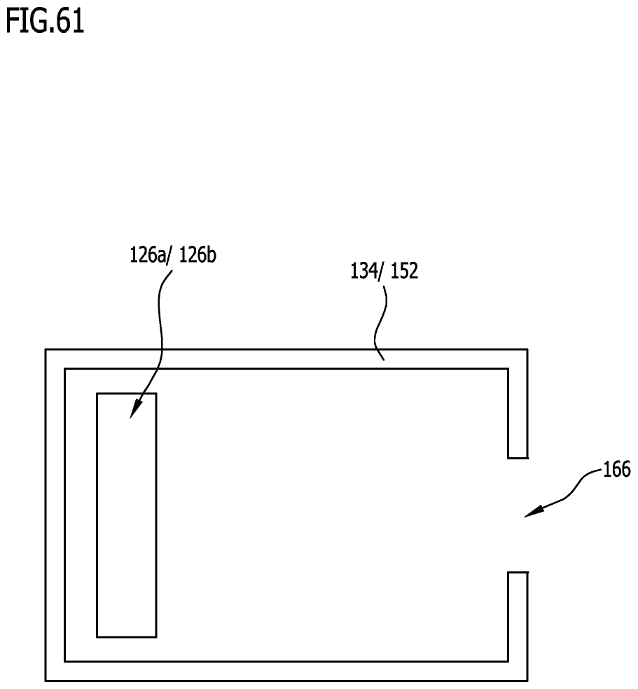

In particular, in order to optimize filling, it can be provided that the first sealing element 134 and/or the second sealing element 152 does not form a closed ring shape, but in particular has one or more interruptions 166 (see FIG. 61).

The one or more interruptions 166 form ventilation openings, for example.

To produce the electrochemical cell 100, the cover element 110 is preferably positioned on the insulating element 136 by means of the positioning projections 138 and positioning recesses 140.

The first opening 126a of the cover element 110 and the first opening 127a of the insulating element 136 are preferably arranged in such a way that they are congruent.

The second opening 126b of the cover element 110 and the second opening 127b of the insulating element 136 are preferably arranged in such a way that they are congruent.

The first contact element 120 is then preferably passed through the first openings 126a, 127a and/or the second contact element 124 is passed through the second openings 126b, 127b.

During this or afterwards, for example, the first cell terminal 118 is positioned on the first contact element 120. In particular, the second cell terminal 122 is positioned on the second contact element 124.

For example, the cell terminals 118, 122 and respective contact elements 120, 124 are held together in a force-locking manner by means of one or more holding elements, for example hold-down devices, while they are connected to one another integrally, for example by means of laser welding.

The one or more holding elements can then be removed.

It can be favorable if the previous component is hardened, for example in a hardening line, before the connection regions 130, 156 are filled.

The first resin material is then preferably filled into the first connection region 130, for example through the first filling opening 164.

In particular, subsequently or during this time, the second resin material is filled into the second connection region 156, for example through the second filling opening 164.

The first resin material and/or the second resin material is/are then converted to the first polymer material or the second polymer material, preferably by means of drying.

This creates the first potting element 128 and the second potting element 150.

Otherwise, the further embodiment of an electrochemical cell 100 shown in FIG. 37 substantially corresponds in terms of structure and function to the first embodiment shown in FIGS. 1 to 10, such that reference is made to the description thereof.

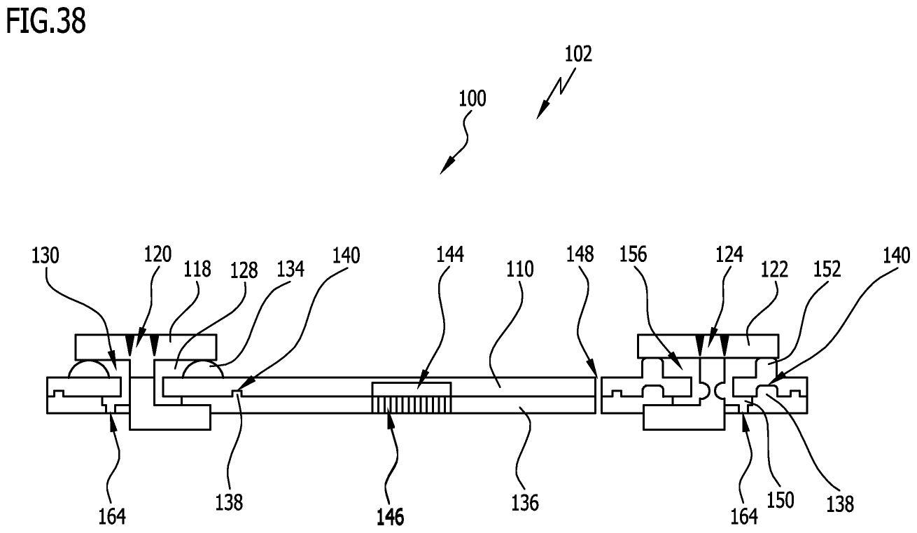

A further embodiment of an electrochemical cell 100, which is not shown as a whole in FIG. 38, differs in terms of structure and function from the embodiment shown in FIG. 37 substantially in that the second sealing element 152, as described in connection with the embodiment shown in FIGS. 33 to 35, is formed as part of the cover element 110.

For example, in the region of the second connection region 156, the cover element 110 rests on a positioning projection 138, formed for example by a bead, of the insulating element 136.

It can be provided that the second cell terminal 122 is in direct integral contact with the second sealing element 152 embodied as an elevation of the cover element 110. This can minimize corrosion.

It can be advantageous if an electrically insulating coating, in particular an oxide layer, for example an aluminum oxide layer, is formed between the second cell terminal 122 and the second sealing element 152. An electrical resistance can thus be formed between the housing 104 and the second cell terminal 122. In particular, said electrical resistance limits the current flow and increases the safety of the electrochemical cell 100.

It can be provided that contact surfaces of the second cell terminal 122 and/or of the second sealing element 152 are subjected to a surface treatment. For example, the contact surfaces are anodized and/or a surface roughness is increased, for example by means of sandblasting.

In this way, on the one hand, the electrical resistance of the contact surfaces can be increased and, on the other hand, direct integral contact between the contact surfaces can be interrupted at least at certain points.

Otherwise, the further embodiment of an electrochemical cell 100 shown in FIG. 38 substantially corresponds in terms of structure and function to the embodiment shown in FIG. 37, such that reference is made to the description thereof.

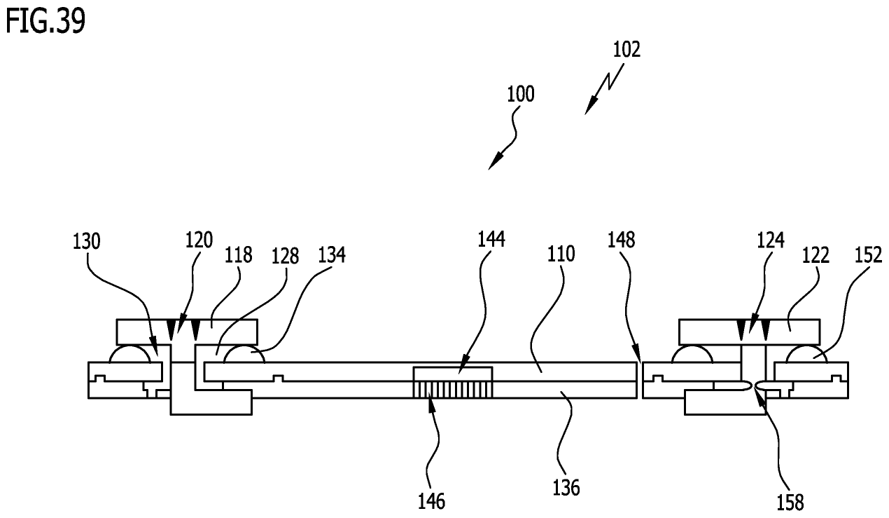

A further embodiment of an electrochemical cell 100, which is not shown as a whole in FIG. 39, differs in terms of structure and function from the embodiment shown in FIG. 37 substantially in that the second contact element 124 is connected to the cover element 108 in an electrically conductive manner and/or integrally.

The fuse element 158 is preferably arranged on a side of the cover element 108 facing the interior space 108 of the housing 104.

For example, the housing 104 is brought to the potential of the second cell terminal 122.

The first resin material and/or the second resin material is preferably filled in when the cell terminals 118, 122 are welded to the contact elements 120, 124.

Otherwise, the embodiment of an electrochemical cell 100 shown in FIG. 39 substantially corresponds in terms of structure and function to the embodiment shown in FIG. 37, such that reference is made to the description thereof.

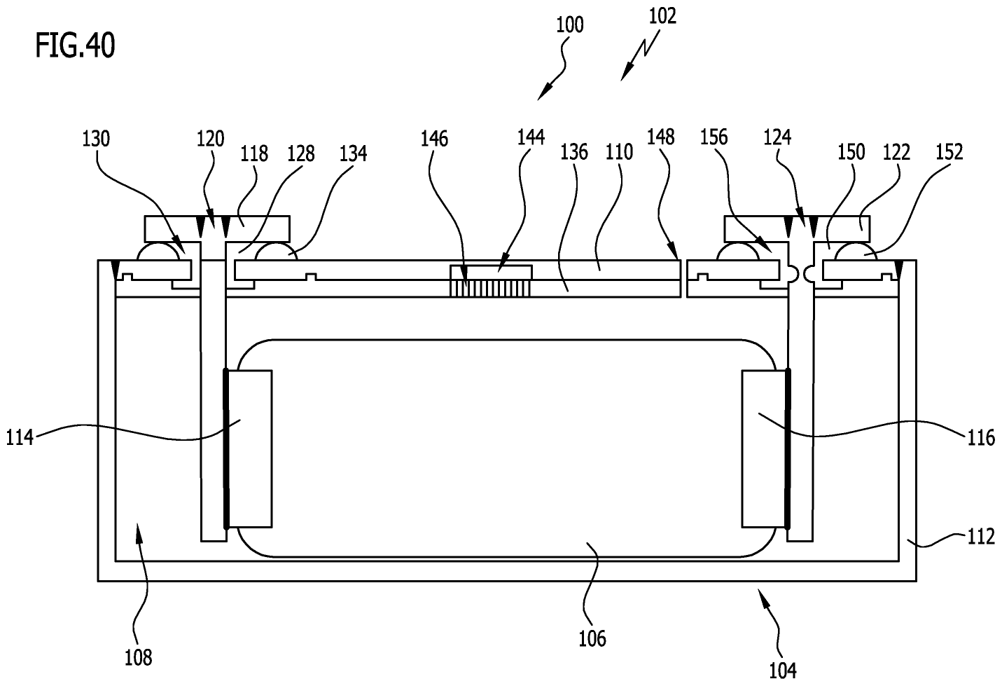

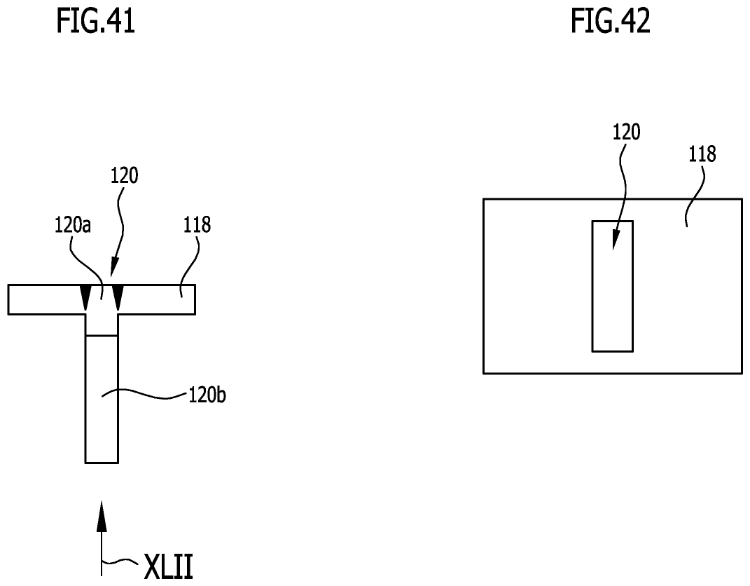

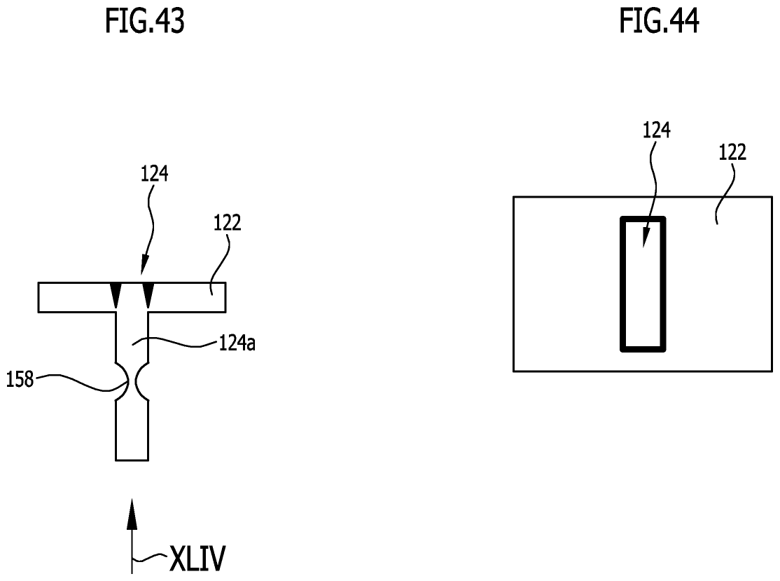

A further embodiment of an electrochemical cell 100 shown in FIGS. 40 to 44 differs in terms of structure and function from the first embodiment shown in FIGS. 1 to 10 substantially in that the first contact element 120 and/or the second contact element 124 is laterally connected to the first connection conductor 114 and the second connection conductor 116, respectively.

A connection of the connection conductors 114, 116 to the electrochemical element 106 is also formed laterally.

Otherwise, the embodiment shown in FIGS. 40 to 44 substantially corresponds in terms of structure and function to the first embodiment shown in FIGS. 1 to 10, such that reference is made to the description thereof.

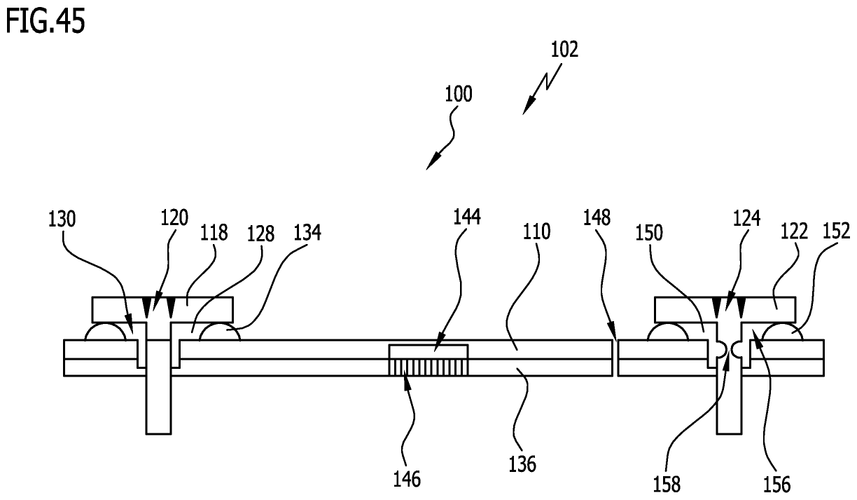

A further embodiment of an electrochemical cell 100, which is not shown as a whole in FIG. 45, differs in terms of structure and function from the embodiment shown in FIGS. 40 to 44 substantially in that the electrochemical cell 100 does not comprise an insulating element 136.

In particular, the first potting element 128 and/or the second potting element 150 do not undercut the cover element 110 on a side facing the interior space 108 of the housing 104.

Filling the first connection region 130 with the first resin material and/or filling the second connection region 156 with the second resin material preferably takes place from a side facing the interior space 108 in the installed state.

Otherwise, the further embodiment of an electrochemical cell shown in FIG. 45 substantially corresponds in terms of structure and function to the embodiment shown in FIGS. 40 to 44, such that reference is made to the description thereof.

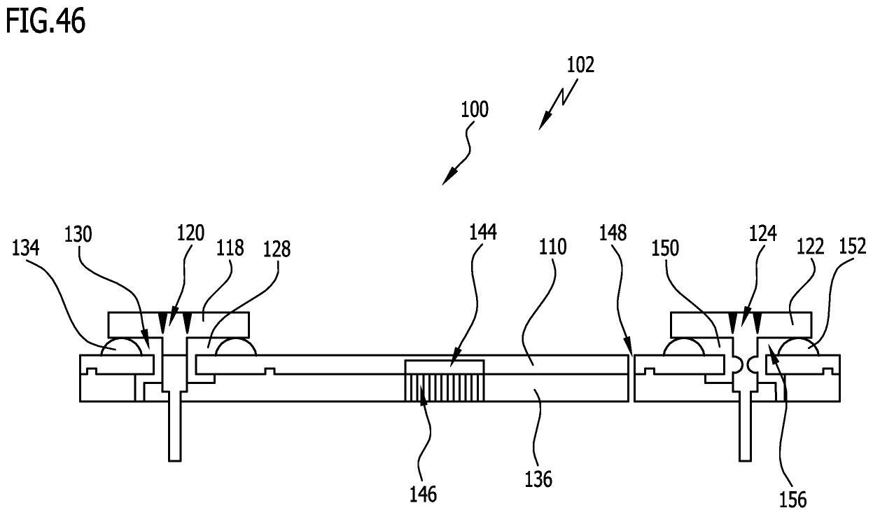

A further embodiment of an electrochemical cell 100, which is not shown as a whole in FIG. 46, differs in terms of structure and function from the embodiment shown in FIGS. 40 to 44 substantially in that the insulating element 136 has a first filling opening 164 in the region of the first connection region 130 and/or a second filling opening 164 in the region of the second connecting region 156.

The filling openings 164 are preferably used to fill the first resin material into the first connection region 130 and/or to fill the second resin material into the second connection region 156.

It can be advantageous if the first contact element 120 has a cross-sectional area that is reduced by approx. 10% or more, for example by approx. 30% or more, in a region below the cover element 110 that faces the interior space 108 compared to the rest of the first contact element 120.

It can be provided that the second contact element 124 has a cross-sectional area reduced by approx. 10% or more, for example by approx. 30% or more, in a region below the cover element 110 facing the interior space 108 compared to the rest of the second contact element 124.

Otherwise, the further embodiment of an electrochemical cell 100 shown in FIG. 46 substantially corresponds in terms of structure and function to the embodiment shown in FIGS. 40 to 44, such that reference is made to the description thereof.

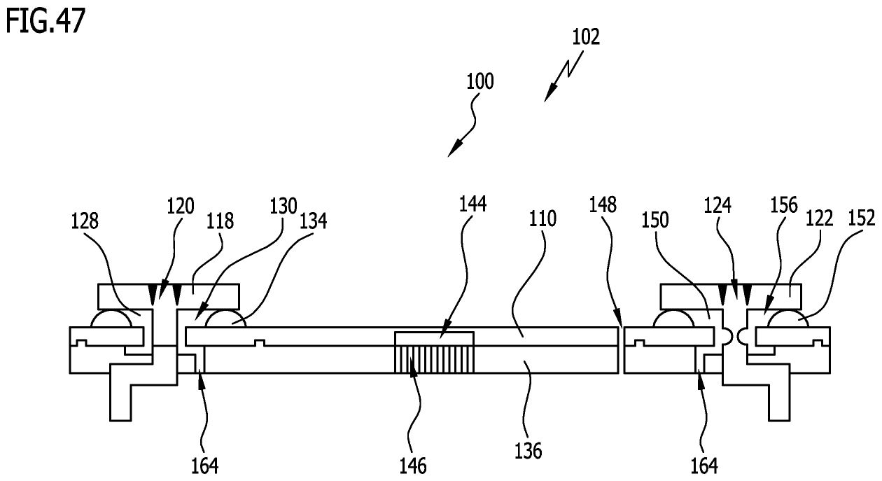

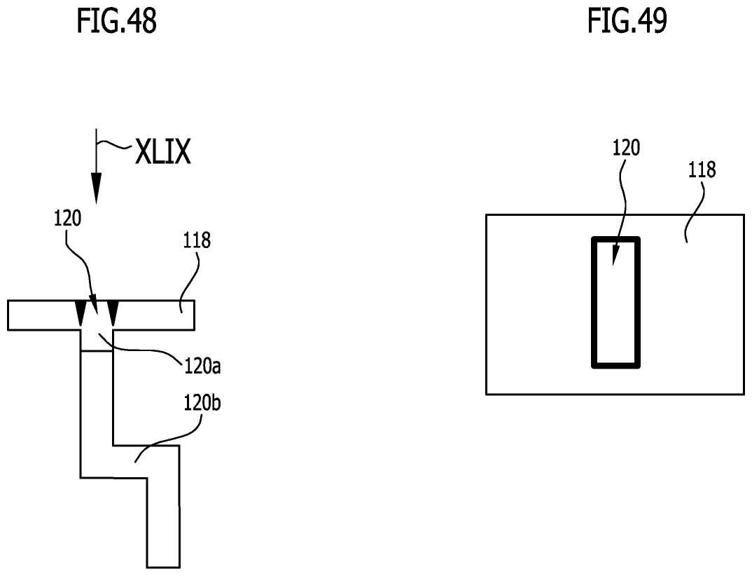

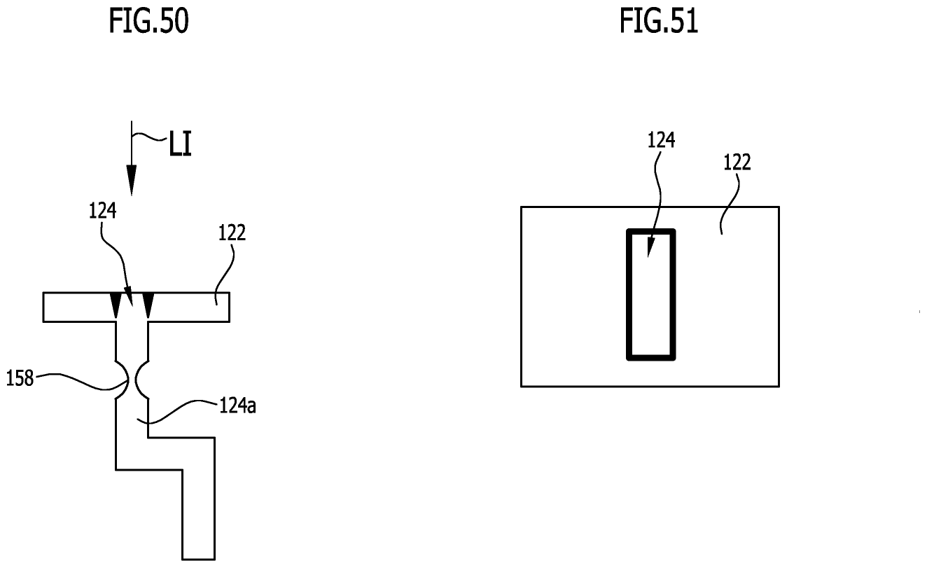

A further embodiment of an electrochemical cell, which is not shown as a whole in FIGS. 47 to 51, differs in terms of structure and function from the embodiment shown in FIG. 46 substantially in that the first contact element 120 and/or the second contact element 124 substantially have a stepped cross section. The cross section is preferably taken parallel to a primary side of the electrochemical cell 100.

It can be advantageous if the first contact element 120 is bent in such a way that it has a region that is arranged at least approximately parallel to a main extension plane of cover element 110.

In particular, the first contact element 120 has a further region that faces away from the first cell terminal 118 and whose main extension plane is arranged at least approximately perpendicular to the main extension plane of the cover element 110.

Preferably, the second contact element 124 is bent in such a way that it has a region that is arranged at least approximately parallel to a main extension plane of the cover element 110.

It can be favorable if the second contact element 124 has a further region that faces away from the second cell terminal 122 and whose main extension plane is arranged at least approximately perpendicular to the main extension plane of the cover element 110.

It can be advantageous if the first contact element 120 and the insulating element 136 form a force fit and/or form fit.

In particular, the second contact element 124 and the insulating element 136 form a force fit and/or form fit.

A holding element is preferably not required in the production of the electrochemical cell 100.

A cross-sectional area of the first contact element 120 and/or a cross-sectional area of the second contact element 124 is preferably constant over the entire extent thereof.

Otherwise, the further embodiment of an electrochemical cell shown in FIGS. 47 to 51 substantially corresponds in terms of structure and function to the embodiment shown in FIG. 46, such that reference is made to the description thereof.

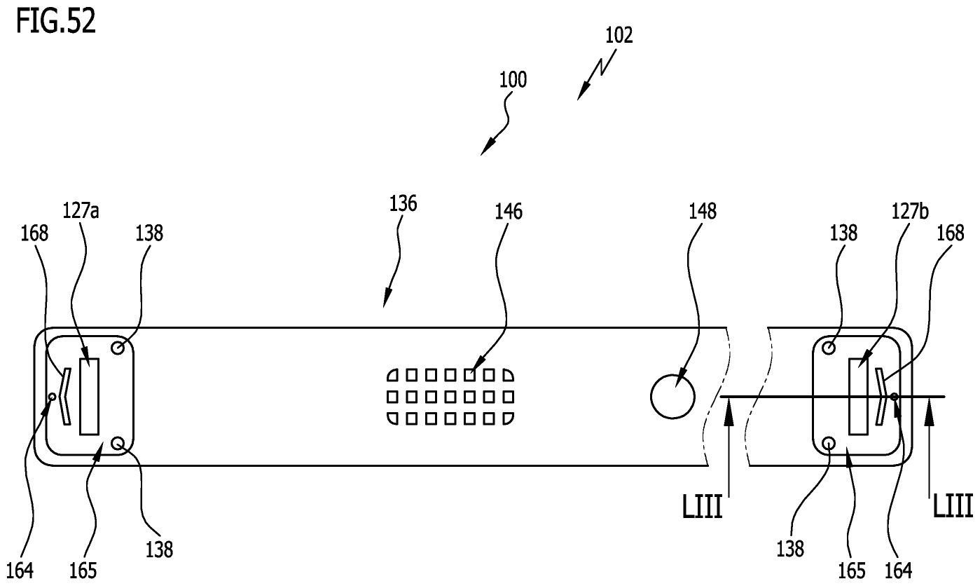

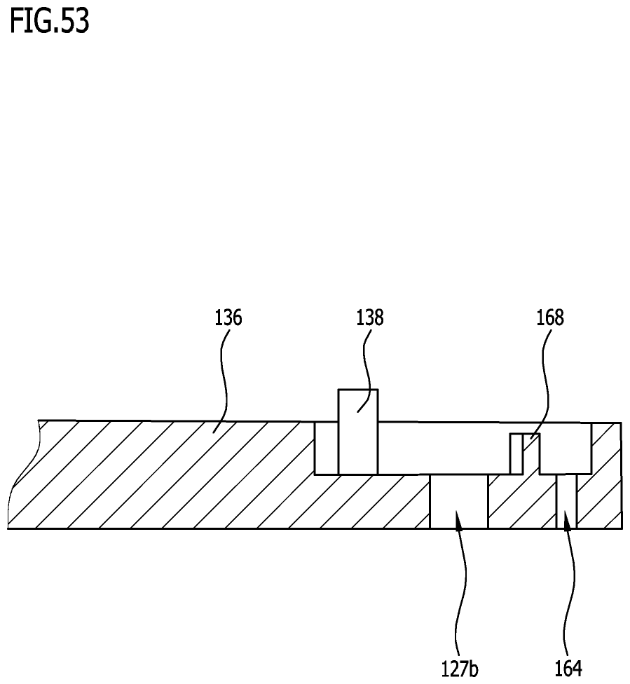

FIGS. 52 and 53 show an insulating element 136 of a further embodiment of an electrochemical cell 100 that is not shown as a whole in the drawings.

The further embodiment of an electrochemical cell 100 differs in terms of structure and function from the embodiment shown in FIGS. 1 to 10 substantially in that the insulating element 136 has a plurality of flow guide elements 168.

It can be advantageous if a flow guide element 168 is arranged in a depression 165 of the insulating element 136 arranged in the region of the first connection region 130.

A further flow guide element 168 is preferably arranged in a depression 165 of the insulating element 136 arranged in the region of the second connection region 156.

It can be favorable if the flow guide elements 168 have an at least approximately V-shaped cross section. The cross section is preferably taken parallel to a main extension plane of the insulating element 136.

The flow guide elements 168 are preferably used for a controlled distribution of the first resin material and/or the second resin material.

The flow guide elements 168 are preferably arranged in each case between the respective opening 127a, 127b and a secondary side of the electrochemical cell 100.

In particular, tips of the V-shapes each point outwardly away from the respective opening 127a, 127b.

It can be advantageous if the depressions 165 of the insulating element 136 serve as receptacles and/or pockets for the first resin material or the second resin material.

Positioning projections 138 are preferably arranged on sides of the depressions 165 that face one another.

A filling opening 164 for filling in the first resin material or the second resin material is preferably arranged in each case on a side of the respective depression 165 that faces a secondary side of the electrochemical cell 100.

The insulating element 136 shown in FIGS. 52 and 53 can alternatively be used in any of the described embodiments of an electrochemical cell 100.

Otherwise, the further embodiment of an electrochemical cell 100 shown in FIGS. 52 and 53 corresponds in terms of structure and function to the first embodiment shown in FIGS. 1 to 10, such that reference is made to the description thereof.

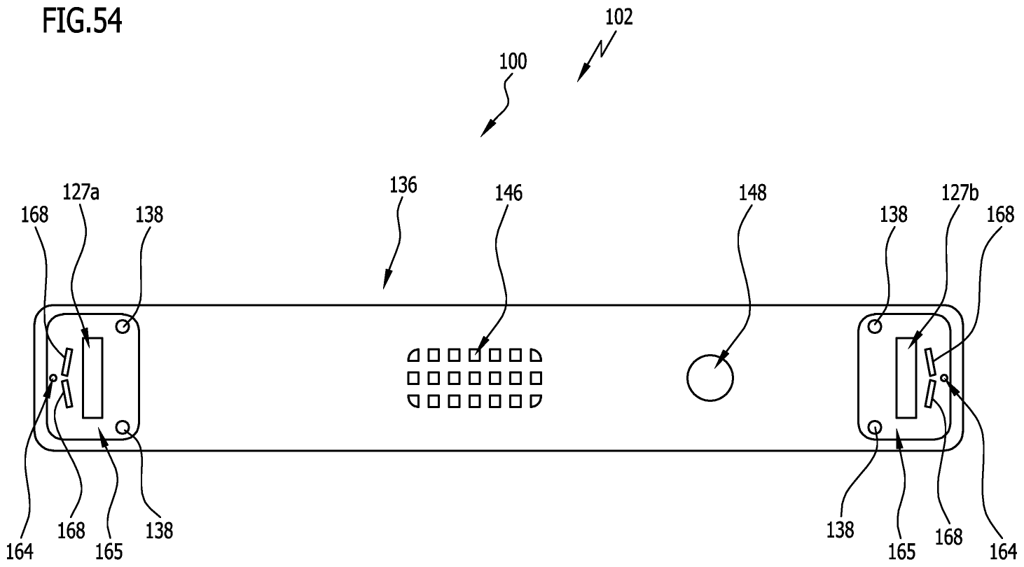

FIG. 54 shows an insulating element 136 of a further embodiment of an electrochemical cell 100 that is not shown as a whole in the drawings.

The further embodiment of an electrochemical cell 100 differs in terms of structure and function from the embodiment shown in FIGS. 52 and 53 substantially in that two flow guide elements 168 are arranged in each depression of the insulating element 136, which flow guide elements are arranged at an angle to one another and/or at a distance from one another.

The two flow guide elements 168 preferably enclose an obtuse angle with one another.

The insulating element 136 according to FIG. 54 can be used in any of the described embodiments of an electrochemical cell 100.

Otherwise, the further embodiment of an electrochemical cell 100 shown in FIG. 54 substantially corresponds in terms of structure and function to the embodiment shown in FIGS. 52 and 53, such that reference is made to the description thereof.

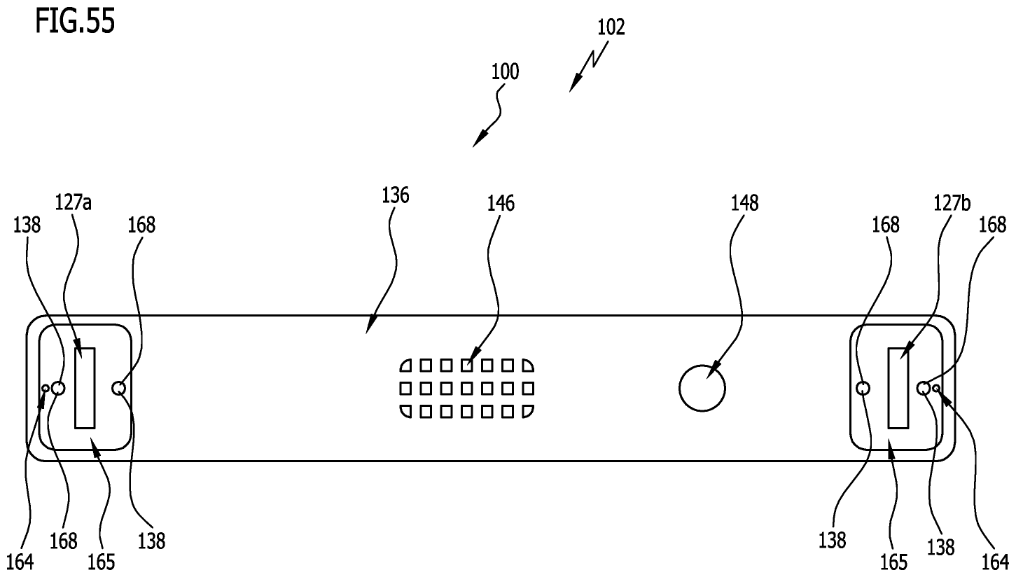

FIG. 55 shows an insulating element 136 of a further embodiment of an electrochemical cell 100 that is not shown as a whole in the drawings.

The further embodiment of an electrochemical cell 100 differs in terms of structure and function from the embodiment shown in FIGS. 52 and 53 substantially in that no separate flow guide elements 168 are provided, but the positioning projections 138 form flow guide elements 168.

In each case, two flow guide elements are preferably arranged on both sides of the first opening 127a and the second opening 127b of the insulating element 136.

The insulating element 136 according to FIG. 55 can be used in any of the described embodiments of an electrochemical cell 100.

Otherwise, the further embodiment of an electrochemical cell shown in FIG. 55 substantially corresponds in terms of structure and function to the embodiment shown in FIGS. 52 and 53, such that reference is made to the description thereof.

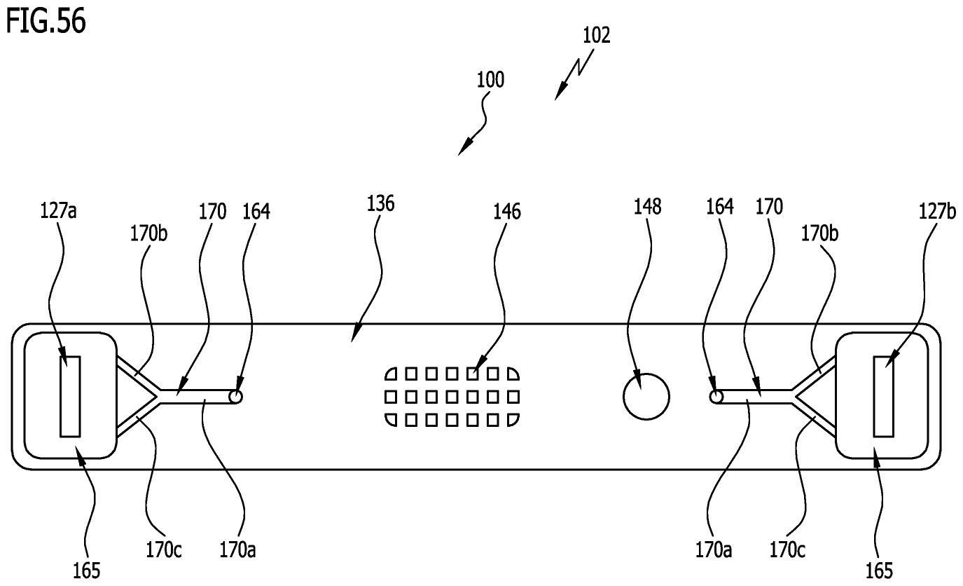

FIG. 56 shows an insulating element 136 of a further embodiment of an electrochemical cell 100 that is not shown as a whole in the drawings.

The further embodiment of an electrochemical cell 100 differs in terms of structure and function from the embodiment shown in FIG. 55 substantially in that the insulating element 136 has a plurality of, in this case two, filling channels 170 that each connect a filling opening 164 of the insulating element 136 to a depression 165 of the insulating element 136, which depression is, for example, pocket-shaped.

It can be favorable if a filling opening 164 is arranged between the first opening 127a and a central region of the insulating element 136 arranged centrally between the openings 127a, 127b.

A further filling opening 164 is preferably arranged between the second opening 127b and the central region of the insulating element 136 arranged centrally between the openings 127a, 127b.

It can be advantageous if the filling channels 170 are designed as open channels.

For example, the filling channels 170 are designed as elongated regions in which the insulating element 136 has a locally reduced thickness, for example by approx. 20% or more, compared to an average thickness of the remaining insulating element 136.

It can be provided that each filling channel 170 has a filling channel portion 170a that is connected to a filling opening 164 and whose main direction of extent is arranged at least approximately parallel to a primary side of the electrochemical cell 100.

Further filling channel portions 170b, 170c are preferably connected directly to the filling channel portion 170a.

The other filling channel portions 170b, 170c form, for example, at least approximately a V-shape and/or connect the filling channel portion 170a to a depression 165, for example a pocket-like depression, in the insulating element 136.

When the first resin material is filled into the filling opening 164 arranged adjacent to the first opening 127a, the first resin material preferably flows through the filling channel portion 170a and through the further filling channel portions 170b, 170c. The first resin material is then collected in particular in the first depression 165 of the insulating element 136 and/or accumulates in the first depression 165 of the insulating element 136.

When the second resin material is filled into the filling opening 164 arranged adjacent to the second opening 127b, the second resin material preferably flows through the filling channel portion 170a and through the further filling channel portions 170b, 170c. The second resin material is then collected in particular in the second depression 165 of the insulating element 136 and/or accumulates in the second depression 165 of the insulating element 136.

The insulating element 136 of FIG. 56 can be used in any of the described embodiments of an electrochemical cell 100.

Positioning projections 138 are not shown in the drawings, but can be provided.

Otherwise, the embodiment of an electrochemical cell 100 shown in FIG. 56 substantially corresponds in terms of structure and function to the embodiment shown in FIG. 55, such that reference is made to the description thereof.

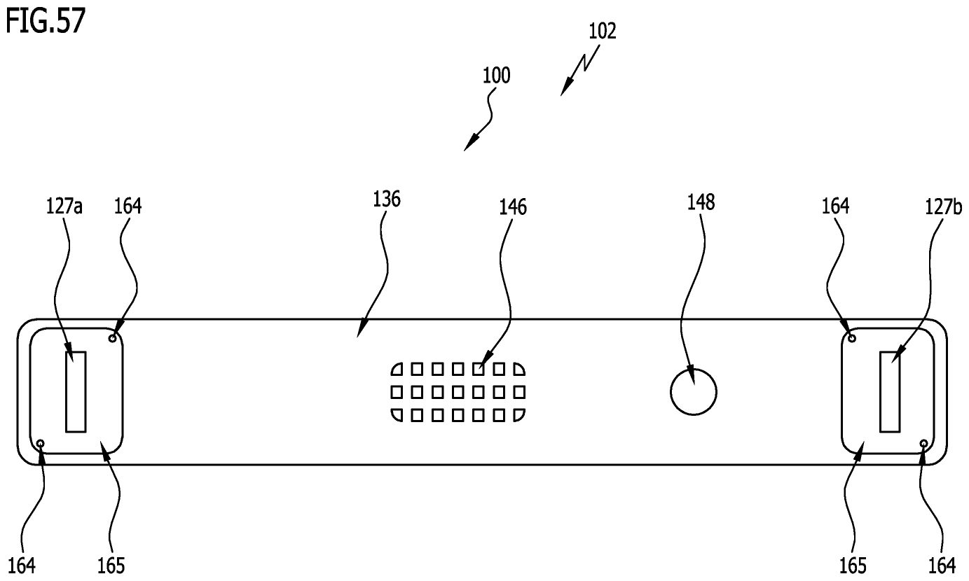

FIG. 57 shows an insulating element 136 of a further embodiment of an electrochemical cell 100 that is not shown as a whole in the drawings.

The further embodiment differs in terms of structure and function from the embodiment shown in FIG. 55 substantially in that in each case two filling openings 164 are arranged in the two depressions 165 of the insulating element 136.

The two filling openings 164 preferably lie on a diagonal that runs through the respective depression 165. For example, the two filling openings 164 are arranged in corner regions of the respective depression 165 lying on a diagonal.

Positioning projections 138 are preferably not required.

The insulating element 136 according to FIG. 57 can be used in any of the described embodiments of an electrochemical cell 100.

Otherwise, the embodiment of an electrochemical cell 100 shown in FIG. 57 substantially corresponds in terms of structure and function to the embodiment shown in FIG. 55, such that reference is made to the description thereof.

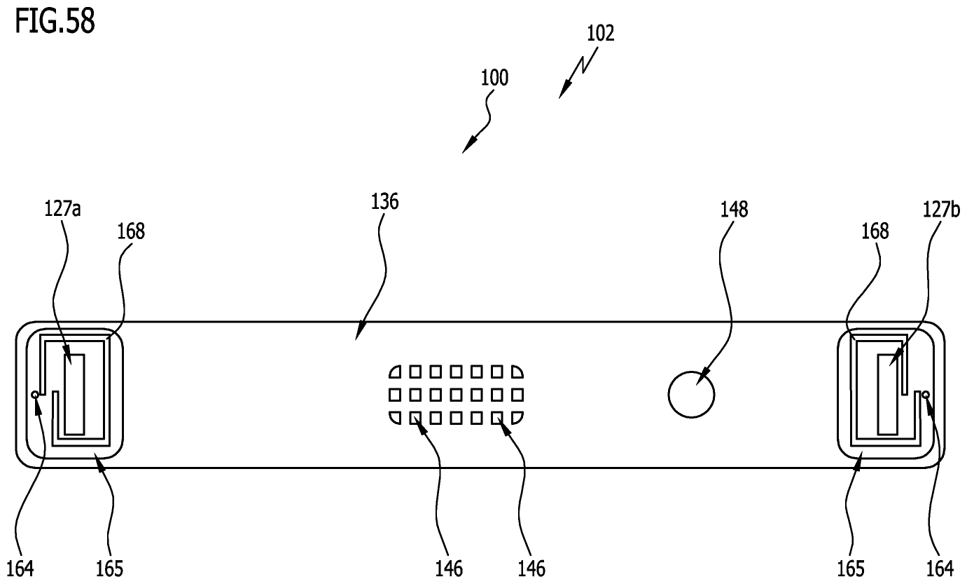

FIG. 58 shows an insulating element 136 of a further embodiment of an electrochemical cell 100 that is not shown as a whole in the drawings.

The further embodiment of an electrochemical cell 100 differs in terms of structure and function from the embodiment shown in FIG. 55 substantially in that the insulating element 136 comprises two flow guide elements 168 that are arranged at least approximately spirally around the first opening 127a and/or the second opening 127b.

The flow guide elements 168 preferably serve to uniformly distribute the first resin material in the first connection region 130 and/or the second resin material in the second connection region 156.

It can be provided that the flow guide elements 168 each have a varying height.

For example, the flow guide elements 168 extend in part or in full from a depression 165 of the insulating element 136 to an extension of the insulating element 136 in regions of the insulating element 136 adjoining the depression 165.

For example, the flow guide elements 168 terminate perpendicularly to a main extension plane of the insulating element 136 at least approximately flush with the rest of the insulating element 136 and/or do not protrude beyond a main body of the insulating element 136.

It can be advantageous if a filling opening 164 is arranged on an edge of the insulating element 136 facing a secondary side of the electrochemical cell 100 within the respective depression 165.

Positioning projections 138 are preferably not required.

The insulating element 136 according to FIG. 58 can be used in any of the described embodiments of an electrochemical cell 100.

Otherwise, the embodiment of an electrochemical cell 100 shown in FIG. 58 substantially corresponds in terms of structure and function to the embodiment shown in FIG. 55, such that reference is made to the description thereof.

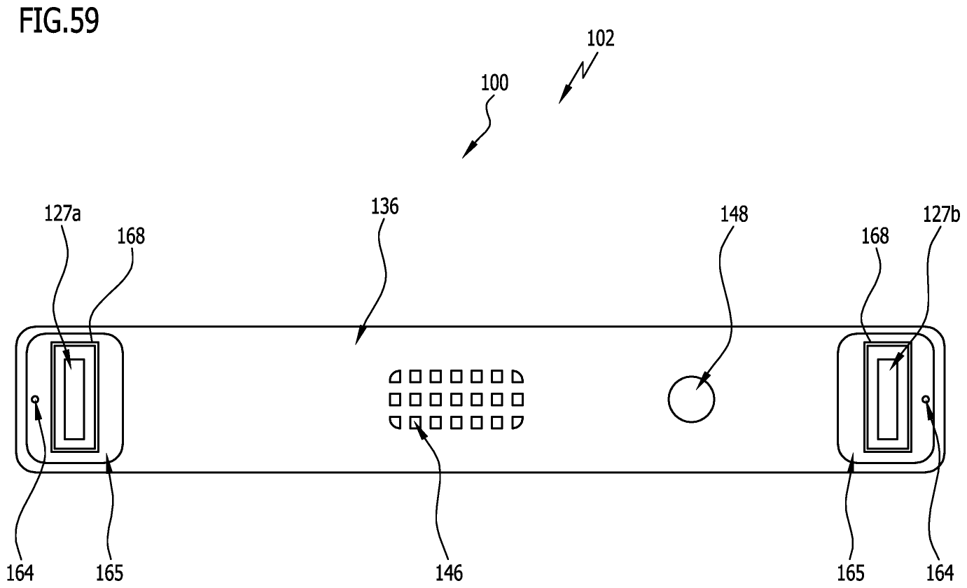

FIG. 59 shows an insulating element 136 of a further embodiment of an electrochemical cell 100 that is not shown as a whole in the drawings.

The further embodiment of an electrochemical cell 100 differs in terms of structure and function from the embodiment shown in FIG. 58 substantially in that the flow guide elements 168 form a closed ring shape.

A first flow guide element 168 preferably surrounds the first opening 127a of the insulating element 136 in a closed ring shape. Said first flow guide element is preferably arranged at a distance from the first opening 127a.

It can be advantageous if a second flow guide element 168 surrounds the second opening 127b of the insulating element 136 in a closed manner to form a ring shape. The second flow guide element 168 is arranged in particular at a distance from the second opening 127b of the insulating element 136.

The flow guide elements 168 preferably have an at least approximately rectangular cross section. The cross section is preferably taken parallel to a main extension plane of the insulating element 136.

It can be provided that the flow guide elements 168 have different heights from one another, such that in particular flow guide elements that are dependent on the flow path are formed.

The insulating element 136 according to FIG. 59 can be used in any of the described embodiments of an electrochemical cell 100.

Otherwise, the further embodiment of an electrochemical cell 100 shown in FIG. 59 substantially corresponds in terms of structure and function to the embodiment shown in FIG. 58, such that reference is made to the description thereof.

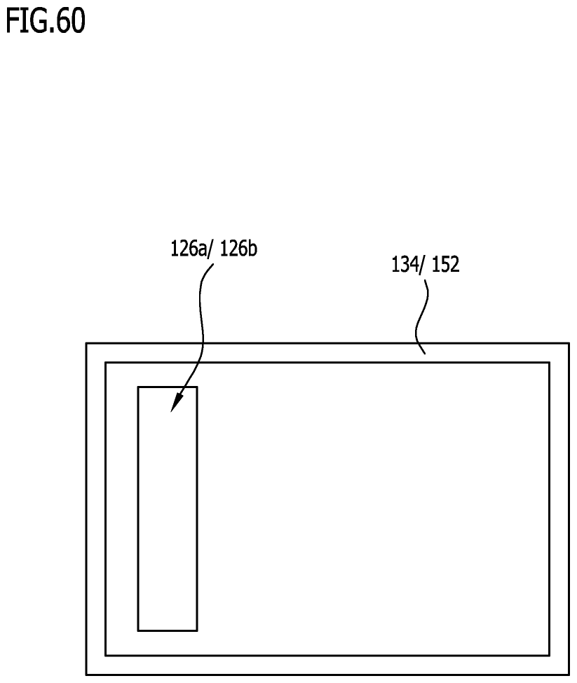

FIGS. 60 to 72 show an example of the shapes that the first sealing element 134 and/or the second sealing element 152 can have.

The sealing elements 134, 152 according to FIGS. 60 to 72 can be used in all of the described embodiments of an electrochemical cell 100.

The following examples apply both to sealing elements 134, 152 made of a polymer material and to sealing elements 134, 152 that form part of the cover element 110 and are in particular made of a metallic material, for example aluminum.

It can be provided that the sealing element 134, 152 has an at least approximately rectangular cross section. The cross section is preferably taken parallel to a main extension plane of the cover element 110. The sealing element 134, 152 forms in particular a closed ring shape (FIG. 60).

It can be provided that the second sealing element 152 comprises two metal beads arranged parallel to one another. The beads are arranged, for example, at least approximately parallel to a primary side of the electrochemical cell 100 and/or to a secondary side of the electrochemical cell 100 (not shown).

As an alternative to a closed ring shape, it can be provided that the sealing element 134, 152 has one or more interruptions 166 (FIG. 61).

In particular, regardless of the shape of the sealing element 134, 152, approx. 350° to approx. 355° of a circle whose central point forms the central axis 142 of the first contact element 120 or the central axis 154 of the second contact element 124 is surrounded by the sealing element 134, 152 in a cross section. In an installation situation of the sealing element 134, 152, the cross section is preferably taken parallel to a main extension plane of the cover element 110.

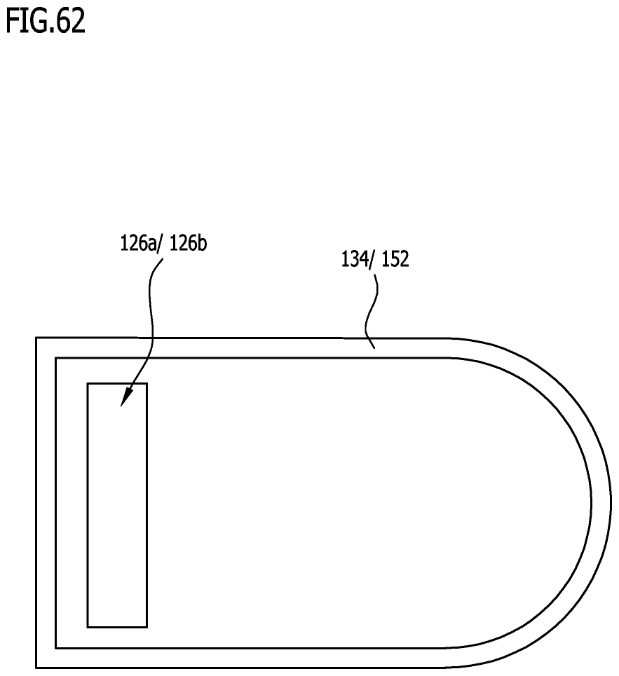

It can be advantageous if the sealing element 134, 152 has an at least approximately U-shaped cross section, free ends of the U-shape being connected to one another in particular by a connection portion. The connection portion is preferably arranged at least approximately parallel to a main direction of extent of the respective opening 126a, 126b (cf. FIG. 62).

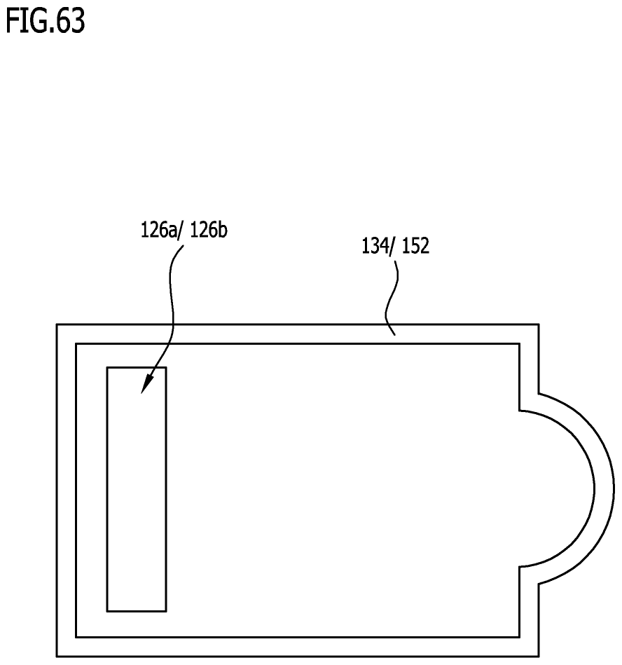

Alternatively, it can be provided that the sealing element 134, 152, for example on a side facing away from the respective opening 126a, 126b, has a bulge that points away from an interior space surrounded by the sealing element 134, 152 (cf. FIG. 63).

According to a further alternative, it can be provided that the sealing element 134, 152 has a plurality of bulges directly adjacent to one another, which bulges form one side of the sealing element 134, 152, for example.

For example, the sealing element 134, 152 has two bulges pointing away from an interior space surrounded by the sealing element 134, 152.

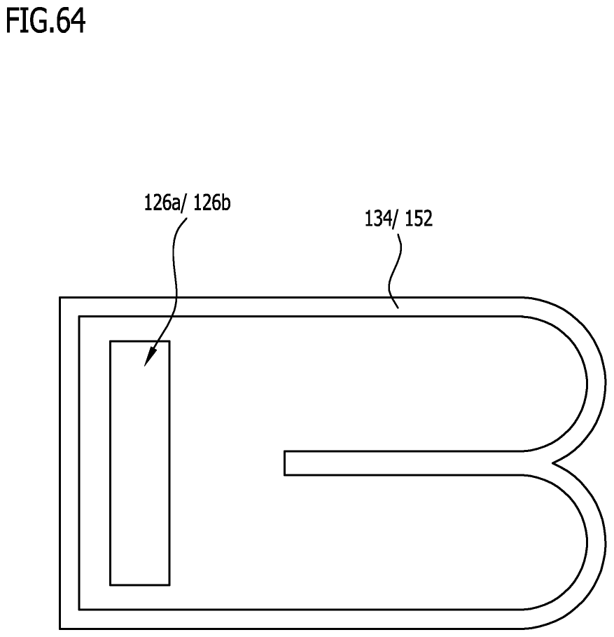

It can be advantageous if a separating portion between the two bulges extends into an interior space surrounded by the sealing element 134, 152. The bulges are preferably arranged on a side of the sealing element 134, 152 facing away from the respective opening 126a, 126b (cf. FIG. 64).

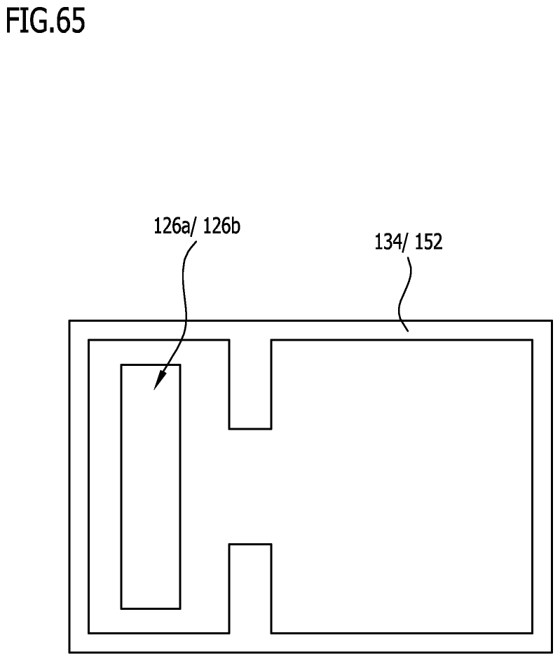

It can be provided that the sealing element 134, 152 has an at least approximately rectangular cross section and two projections in each case, which projections have a main direction of extent that is arranged at least approximately parallel to a main direction of extent of the respective opening 126a, 126b (cf. FIG. 65). The projections preferably extend into an interior space surrounded by a main body of the sealing element 134, 152.

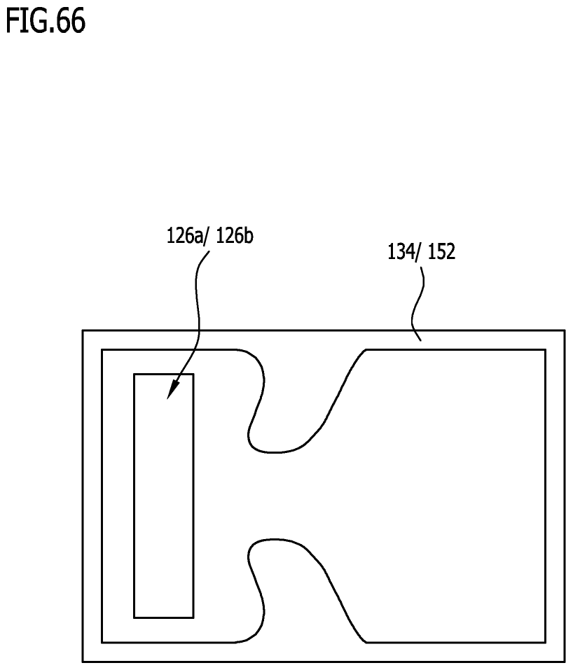

Alternatively, it can be provided that the sealing element 134, 152 has two tongue-shaped projections that are arranged to be inclined in particular inward and/or toward the respective opening 126a, 126b (cf. FIG. 66).

In particular, the sealing element 134, 152 has three projections that protrude along a direction perpendicular to a main direction of extent of the respective opening 126a, 126b alternately from opposite sides into an interior space surrounded by the sealing element 134, 152.

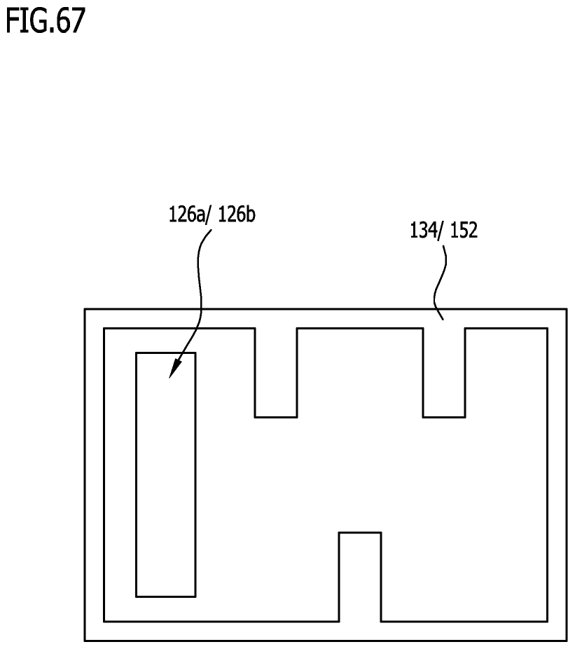

A main direction of extent of the projections is preferably arranged at least approximately parallel to a main direction of extent of the respective opening 126a, 126b (FIG. 67).

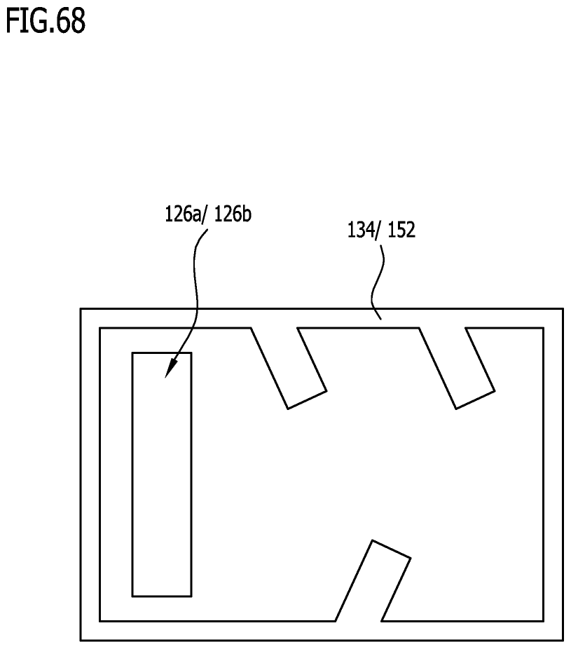

Alternatively, it can be provided that the projections point obliquely away from the respective opening 126a, 126b (FIG. 68).

It can be advantageous if the sealing element 134, 152 has a plurality of projections that are arranged at a distance from a main body of the respective sealing element 134, 152 and/or are arranged in an interior space surrounded by the main body of the respective sealing element 134, 152.

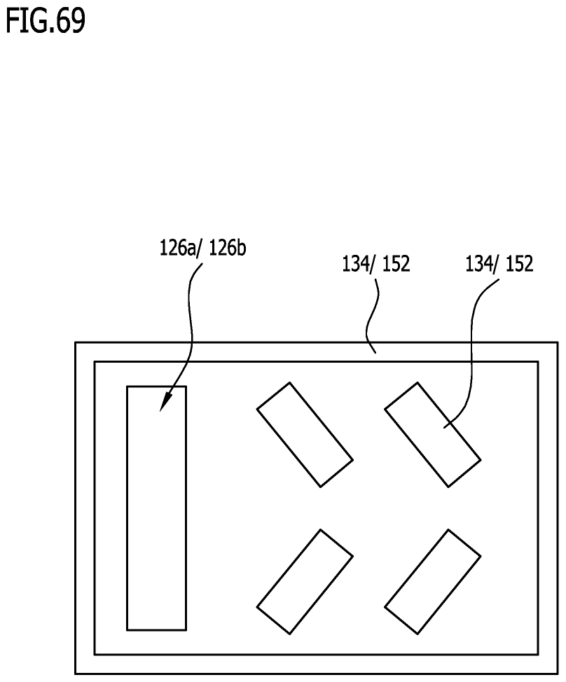

Main directions of extent of two projections in each case preferably enclose an obtuse angle with one another (cf. FIG. 69).

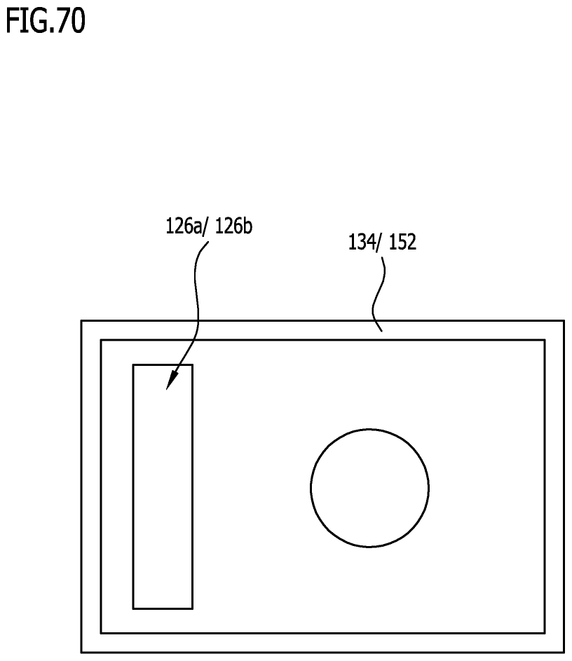

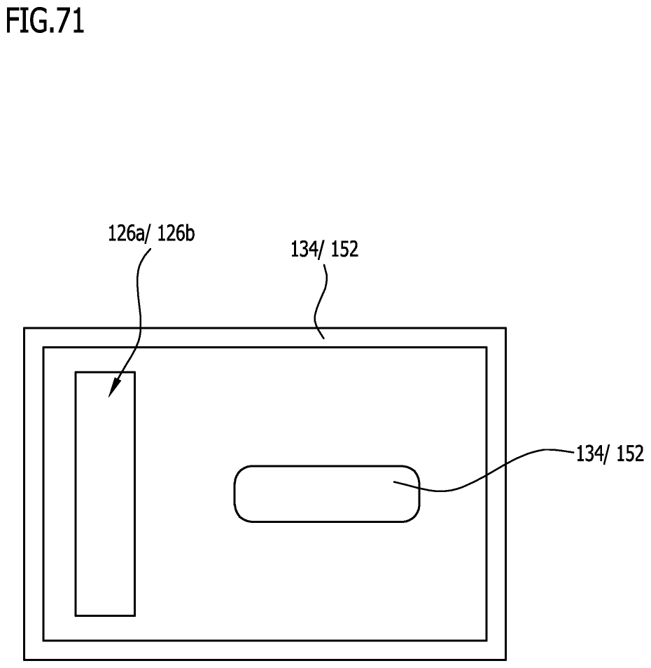

Alternatively, provision can be made for a single projection to be arranged in an interior space surrounded by a main body of sealing element 134, 152, which projection has an at least approximately circular cross section (cf. FIG. 70) or an at least approximately elliptical and/or oval cross section (cf. FIG. 71).

In the case of a projection having an approximately elliptical and/or oval cross section, said projection preferably has a main direction of extent that is arranged at least approximately perpendicular to a main direction of extent of the respective opening 126a, 126b.

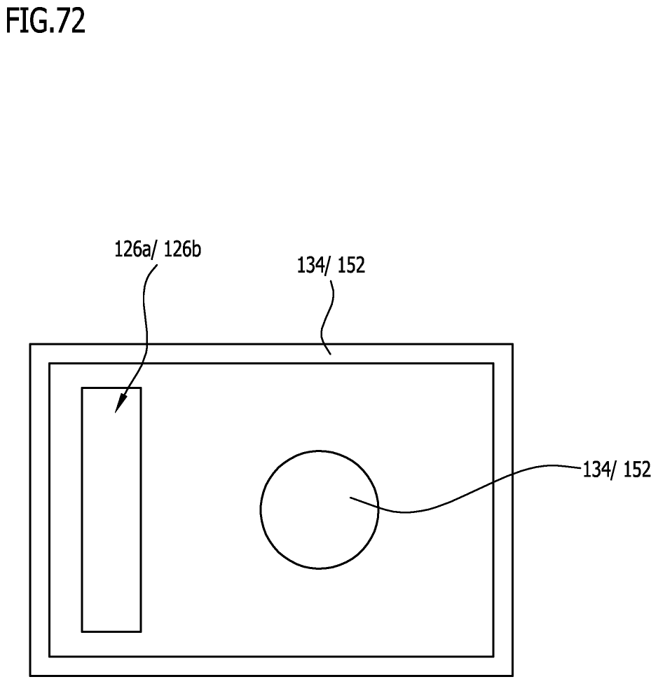

It can be provided that the second sealing element 152 has a projection having an approximately round cross section, which projection comprises or is formed from a metallic material (FIG. 72).

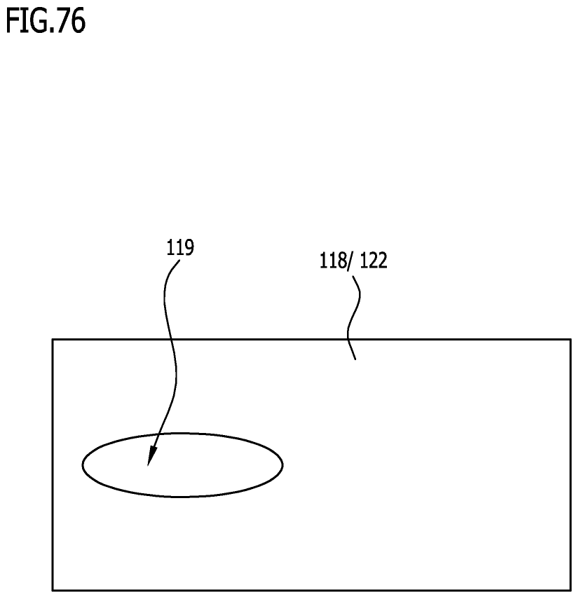

As shown in particular in FIGS. 73 to 76, the cell terminals 118, 122, depending on the shape of the respective contact element 120, 124, can have cuboid passage openings 119 (cf. FIGS. 73 and 74) or passage openings 119 having an oval cross section (cf. FIGS. 75 and 76).

Main directions of extent of the passage openings 119 can be arranged parallel to a primary side of the electrochemical cell 100 (see FIGS. 74 and 76) or perpendicular (see FIGS. 73 and 75) to the primary side of the electrochemical cell 100.

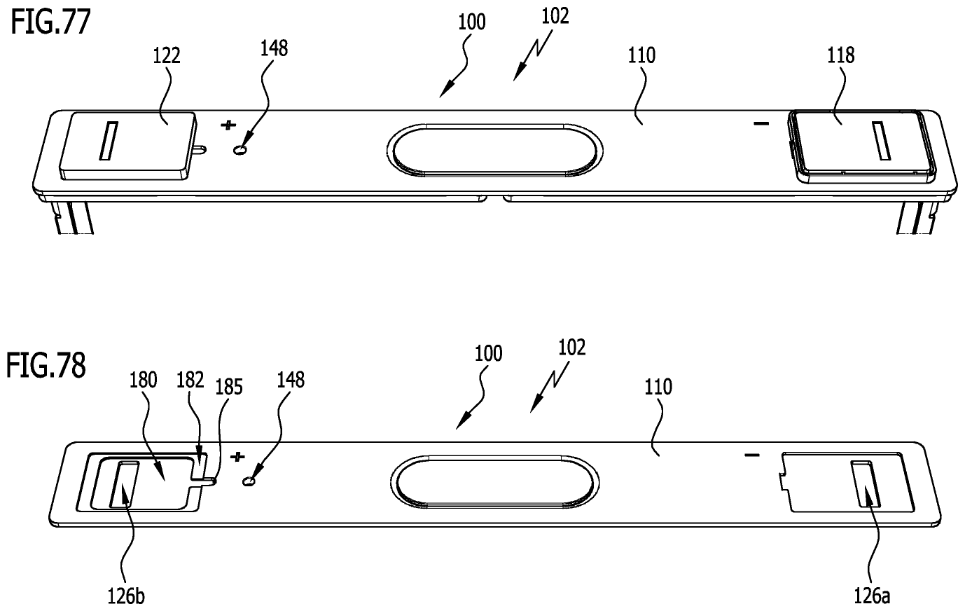

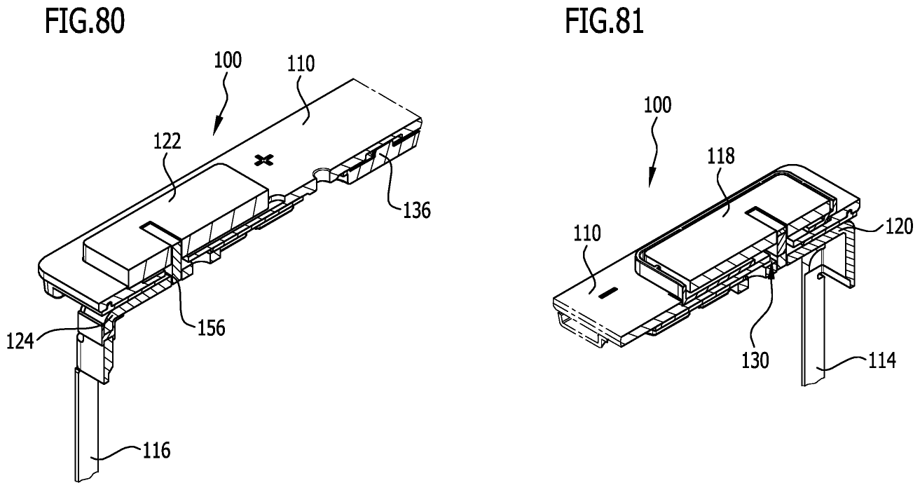

A further embodiment of an electrochemical cell 100 shown in FIGS. 77 to 83, which is not shown as a whole in the drawings, differs in terms of structure and function from the first embodiment of an electrochemical cell 100 shown in FIGS. 1 to 10 substantially in that the cover element 110 has a second recessed region 180, for example on a cathode side (see FIG. 78).

The cathode side is indicated by a plus sign in the drawings. An anode side is indicated by a minus sign in the drawings. The cathode side and the anode side are reversed in the embodiment shown in FIGS. 77 to 83 compared to the illustrations of the other embodiments.

The second recessed region 180 is, for example, an embossed region and/or formed by means of embossing. The second recessed region 180 preferably surrounds and/or delimits the second potting element 156. In particular, the second recessed region 180 serves as a receptacle for the second resin material.

For example, the second recessed region 180 is formed in a basin shape and/or forms a potting basin for the second resin material in a flowable state. When the second connection region 150 is filled with the second resin material, the second resin material preferably flows into the second recessed region 180.

It can be favorable if the second recessed region 180 surrounds the second opening 126b in the cover element 110. It can be provided that a larger partial region of the second recessed region 180 is arranged on a side of the second opening 126b facing the central portion of the cover element 110, while a second smaller partial region of the second recessed region 180 is arranged on a side facing a narrow side of the electrochemical cell 100.

It can be advantageous if the second recessed region 180 is surrounded by a cell terminal support region 182, in particular in a ring shape. The cell terminal support region 182 preferably serves as a support surface for the second cell terminal 122 and/or is in direct contact with the second cell terminal 122 when the electrochemical cell 100 is in an assembled state.

Preferably, the second recessed region 180 has a bulge 185 on a side of the recessed region 180 facing the central region of the cover element 110, which bulge serves, for example, as a degassing opening during a filling process of the second resin material.

It can be provided that the cover element 110 has a first recessed region (not shown in the drawing), for example on the anode side.

The first recessed region may be designed like the second recessed region 180. With regard to the first recessed region, reference is made to the corresponding statements relating to the second recessed region 180.

The design of the second recessed region 180 and/or a first recessed region means that sealing elements 134, 152 are preferably unnecessary.

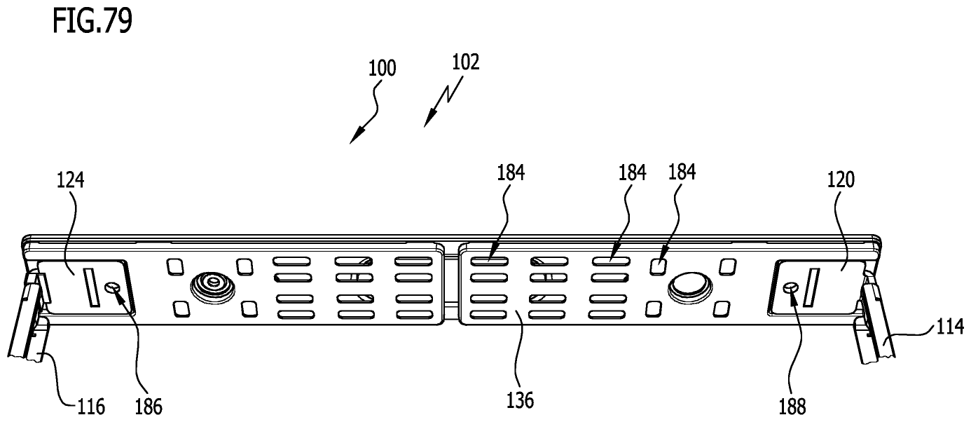

As can be seen in particular in FIG. 79, the insulating element 136 preferably has a plurality of passage openings 184, in the present case arranged regularly. The passage openings 184 are, for example, at least approximately oval or at least approximately rectangular and/or are arranged substantially over the entire region of the insulating element 136.

For example, at least approximately rectangular passage openings 184 are arranged according to a first arrangement pattern over the central portion of the insulating element 136.

In particular, further passage openings 184, for example at least approximately square passage openings, are arranged toward the narrow sides of the insulating element 136 according to a second arrangement pattern.

The insulating element 136 is preferably designed in multiple parts, for example in two parts. In this regard, reference is made to the statements relating to the embodiments illustrated in FIGS. 11 and 12.

As can be seen in particular in FIGS. 79, 82 and 83, the first contact element 120 preferably has a first resin material filling opening 188. The first resin material filling opening 188 preferably serves as an opening for filling a volume that forms the first potting element 130 in the hardened state of the first resin material.

For example, the first resin material is filled in a flowable state through the first resin material filling opening 188.

It can be favorable if the second contact element 124 has a second resin material filling opening 186 that serves in particular as an opening for filling a volume that forms the second potting element 156 in the hardened state of the second resin material.

For example, the second resin material is filled in a flowable state through the second resin material filling opening 186, for example, into the second recessed region 180.

Because of the first resin material filling opening 188 and/or the second resin material filling opening 186, filling openings in the insulating element 136 are preferably not necessary.

In particular, a volume forming the first connection element 130 and/or a volume forming the second connection element 156 is filled through the contact elements 120, 124.

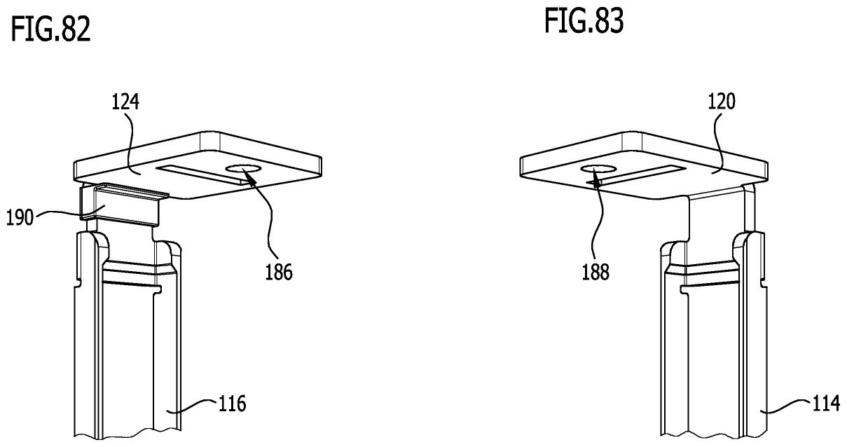

As can be seen in particular in FIG. 82, the second contact element 124 and the second connection conductor 116 are preferably separate components that are connected to one another by a transition part 190, for example.

It can be favorable if the second contact element 124 and the second connection conductor 116 are arranged at least approximately in an L-shape and/or at an angle to one another in a cross section taken perpendicular to the main extension plane of the cover element 110.

As can be seen in particular in FIG. 83, the first contact element 120 and the first connection conductor 114 are preferably formed in one piece.

The first contact element 120 and the first connection conductor 114 preferably form at least approximately an L-shape in a cross section taken perpendicular to the main extension plane of the cover element 110 and/or are arranged at an angle to one another.

Otherwise, the further embodiment of an electrochemical cell 100 shown in FIGS. 77 to 83 substantially corresponds in terms of structure and function to the first embodiment shown in FIGS. 1 to 10, such that reference is made to the description thereof.

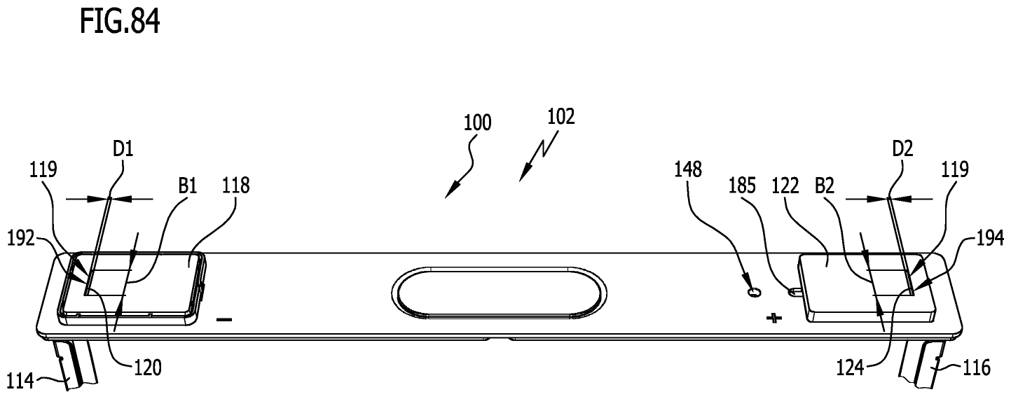

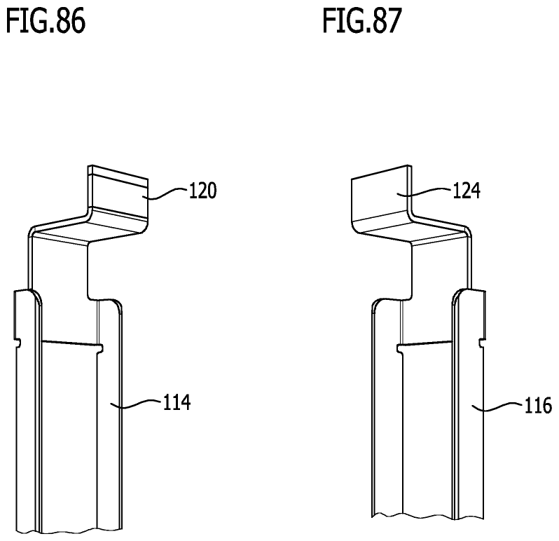

A further embodiment of an electrochemical cell 100 shown in FIGS. 84 to 87, which is not shown as a whole in the drawings, differs in terms of structure and function from the embodiment shown in FIGS. 77 to 83 substantially in that individual elements of the electrochemical cell 100 are formed with an average thickness that is reduced compared to the previous embodiments.

Preferably, an average thickness of the first connection conductor 114 is approx. 1/10 or less of an average width of the first connection conductor 114 taken perpendicular to the thickness.

Preferably, the average thickness of the first connection conductor 114 is preferably approx. 0.8 mm or less, for example approx. 0.7 mm or less.

The average thickness of the first connection conductor 114 is preferably defined perpendicular to the main extension plane thereof and/or corresponds in particular to an average material thickness of a material, for example a sheet metal material, from which the first connection conductor 114 is made.

It can be favorable if an average thickness of the second connection conductor 116 is approx. 1/10 or less of an average width of the second connection conductor 116 taken perpendicular to the thickness.

Preferably, the average thickness of the second connection conductor 116 is preferably approx. 0.8 mm or less, for example approx. 0.7 mm or less.

The average thickness of the second connection conductor 116 is preferably defined perpendicular to the main extension plane thereof and/or corresponds to an average material thickness of a material, for example a sheet metal material, from which the second connection conductor 116 is made.

Due to the reduced average thickness of the first connection conductor 114 and/or the second connection conductor 116, embossing the respective connection conductor 114, 116 is preferably unnecessary.

Preferably, the insulating element 136 has an average thickness that is less than the average thicknesses of the insulating elements 136 of the previously described embodiments.

It can be advantageous if an average thickness of the insulating element 136 is approx. 1/10 or less, for example approx. 1/15 or less, of an average width of the insulating element 136 taken perpendicular to the thickness.

In particular, the average thickness of the insulating element 136 is approx. 1.8 mm or less, for example approx. 1.7 mm or less.

In particular for a cost-effective design of the electrochemical cell 100, it can be advantageous if an average width B1 of the first contact element 120 in a first joint region 192 with the first cell terminal 118 is approx. ½ or less, in particular approx. ⅖ or less, of an average width of the first cell terminal 118.

The average width B1 of the first contact element 120 and the average width of the first cell terminal 118 are preferably defined at least approximately parallel to one another and/or arranged at least approximately parallel to a narrow side of the electrochemical cell 100.

The first joint region 192 is preferably a region in which the first contact element 120 and the first cell terminal 118 are connected to one another. Preferably, the first contact element 120 is passed through the passage opening 119 of the first cell terminal 118 in the first joint region 192 and/or fills said passage opening.

An average width B2 of the second contact element 124 in a second joint region 194 with the second cell terminal 122 is preferably approx. ½ or less, in particular approx. ⅖ or less, of an average width of the second cell terminal 122.

The average width B2 of the second contact element 124 and the average width of the second cell terminal 122 are preferably defined at least approximately parallel to one another and/or arranged at least approximately parallel to a narrow side of the electrochemical cell 100.

The second joint region 194 is preferably a region in which the second contact element 124 and the second cell terminal 122 are connected to one another. The second contact element 124 is preferably passed through the passage opening 119 of the second cell terminal 122 in the second joint region 194 and/or fills said passage opening.

For example, the average width B1 of the first contact element 120 and/or the average width B2 of the second contact element 124 in the respective joint region 192, 194 is approx. 10.5 mm or less, for example approx. 9.5 mm or less.

The average width B1 of the first contact element 120 in the first joint region 192 preferably substantially corresponds to an average width of the passage opening 119 of the first cell terminal 118.

Additionally or alternatively, the average width B2 of the second contact element 124 in the second joint region 194 preferably substantially corresponds to an average width of the passage opening 119 of the second cell terminal 122.

It can be advantageous if the first contact element 120 has an average thickness D1 in the first joint region 192 that is approx. 2/10 or less, for example approx. 1/10 or less, of the average width B1 of the first contact element 120 in the first joint region 192.

It can be favorable if the second contact element 124 in the second joint region 194 has an average thickness D2 that is approx. 2/10 or less, for example approx. 1/10 or less, of the average width B2 of the second contact element 124 in the second joint region 194.

The average thickness D1 of the first contact element 120 is in particular defined to be at least approximately perpendicular to the average width B1 of the first contact element 120.

The average thickness D2 of the second contact element 124 is preferably defined to be at least approximately perpendicular to the average width B2 of the second contact element 124.

The average thickness D1 of the first contact element 120 in the first joint region 192 and/or the average thickness D2 of the second contact element 124 in the second joint region 194 is preferably approx. 0.8 mm or less, for example approx. 0.7 mm or less.

The average thickness D1 of the first contact element 120 in the first joint region 192 is preferably substantially identical to an average length of the passage opening 119 of the first cell terminal 118 in the first joint region 192.

In particular, the average thickness D2 of the second contact element 124 in the second joint region 194 is substantially identical to an average length of the passage opening 119 of the second cell terminal 122 in the second joint region 194.

It can be favorable if an average thickness of the cover element 110 in a cross section taken perpendicular to the main extension plane thereof is approx. 1/10 or less, for example approx. 1/20 or less, of an average width of the cover element 110 perpendicular to the thickness thereof.

Preferably, the average thickness of the cover element 110 is approx. 1.9 mm or less, for example approx. 1.8 mm or less.

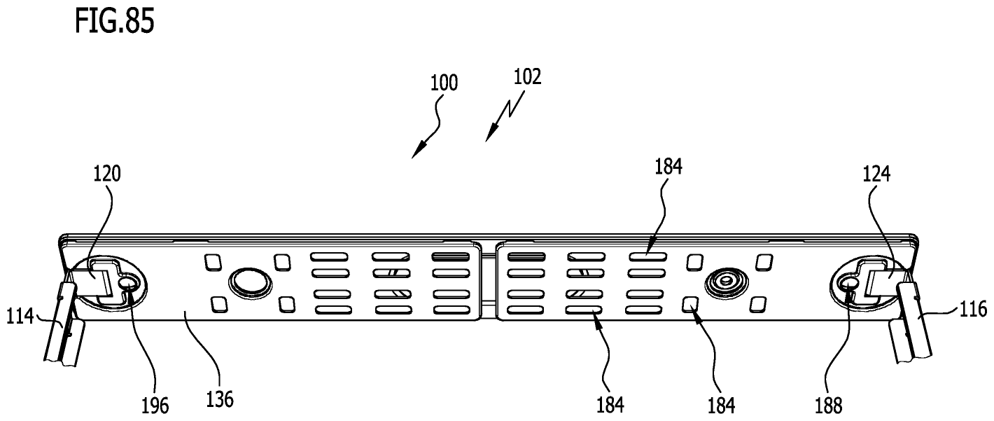

As can be seen in particular in FIGS. 85 to 87, the first connection conductor 114 and the first contact element 120 are preferably formed in one piece and/or do not have any thickening caused by the material transition. In particular, the second connection conductor 116 and the second contact element 124 are formed in one piece and/or do not have any thickening caused by the material transition.

It can be favorable if the first connection conductor 114 and the first contact element 120 are at least approximately step-shaped in a cross section taken perpendicular to the main extension plane of the cover element 110 and/or do not have a T-shape (as a whole).

The first contact element 120 is preferably at least approximately rectangular in a cross section taken parallel to the main extension plane of the cover element 110.

The second connection conductor 116 and the second contact element 124 are preferably at least approximately step-shaped in a cross section taken perpendicular to the main extension plane of the cover element 110 and/or do not have a T-shape (as a whole).

In particular, the second contact element 124 is at least approximately rectangular in a cross section taken parallel to the main extension plane of the cover element 110.

The aforementioned differences in the further embodiment of an electrochemical cell illustrated in FIGS. 84 to 87 preferably serve to optimize costs.

The first resin material and/or the second resin material is/are preferably filled in through a first filling opening 196 and a second filling opening 198, respectively. In the present case, the first filling opening 196 and/or the second filling opening 198 is formed as an opening in the insulating element 136.

Filling the first resin material and/or the second resin material in through the first contact element 120 or the second contact element 124 is preferably unnecessary.

Otherwise, the further embodiment of an electrochemical cell shown in FIGS. 84 to 87 substantially corresponds in terms of structure and function to the embodiment shown in FIGS. 77 to 83, such that reference is made to the description thereof.

Because of the potting elements 128, 150, further tools for producing a seal between the cover element and the contact elements 120, 124 are unnecessary. Hardening can take place in the component.

Component complexity is preferably reduced.

The potting elements 128, 150 preferably act as gap fillers.

1. An electrochemical cell for an electrochemical system, comprising:
an electrochemical element for receiving, storing and/or providing electrical energy;
a housing for receiving the electrochemical element, the housing surrounding an interior space of the electrochemical cell and comprising a cover element;
a first cell terminal and a second cell terminal for connecting the electrochemical cell to a cell contacting system;
a first contact element that connects the first cell terminal to a first connection conductor; and
a second contact element that connects the second cell terminal to a second connection conductor,
the first contact element being fixed to the cover element in a first connection region by means of a first potting element, the first potting element being formed from a first polymer material that comprises a first resin material or is formed therefrom and/or the second contact element being fixed to the cover element in a second connection region by means of a second potting element, the second potting element being formed from a second polymer material that comprises a second resin material or is formed therefrom.

2. The electrochemical cell according to claim 1, wherein:
the first polymer material and/or the second polymer material has a hardness in a range of approx. 40 Shore D to approx. 100 Shore D; and/or
the first polymer material and/or the second polymer material has a glass transition temperature of approx. 90° C. or more; and/or
the first resin material and/or the second resin material comprises or is formed from one or more of the following materials: epoxy resin material, phenolic resin material, aminoplast material, polyurethane material, silicone material, polyester resin material, ABS resin material.

3. The electrochemical cell according to claim 1, wherein the first resin material and/or the second resin material comprises one or more fillers, the one or more fillers being selected in particular from one or more of the following: inorganic fillers, in particular silicon oxide; carbonate; carbide, in particular silicon carbide; nitride, in particular metal nitride; metal oxide.

4. The electrochemical cell according to claim 1, wherein the cover element is connected to an insulating element, which is in particular plate-shaped, on an inner side facing the interior space, the insulating element in particular comprising one or more positioning projections and/or one or more positioning recesses on a side facing the cover element, which positioning projections and/or positioning recesses engage in one or more complementary positioning projections and/or positioning projections of the cover element.

5. The electrochemical cell according to claim 4, wherein the insulating element has a plurality of passage openings, in particular arranged regularly, the passage openings preferably being at least approximately oval or at least approximately rectangular.

6. The electrochemical cell according to claim 1, wherein the cover element has a first recessed region for receiving the first potting element on a side facing away from the interior space and/or
wherein the cover element has a second recessed region for receiving the second potting element on a side facing away from the interior space.

7. The electrochemical cell according to claim 6, wherein the first recessed region and/or the second recessed region are formed by means of embossing.

8. The electrochemical cell according to claim 1, wherein the electrochemical cell comprises a first sealing element, which is in particular closed in a ring shape or has at least one interruption, which sealing element radially surrounds the first potting element on an outer side of the cover element facing away from the interior space of the electrochemical cell with respect to a central axis of the first contact element; and/or
wherein the electrochemical cell comprises a second sealing element, which is in particular closed in a ring shape or has at least one interruption, which sealing element radially surrounds the second potting element on an outer side of the cover element facing away from the interior space of the electrochemical cell with respect to a central axis of the second contact element.

9. The electrochemical cell according to claim 8, wherein the first sealing element has at least one interruption in the radial direction with respect to the central axis of the first contact element or in that the first sealing element protrudes beyond the first cell terminal in the radial direction with respect to the central axis of the first contact element and/or wherein the second sealing element has at least one interruption in the radial direction with respect to the central axis of the second contact element or wherein the second sealing element protrudes beyond the second cell terminal in the radial direction with respect to the central axis of the second contact element.

10. The electrochemical cell according to claim 1, wherein a first sealing element of the electrochemical cell comprises or is formed from a third polymer material and/or wherein a second sealing element of the electrochemical cell comprises or is formed from a fourth polymer material, the first sealing element and/or the second sealing element being applied to a main body of the cover element, in particular in the form of a sealing bead, in particular in a printing process.

11. The electrochemical cell according to claim 10, wherein the third polymer material and/or the fourth polymer material comprise one or more fillers, the one or more fillers being selected in particular from one or more of the following: inorganic fillers, in particular silicon oxide; carbonate; carbide, in particular silicon carbide; nitride, in particular metal nitride; metal oxide; and/or
wherein the fourth polymer material comprises one or more conductive additives, the one or more conductive additives being selected in particular from one or more of the following: carbon materials, in particular conductive carbon black, graphite, graphene, carbon nanotubes, carbon fibers and/or carbon nano-onions; particulate metallic materials, in particular metal powder; electrically conductive ceramic materials, in particular nitrides and/or carbides; electrically conductive polymers, in particular trans-polyacetylene, polypyrrole, polyaniline, poly(-phenylene), polythiophene and/or polystyrene doped poly(3,4-ethylenedioxythiophene) (PEDOT:PSS).

12. The electrochemical cell according to claim 1, wherein a first sealing element of the electrochemical cell and/or a second sealing element of the electrochemical cell is part of the cover element and is formed in particular by an elevation of the cover element, which is in particular closed in a ring shape or has at least one interruption, which elevation extends from a main body of the cover element in a direction pointing away from the interior space of the electrochemical cell.

13. The electrochemical cell according to claim 1, wherein the first contact element and/or the second contact element comprises at least two contact element components that in particular comprise or are formed from different metallic materials and wherein, in particular in the first connection region and/or in the second connection region, are integrally connected to one another, in particular by means of laser welding and/or roll cladding.

14. The electrochemical cell according to claim 1, wherein the first contact element has a first resin material filling opening for filling the first resin material into the first connection region and/or
wherein the second contact element has a second resin material filling opening for filling the second resin material into the second connection region.

15. The electrochemical cell according to claim 1, wherein the first connection conductor has an average thickness that is approx. 1/10 or less of an average width of the first connection conductor taken perpendicular to the thickness, the average thickness preferably being approx. 0.8 mm or less, for example approx. 0.7 mm or less, and/or wherein the second connection conductor has an average thickness that is approx. 1/10 or less of an average width of the second connection conductor taken perpendicular to the thickness, the average thickness preferably being approx. 0.8 mm or less, for example approx. 0.7 mm or less.

16. The electrochemical cell according to claim 1, wherein the first contact element has an average thickness in a first joint region with the first cell terminal, which thickness is approx. 2/10 or less of an average width of the first contact element taken perpendicular to the thickness, the average thickness preferably being approx. 0.8 mm or less, for example approx. 0.7 mm or less, and/or
wherein the second contact element has an average thickness in a second joint region with the second cell terminal, which thickness is approx. 2/10 or less of an average width taken perpendicularly to the thickness of the second contact element, the average thickness preferably being approx. 0.8 mm or less, for example approx. 0.7 mm or less.

17. The electrochemical cell according to claim 1, wherein an average width of the first contact element in a first joint region with the first cell terminal is approx. ½ or less, in particular ⅖ or less, of an average width of the first cell terminal in a direction taken parallel to the width of the first contact member, the average width preferably being approx. 10.0 mm or less, and/or
wherein an average width of the second contact element in a second joint region with the second cell terminal is approx. ½ or less, in particular ⅖ or less, of an average width of the second cell terminal in a direction taken parallel to the width of the second contact member, the average width preferably being approx. 10.0 mm or less.

18. The electrochemical cell according to claim 1, wherein the first connection conductor and the first contact element are formed in one piece and/or in that the first contact element is at least approximately rectangular in a cross section taken parallel to a main extension plane of the cover element, and/or
wherein the second connection conductor and the second contact element are formed in one piece and/or in that the second contact element is at least approximately rectangular in a cross section taken parallel to the main extension plane of the cover element.

19. The electrochemical cell according to claim 1, wherein an average thickness of the cover element in a cross section taken perpendicular to its main extension plane is approx. 1/10 or less, for example approx. 1/20 or less, of an average width of the cover element perpendicular to its thickness and/or in that the average thickness of the cover element is approx. 1.9 mm or less, for example approx. 1.8 mm or less.

20. The electrochemical cell according to claim 1, wherein an average thickness of an insulating element of the electrochemical cell is approx. 1/10 or less, for example approx. 1/15 or less, of an average width of the insulating member taken perpendicular to the thickness, the average thickness of the insulating member preferably being approx. 1.7 mm or less.

21. The electrochemical cell according to claim 1, wherein an insulating element of the electrochemical cell has a plurality of depressions for receiving the first potting element and/or the second potting element, one or more flow guide elements for distributing the first resin material and/or the second resin material during the production of the electrochemical cell in particular being arranged in the depressions.

22. The electrochemical cell according to claim 1, wherein the electrochemical cell comprises at least one snap-over element that, when a critical pressure and/or a critical temperature is exceeded in the interior space of the electrochemical cell, can be deflected outwards from a rest state into a working state, thus establishing electrical contact between the cover element and the first cell terminal.

23. The electrochemical cell according to claim 1, wherein the first contact element and/or the second contact element is/are connected integrally and/or in a form-fitting manner and/or in a force-locking manner to an insulating element of the electrochemical cell.

24. The electrochemical cell according to claim 1, wherein the electrochemical cell comprises an insulating element that, on an inner side of the cover element facing the interior space, is connected to the cover element, the insulating element having at least one filling opening adjacent to the first connection region and/or adjacent to the second connection region for filling the first resin material into the first connection region and/or for filling the second resin material into the second connection region.

25. An electrochemical system comprising one or more electrochemical cells according to claim 1.

26. A method for producing an electrochemical cell, in particular an electrochemical cell according to claim 1, the method comprising the following:
providing a cover element that comprises a first opening and/or a second opening;
positioning a first contact element, which is or can be connected in particular to a first cell terminal, in the first opening and/or positioning a second contact element, which is or can be connected in particular to a second cell terminal, in the second opening;
filling a first resin material into a first connection region surrounded by the cover element, the first contact element and in particular the first cell terminal in a casting process and/or filling a second resin material into a second connection region surrounded by the cover element, the second contact element and in particular the second cell terminal in a casting process;
drying and/or curing the first resin material to form a first potting element and/or drying and/or curing the second resin material to form a second potting element.

27. The method according to claim 26, wherein on the outside of a main body of the cover element facing away from an interior space of the electrochemical cell at least one first sealing element is applied to the cover element and/or introduced into the cover element, which first sealing element radially surrounds the first connection region, and/or in that on the outside of the main body of the cover element facing away from the interior space of the electrochemical cell at least one second sealing element is applied to the cover element and/or introduced into the cover element, which second sealing element radially surrounds the second connecting region.
